(19) United States
(12) Patent Application Publication
(10) Pub. No.: US 2024/0171428 A1
(43) Pub. Date: May 23, 2024

(54) NEURAL NETWORK ASSISTED COMMUNICATION TECHNIQUES

(71) Applicant: QUALCOMM Incorporated, San Diego, CA (US)

(72) Inventors: Rui HU, Beijing (CN); Qiaoyu LI, Beijing (CN); Chenxi HAO, Beijing (CN); Yu ZHANG, San Diego, CA (US); Hao XU, Beijing (CN)

(21) Appl. No.: 18/551,382

(22) PCT Filed: May 26, 2022
(86) PCT No.: PCT/CN2022/095169

§ 371 Date: Sep. 19, 2023

(30) Foreign Application Priority Data
May 27, 2021 (WO) PCT/CN2021/096210

(51) Int. Cl. H04L 25/02

(52) U.S. Cl. CPC H04L 25/0254

(57) ABSTRACT

Methods, systems, and devices for wireless communication are described. Neural networks may assist user equipments (UEs) and base stations in performing various operations related to wireless communications. For example, neural networks may be used to generate non-orthogonal cover codes for transmitting reference signals such as channel state information-reference signals (CSI-RSs). A base station may transmit, to a UE, a CSI-RS associated with a non-orthogonal cover code of a set of non-orthogonal cover codes. Using the CSI-RS, the UE may perform a channel estimation procedure that corresponds to the non-orthogonal cover code. Based on the channel estimation procedure, the UE may transmit a feedback message to the base station that indicates a channel quality parameter. Additionally, or alternatively, a UE may receive a CSI-RS, determine a precoding matrix using the CSI-RS and neural network, and transmit an indication of the pre-coding matrix to a base station.

### CROSS REFERENCE

The present Application is a 371 national stage filing of International PCT Application No. PCT/CN2022/095169 by HU et al. entitled “NEURAL NETWORK ASSISTED COMMUNICATION TECHNIQUES,” filed May 26, 2022, and claims priority to International PCT Patent Application No. PCT/CN2021/096210 by Hu et al., entitled “NEURAL NETWORK ASSISTED COMMUNICATION TECHNIQUES,” filed May 27, 2021, each of which is assigned to the assignee hereof, and each of which is expressly incorporated by reference in its entirety herein.

### BACKGROUND

The following relates to wireless communication, including communications using a neural network.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

A method for wireless communications at a user equipment (UE) is described. The method may include obtaining a channel state information-reference signal (CSI-RS) associated with a non-orthogonal cover code of a set of non-orthogonal cover codes for reference signals. The method may further include performing a channel estimation procedure of the CSI-RS, the channel estimation procedure corresponding to the non-orthogonal cover code. The method may further include outputting a feedback message that indicates a channel quality parameter based on the channel estimation procedure of the CSI-RS associated with the non-orthogonal cover code.

An apparatus for wireless communications at a UE is described. The apparatus may include a processor, and memory coupled with the processor. The processor may be configured to obtain a CSI-RS associated with a non-orthogonal cover code of a set of non-orthogonal cover codes for reference signals. The processor may be further configured to perform a channel estimation procedure of the CSI-RS, the channel estimation procedure corresponding to the non-orthogonal cover code. The processor may be further configured to output a feedback message that indicates a channel quality parameter based on the channel estimation procedure of the CSI-RS associated with the non-orthogonal cover code.

Another apparatus for wireless communications at a UE is described. The apparatus may include means for obtaining a CSI-RS associated with a non-orthogonal cover code of a set of non-orthogonal cover codes for reference signals. The apparatus may further include means for performing a channel estimation procedure of the CSI-RS, the channel estimation procedure corresponding to the non-orthogonal cover code. The apparatus may further include means for outputting a feedback message that indicates a channel quality parameter based on the channel estimation procedure of the CSI-RS associated with the non-orthogonal cover code.

A non-transitory computer-readable medium storing code for wireless communications at a UE is described. The code may include instructions executable by a processor to obtain a CSI-RS associated with a non-orthogonal cover code of a set of non-orthogonal cover codes for reference signals. The code may further include instructions executable by the processor to perform a channel estimation procedure of the CSI-RS, the channel estimation procedure corresponding to the non-orthogonal cover code. The code may further include instructions executable by the processor to output a feedback message that indicates a channel quality parameter based on the channel estimation procedure of the CSI-RS associated with the non-orthogonal cover code.

Some examples of the method, apparatuses, and non-transitory computer-readable medium described herein may further include operations, features, means, or instructions for demultiplexing the CSI-RS based on the non-orthogonal cover code, where the channel estimation procedure may be performed based on inputting the demultiplexed CSI-RS into a neural network model for channel estimation, the neural network model using a set of neural network parameters corresponding to the non-orthogonal cover code.

Some examples of the method, apparatuses, and non-transitory computer-readable medium described herein may further include operations, features, means, or instructions for inputting the CSI-RS into a neural network model for channel estimation, the neural network model using a set of neural network parameters corresponding to the non-orthogonal cover code.

In some examples of the method, apparatuses, and non-transitory computer-readable medium described herein, the non-orthogonal cover code may be based on a location of one or more resources used to communicate the CSI-RS.

Some examples of the method, apparatuses, and non-transitory computer-readable medium described herein may further include operations, features, means, or instructions for obtaining a configuration message that indicates a set of communication parameters associated with the non-orthogonal cover code, where the CSI-RS may be obtained in accordance with the set of communication parameters and selecting the non-orthogonal cover code from the set of non-orthogonal cover codes based on obtaining the CSI-RS in accordance with the set of communication parameters.

In some examples of the method, apparatuses, and non-transitory computer-readable medium described herein, the set of communication parameters includes a channel condition associated with the CSI-RS, a bandwidth associated with the CSI-RS, a location of one or more resources used to communicate the CSI-RS, a code division multiplexing (CDM) type associated with the CSI-RS, or a combination thereof.

Some examples of the method, apparatuses, and non-transitory computer-readable medium described herein may further include operations, features, means, or instructions for outputting a message indicating the set of non-orthogonal cover codes, where the CSI-RS associated with the non-orthogonal cover code may be obtained based on the output of the message.

Some examples of the method, apparatuses, and non-transitory computer-readable medium described herein may further include operations, features, means, or instructions for obtaining a configuration message indicating a second set of non-orthogonal cover codes including the set of non-orthogonal cover codes, where the message indicating the set of non-orthogonal cover codes includes a set of indexes, each index corresponding to a non-orthogonal code of the set of non-orthogonal cover codes.

Some examples of the method, apparatuses, and non-transitory computer-readable medium described herein may further include operations, features, means, or instructions for selecting, based on the output of the message indicating the set of non-orthogonal cover codes, a set of neural network parameters of a neural network model for channel estimation corresponding to the non-orthogonal cover code, where the channel estimation procedure may be performed using the set of neural network parameters.

Some examples of the method, apparatuses, and non-transitory computer-readable medium described herein may further include operations, features, means, or instructions for obtaining, based on the output of the message indicating the set of non-orthogonal cover codes, a configuration message indicating a set of neural network parameters of a neural network model for channel estimation corresponding to the non-orthogonal cover code, where the channel estimation procedure may be performed using the set of neural network parameters.

Some examples of the method, apparatuses, and non-transitory computer-readable medium described herein may further include operations, features, means, or instructions for obtaining a configuration message indicating a set of neural network parameters of a neural network model for channel estimation corresponding to the non-orthogonal cover code, where the channel estimation procedure may be performed using the set of neural network parameters based on the configuration message.

Some examples of the method, apparatuses, and non-transitory computer-readable medium described herein may further include operations, features, means, or instructions for outputting an indication of a precoding matrix for communicating with a network device, the precoding matrix determined using the CSI-RS and a set of neural network parameters of a neural network model for channel estimation corresponding to the non-orthogonal cover code.

Some examples of the method, apparatuses, and non-transitory computer-readable medium described herein may further include operations, features, means, or instructions for obtaining, in response to the output of the indication of the precoding matrix, a second CSI-RS associated with the non-orthogonal cover code, performing a second channel estimation procedure of the second CSI-RS using a second set of neural network parameters of the neural network model corresponding to the non-orthogonal cover code, and outputting a second feedback message including a channel quality indicator (CQI), a rank indicator (RI), or a combination thereof, based on the second channel estimation procedure.

Some examples of the method, apparatuses, and non-transitory computer-readable medium described herein may further include operations, features, means, or instructions for outputting a second feedback message including a CQI, the CQI determined using the CSI-RS and a set of neural network parameters of a neural network model for channel estimation corresponding to the non-orthogonal cover code.

Some examples of the method, apparatuses, and non-transitory computer-readable medium described herein may further include operations, features, means, or instructions for obtaining an indication of a quantity of transmission ports associated with transmission of the CSI-RS, where a length of the non-orthogonal cover code may be based on the quantity of transmission ports.

In some examples of the method, apparatuses, and non-transitory computer-readable medium described herein, obtaining the CSI-RS may include operations, features, means, or instructions for obtaining the CSI-RS via a set of resource blocks, where a quantity of the set of resource blocks may be based on a reporting channel bandwidth associated with the feedback message.

In some examples of the method, apparatuses, and non-transitory computer-readable medium described herein, obtaining the CSI-RS may include operations, features, means, or instructions for obtaining the CSI-RS via a set of resource elements, where a quantity of the set of resource elements may be based on the length of the non-orthogonal cover code.

A method for wireless communications at a UE is described. The method may include obtaining a CSI-RS generated using a first set of neural network parameters of a first neural network model for reference signals. The method may further include outputting an indication of a precoding matrix for communicating with a network device, the precoding matrix determined using the CSI-RS and a second set of neural network parameters of a second neural network model for channel estimation.

An apparatus for wireless communications at a UE is described. The apparatus may include a processor, and memory coupled with the processor. The processor may be configured to obtain a CSI-RS generated using a first set of neural network parameters of a first neural network model for reference signals. The processor may be further configured to output an indication of a precoding matrix for communicating with a network device, the precoding matrix determined using the CSI-RS and a second set of neural network parameters of a second neural network model for channel estimation.

Another apparatus for wireless communications at a UE is described. The apparatus may include means for obtaining a CSI-RS generated using a first set of neural network parameters of a first neural network model for reference signals. The apparatus may further include means for outputting an indication of a precoding matrix for communicating with a network device, the precoding matrix determined using the CSI-RS and a second set of neural network parameters of a second neural network model for channel estimation.

A non-transitory computer-readable medium storing code for wireless communications at a UE is described. The code may include instructions executable by a processor to obtain a CSI-RS generated using a first set of neural network parameters of a first neural network model for reference signals. The code may further include instructions executable by the processor to output an indication of a precoding matrix for communicating with a network device, the precoding matrix determined using the CSI-RS and a second set of neural network parameters of a second neural network model for channel estimation.

Some examples of the method, apparatuses, and non-transitory computer-readable medium described herein may further include operations, features, means, or instructions for obtaining, in response to the output of the indication of the precoding matrix, a second CSI-RS generated using a third set of neural network parameters of the first neural network model corresponding to the indicated precoding matrix, performing a channel estimation procedure of the second CSI-RS using a fourth set of neural network parameters of the second neural network model, and outputting a feedback message including a CQI, a RI, or a combination thereof, based on the channel estimation procedure.

Some examples of the method, apparatuses, and non-transitory computer-readable medium described herein may further include operations, features, means, or instructions for outputting a feedback message including a CQI, the CQI determined using the CSI-RS and a third set of neural network parameters of the second neural network model.

A method for wireless communications at a network device is described. The method may include outputting a CSI-RS associated with a non-orthogonal cover code of a set of non-orthogonal cover codes for reference signals. The method may further include obtaining a feedback message indicating a channel quality parameter that is determined based on a channel estimation procedure of the CSI-RS, the channel estimation procedure corresponding to the non-orthogonal cover code.

An apparatus for wireless communications at a network device is described. The apparatus may include a processor, and memory coupled with the processor. The processor may be configured to output a CSI-RS associated with a non-orthogonal cover code of a set of non-orthogonal cover codes for reference signals. The processor may be further configured to obtain a feedback message indicating a channel quality parameter that is determined based on a channel estimation procedure of the CSI-RS, the channel estimation procedure corresponding to the non-orthogonal cover code.

Another apparatus for wireless communications at a network device is described. The apparatus may include means for outputting a CSI-RS associated with a non-orthogonal cover code of a set of non-orthogonal cover codes for reference signals. The apparatus may further include means for obtaining a feedback message indicating a channel quality parameter that is determined based on a channel estimation procedure of the CSI-RS, the channel estimation procedure corresponding to the non-orthogonal cover code.

A non-transitory computer-readable medium storing code for wireless communications at a network device is described. The code may include instructions executable by a processor to output a CSI-RS associated with a non-orthogonal cover code of a set of non-orthogonal cover codes for reference signals. The code may further include instructions executable by the processor to obtain a feedback message indicating a channel quality parameter that is determined based on a channel estimation procedure of the CSI-RS, the channel estimation procedure corresponding to the non-orthogonal cover code.

In some examples of the method, apparatuses, and non-transitory computer-readable medium described herein, the non-orthogonal cover code may be based on a location of one or more resources used to output the CSI-RS.

Some examples of the method, apparatuses, and non-transitory computer-readable medium described herein may further include operations, features, means, or instructions for outputting a configuration message that indicates a set of communication parameters associated with the non-orthogonal cover code, where the CSI-RS may be output in accordance with the set of communication parameters.

In some examples of the method, apparatuses, and non-transitory computer-readable medium described herein, the set of communication parameters includes a channel condition associated with the CSI-RS, a bandwidth associated with the CSI-RS, a location of one or more resources used to communicate the CSI-RS, a CDM type associated with the CSI-RS, or a combination thereof.

Some examples of the method, apparatuses, and non-transitory computer-readable medium described herein may further include operations, features, means, or instructions for obtaining a message indicating the set of non-orthogonal cover codes, where the processor may be configured to output the CSI-RS associated with the non-orthogonal cover code based on the message.

Some examples of the method, apparatuses, and non-transitory computer-readable medium described herein may further include operations, features, means, or instructions for outputting a configuration message indicating a second set of non-orthogonal cover codes including the set of non-orthogonal cover codes, where the message indicating the set of non-orthogonal cover codes includes a set of indexes, each index corresponding to a non-orthogonal code of the set of non-orthogonal cover codes.

Some examples of the method, apparatuses, and non-transitory computer-readable medium described herein may further include operations, features, means, or instructions for outputting, based on the message indicating the set of non-orthogonal cover codes, a configuration message indicating a set of neural network parameters of a neural network model for channel estimation corresponding to the non-orthogonal cover code.

Some examples of the method, apparatuses, and non-transitory computer-readable medium described herein may further include operations, features, means, or instructions for outputting a configuration message indicating a set of neural network parameters of a neural network model for channel estimation corresponding to the non-orthogonal cover code, where the channel estimation procedure may be performed using the set of neural network parameters based on the output of the configuration message.

Some examples of the method, apparatuses, and non-transitory computer-readable medium described herein may further include operations, features, means, or instructions for obtaining an indication of a precoding matrix for communicating with a UE, the precoding matrix determined using the CSI-RS and a set of neural network parameters of a neural network model for channel estimation corresponding to the non-orthogonal cover code.

Some examples of the method, apparatuses, and non-transitory computer-readable medium described herein may further include operations, features, means, or instructions for outputting, in response to the indication of the precoding matrix, a second CSI-RS associated with the non-orthogonal cover code and obtaining a second feedback message including a CQI, a RI, or a combination thereof, determined based on a second channel estimation procedure of the second CSI-RS using a second set of neural network parameters of the neural network model corresponding to the non-orthogonal cover code.

Some examples of the method, apparatuses, and non-transitory computer-readable medium described herein may further include operations, features, means, or instructions for obtaining a second feedback message including a CQI, the CQI determined using the CSI-RS and a set of neural network parameters of a neural network model for channel estimation corresponding to the non-orthogonal cover code.

Some examples of the method, apparatuses, and non-transitory computer-readable medium described herein may further include operations, features, means, or instructions for outputting an indication of a quantity of transmission ports associated with the output of the CSI-RS, where a length of the non-orthogonal cover code may be based on the quantity of transmission ports.

In some examples of the method, apparatuses, and non-transitory computer-readable medium described herein, outputting the CSI-RS may include operations, features, means, or instructions for outputting the CSI-RS via a set of resource elements, where a quantity of the set of resource elements may be based on the length of the non-orthogonal cover code.

A method for wireless communications at a network device is described. The method may include generating a CSI-RS using a first set of neural network parameters of a first neural network model for reference signals. The method may further include outputting the CSI-RS. The method may further include obtaining an indication of a precoding matrix for communicating with a UE, the precoding matrix determined using the CSI-RS and a second set of neural network parameters of a second neural network model for channel estimation.

An apparatus for wireless communications at a network device is described. The apparatus may include a processor, and memory coupled with the processor. The processor may be configured to generate a CSI-RS using a first set of neural network parameters of a first neural network model for reference signals. The processor may be further configured to output the CSI-RS. The processor may be further configured to obtain an indication of a precoding matrix for communicating with a UE, the precoding matrix determined using the CSI-RS and a second set of neural network parameters of a second neural network model for channel estimation.

Another apparatus for wireless communications at a network device is described. The apparatus may include means for generating a CSI-RS using a first set of neural network parameters of a first neural network model for reference signals. The apparatus may further include means for outputting the CSI-RS. The apparatus may further include means for obtaining an indication of a precoding matrix for communicating with a UE, the precoding matrix determined using the CSI-RS and a second set of neural network parameters of a second neural network model for channel estimation.

A non-transitory computer-readable medium storing code for wireless communications at a network device is described. The code may include instructions executable by a processor to generate a CSI-RS using a first set of neural network parameters of a first neural network model for reference signals. The code may further include instructions executable by the processor to output the CSI-RS. The code may further include instructions executable by the processor to obtain an indication of a precoding matrix for communicating with a UE, the precoding matrix determined using the CSI-RS and a second set of neural network parameters of a second neural network model for channel estimation.

Some examples of the method, apparatuses, and non-transitory computer-readable medium described herein may further include operations, features, means, or instructions for generating, in response to the indication of the precoding matrix, a second CSI-RS using a third set of neural network parameters of the first neural network model corresponding to the indicated precoding matrix, outputting the second CSI-RS, and obtaining a feedback message including a CQI, a RI, or a combination thereof, determined using the second CSI-RS and a fourth set of neural network parameters of the second neural network model.

A method for wireless communications at a UE is described. The method may include obtaining an indication of a quantity of transmission ports associated with transmission of a CSI-RS in accordance with a non-orthogonal cover code, a length of the non-orthogonal cover code based on the quantity of transmission ports. The method may further include obtaining the CSI-RS via a set of resource blocks. The method may further include performing a channel estimation procedure of the CSI-RS using a neural network model that corresponds to the length of the non-orthogonal cover code and the quantity of transmission ports.

An apparatus for wireless communications at a UE is described. The apparatus may include a processor, and memory coupled with the processor. The processor may be configured to obtain an indication of a quantity of transmission ports associated with transmission of a CSI-RS in accordance with a non-orthogonal cover code, a length of the non-orthogonal cover code based on the quantity of transmission ports. The processor may be further configured to obtain the CSI-RS via a set of resource blocks. The processor may be further configured to perform a channel estimation procedure of the CSI-RS using a neural network model that corresponds to the length of the non-orthogonal cover code and the quantity of transmission ports.

Another apparatus for wireless communications at a UE is described. The apparatus may include means for obtaining an indication of a quantity of transmission ports associated with transmission of a CSI-RS in accordance with a non-orthogonal cover code, a length of the non-orthogonal cover code based on the quantity of transmission ports. The apparatus may further include means for obtaining the CSI-RS via a set of resource blocks. The apparatus may further include means for performing a channel estimation procedure of the CSI-RS using a neural network model that corresponds to the length of the non-orthogonal cover code and the quantity of transmission ports.

A non-transitory computer-readable medium storing code for wireless communications at a UE is described. The code may include instructions executable by a processor to obtain an indication of a quantity of transmission ports associated with transmission of a CSI-RS in accordance with a non-orthogonal cover code, a length of the non-orthogonal cover code based on the quantity of transmission ports. The code may further include instructions executable by the processor to obtain the CSI-RS via a set of resource blocks. The code may further include instructions executable by the processor to perform a channel estimation procedure of the CSI-RS using a neural network model that corresponds to the length of the non-orthogonal cover code and the quantity of transmission ports.

In some examples of the method, apparatuses, and non-transitory computer-readable medium described herein, obtaining the CSI-RS may include operations, features, means, or instructions for obtain the CSI-RS in accordance with a set of non-orthogonal cover codes including the non-orthogonal cover code, where each non-orthogonal cover code may be specific to a resource block of the set of resource blocks.

In some examples of the method, apparatuses, and non-transitory computer-readable medium described herein, obtaining the CSI-RS may include operations, features, means, or instructions for obtain, via each resource block of the set of resource blocks, the CSI-RS via a set of resource elements of the resource block, where a quantity of resource elements of the set of resource elements may be based on the length of the non-orthogonal cover code.

In some examples of the method, apparatuses, and non-transitory computer-readable medium described herein, the quantity of resource elements per resource block of the set of resource blocks may be less than the quantity of transmission ports.

In some examples of the method, apparatuses, and non-transitory computer-readable medium described herein, the length of the non-orthogonal cover code per resource block of the set of resource blocks may be less than the quantity of transmission ports.

A method for wireless communication at a UE is described. The method may include receiving, from a base station, a CSI-RS associated with a non-orthogonal cover code of a set of non-orthogonal cover codes for reference signals. The method may further include performing a channel estimation procedure of the CSI-RS, the channel estimation procedure corresponding to the non-orthogonal cover code. The method may further include transmitting, to the base station, a feedback message that indicates a channel quality parameter based on the channel estimation procedure of the CSI-RS associated with the non-orthogonal cover code.

An apparatus for wireless communication at a UE is described. The apparatus may include a processor; and memory coupled to the processor, the processor and memory configured to receive, from a base station, a CSI-RS associated with a non-orthogonal cover code of a set of non-orthogonal cover codes for reference signals. The processor and memory may be further configured to perform a channel estimation procedure of the CSI-RS, the channel estimation procedure corresponding to the non-orthogonal cover code. The processor and memory may be further configured to transmit, to the base station, a feedback message that indicates a channel quality parameter based on the channel estimation procedure of the CSI-RS associated with the non-orthogonal cover code.

Another apparatus for wireless communication at a UE is described. The apparatus may include means for receiving, from a base station, a CSI-RS associated with a non-orthogonal cover code of a set of non-orthogonal cover codes for reference signals. The apparatus may further include means for performing a channel estimation procedure of the CSI-RS, the channel estimation procedure corresponding to the non-orthogonal cover code. The apparatus may further include means for transmitting, to the base station, a feedback message that indicates a channel quality parameter based on the channel estimation procedure of the CSI-RS associated with the non-orthogonal cover code.

A non-transitory computer-readable medium storing code for wireless communication at a UE is described. The code may include instructions executable by a processor to receive, from a base station, a CSI-RS associated with a non-orthogonal cover code of a set of non-orthogonal cover codes for reference signals. The code may further include instructions executable by the processor to perform a channel estimation procedure of the CSI-RS, the channel estimation procedure corresponding to the non-orthogonal cover code. The code may further include instructions executable by the processor to transmit, to the base station, a feedback message that indicates a channel quality parameter based on the channel estimation procedure of the CSI-RS associated with the non-orthogonal cover code.

Some examples of the method, apparatuses, and non-transitory computer-readable medium described herein may further include operations, features, means, or instructions for demultiplexing the CSI-RS based on the non-orthogonal cover code, where performing the channel estimation procedure may be based on inputting the demultiplexed CSI-RS into a neural network model for channel estimation, the neural network model using a set of neural network parameters corresponding to the non-orthogonal cover code.

Some examples of the method, apparatuses, and non-transitory computer-readable medium described herein may further include operations, features, means, or instructions for inputting the CSI-RS into a neural network model for channel estimation, the neural network model using a set of neural network parameters corresponding to the non-orthogonal cover code.

In some examples of the method, apparatuses, and non-transitory computer-readable medium described herein, the non-orthogonal cover code may be based on a location of one or more resources used to communicate the CSI-RS.

Some examples of the method, apparatuses, and non-transitory computer-readable medium described herein may further include operations, features, means, or instructions for receiving a configuration message that indicates a set of communication parameters associated with the non-orthogonal cover code, where the CSI-RS may be received in accordance with the set of communication parameters. Some examples of the method, apparatuses, and non-transitory computer-readable medium described herein may further include operations, features, means, or instructions for selecting the non-orthogonal cover code from the set of non-orthogonal cover codes based at least in part receiving the CSI-RS in accordance with the set of communication parameters.

In some examples of the method, apparatuses, and non-transitory computer-readable medium described herein, the set of communication parameters includes a channel condition associated with the CSI-RS, a bandwidth associated with the CSI-RS, a location of one or more resources used to communicate the CSI-RS, a CDM type associated with the CSI-RS, or a combination thereof.

Some examples of the method, apparatuses, and non-transitory computer-readable medium described herein may further include operations, features, means, or instructions for transmitting, to the base station, a message indicating the set of non-orthogonal cover codes, where receiving the CSI-RS associated with the non-orthogonal cover code may be based on transmitting the message.

Some examples of the method, apparatuses, and non-transitory computer-readable medium described herein may further include operations, features, means, or instructions for receiving, from the base station, a configuration message indicating a second set of non-orthogonal cover codes including the set of non-orthogonal cover codes, where the message indicating the set of non-orthogonal cover codes includes a set of indexes, each index corresponding to a non-orthogonal code of the set of non-orthogonal cover codes.

Some examples of the method, apparatuses, and non-transitory computer-readable medium described herein may further include operations, features, means, or instructions for selecting, based on transmitting the message indicating the set of non-orthogonal cover codes, a set of neural network parameters of a neural network model for channel estimation corresponding to the non-orthogonal cover code, where the channel estimation procedure may be performed using the set of neural network parameters.

Some examples of the method, apparatuses, and non-transitory computer-readable medium described herein may further include operations, features, means, or instructions for receiving, based on transmitting the message indicating the set of non-orthogonal cover codes, a configuration message indicating a set of neural network parameters of a neural network model for channel estimation corresponding to the non-orthogonal cover code, where the channel estimation procedure may be performed using the set of neural network parameters.

Some examples of the method, apparatuses, and non-transitory computer-readable medium described herein may further include operations, features, means, or instructions for receiving a configuration message indicating a set of neural network parameters of a neural network model for channel estimation corresponding to the non-orthogonal cover code, where the channel estimation procedure may be performed using the set of neural network parameters based on receiving the configuration message.

Some examples of the method, apparatuses, and non-transitory computer-readable medium described herein may further include operations, features, means, or instructions for transmitting, to the base station, an indication of a precoding matrix for communicating with the base station, the precoding matrix determined using the CSI-RS and a set of neural network parameters of a neural network model for channel estimation corresponding to the non-orthogonal cover code.

Some examples of the method, apparatuses, and non-transitory computer-readable medium described herein may further include operations, features, means, or instructions for receiving, in response to transmitting the indication of the precoding matrix, a second CSI-RS associated with the non-orthogonal cover code. Some examples of the method, apparatuses, and non-transitory computer-readable medium described herein may further include operations, features, means, or instructions for performing a second channel estimation procedure of the second CSI-RS using a second set of neural network parameters of the neural network model corresponding to the non-orthogonal cover code. Some examples of the method, apparatuses, and non-transitory computer-readable medium described herein may further include operations, features, means, or instructions for transmitting, to the base station, a second feedback message including a CQI, an RI, or a combination thereof, based on the second channel estimation procedure.

Some examples of the method, apparatuses, and non-transitory computer-readable medium described herein may further include operations, features, means, or instructions for transmitting, to the base station, a second feedback message including a CQI, the CQI determined using the CSI-RS and a set of neural network parameters of a neural network model for channel estimation corresponding to the non-orthogonal cover code.

A method for wireless communication at a UE is described. The method may include receiving, from a base station, a CSI-RS generated using a first set of neural network parameters of a first neural network model for reference signals. The method may further include transmitting, to the base station, an indication of a precoding matrix for communicating with the base station, the precoding matrix determined using the CSI-RS and a second set of neural network parameters of a second neural network model for channel estimation.

An apparatus for wireless communication at a UE is described. The apparatus may include a processor; and memory coupled to the processor, the processor and memory configured to receive, from a base station, a CSI-RS generated using a first set of neural network parameters of a first neural network model for reference signals. The processor and memory may be further configured to transmit, to the base station, an indication of a precoding matrix for communicating with the base station, the precoding matrix determined using the CSI-RS and a second set of neural network parameters of a second neural network model for channel estimation.

Another apparatus for wireless communication at a UE is described. The apparatus may include means for receiving, from a base station, a CSI-RS generated using a first set of neural network parameters of a first neural network model for reference signals. The apparatus may further include means for transmitting, to the base station, an indication of a precoding matrix for communicating with the base station, the precoding matrix determined using the CSI-RS and a second set of neural network parameters of a second neural network model for channel estimation.

A non-transitory computer-readable medium storing code for wireless communication at a UE is described. The code may include instructions executable by a processor to receive, from a base station, a CSI-RS generated using a first set of neural network parameters of a first neural network model for reference signals. The code may further include instructions executable by the processor to transmit, to the base station, an indication of a precoding matrix for communicating with the base station, the precoding matrix determined using the CSI-RS and a second set of neural network parameters of a second neural network model for channel estimation.

Some examples of the method, apparatuses, and non-transitory computer-readable medium described herein may further include operations, features, means, or instructions for receiving, in response to transmitting the indication of the precoding matrix, a second CSI-RS generated using a third set of neural network parameters of the first neural network model corresponding to the indicated precoding matrix. Some examples of the method, apparatuses, and non-transitory computer-readable medium described herein may further include operations, features, means, or instructions for performing a channel estimation procedure of the second CSI-RS using a fourth set of neural network parameters of the second neural network model. Some examples of the method, apparatuses, and non-transitory computer-readable medium described herein may further include operations, features, means, or instructions for transmitting a feedback message including a CQI, an RI, or a combination thereof, based on the channel estimation procedure.

Some examples of the method, apparatuses, and non-transitory computer-readable medium described herein may further include operations, features, means, or instructions for transmitting, to the base station, a feedback message including a CQI, the CQI determined using the CSI-RS and a third set of neural network parameters of the second neural network model.

A method for wireless communication at a base station is described. The method may include transmitting, to a UE, a CSI-RS associated with a non-orthogonal cover code of a set of non-orthogonal cover codes for reference signals. The method may further include receiving, from the UE, a feedback message indicating a channel quality parameter that is determined based on a channel estimation procedure of the CSI-RS, the channel estimation procedure corresponding to the non-orthogonal cover code.

An apparatus for wireless communication at a base station is described. The apparatus may include a processor; and memory coupled to the processor, the processor and memory configured to transmit, to a UE, a CSI-RS associated with a non-orthogonal cover code of a set of non-orthogonal cover codes for reference signals. The processor and memory may be further configured to receive, from the UE, a feedback message indicating a channel quality parameter that is determined based on a channel estimation procedure of the CSI-RS, the channel estimation procedure corresponding to the non-orthogonal cover code.

Another apparatus for wireless communication at a base station is described. The apparatus may include means for transmitting, to a UE, a CSI-RS associated with a non-orthogonal cover code of a set of non-orthogonal cover codes for reference signals. The apparatus may further include means for receiving, from the UE, a feedback message indicating a channel quality parameter that is determined based on a channel estimation procedure of the CSI-RS, the channel estimation procedure corresponding to the non-orthogonal cover code.

A non-transitory computer-readable medium storing code for wireless communication at a base station is described. The code may include instructions executable by a processor to transmit, to a UE, a CSI-RS associated with a non-orthogonal cover code of a set of non-orthogonal cover codes for reference signals. The code may further include instructions executable by the processor to receive, from the UE, a feedback message indicating a channel quality parameter that is determined based on a channel estimation procedure of the CSI-RS, the channel estimation procedure corresponding to the non-orthogonal cover code.

In some examples of the method, apparatuses, and non-transitory computer-readable medium described herein, the non-orthogonal cover code may be based on a location of one or more resources used to transmit the CSI-RS.

Some examples of the method, apparatuses, and non-transitory computer-readable medium described herein may further include operations, features, means, or instructions for transmitting a configuration message that indicates a set of communication parameters associated with the non-orthogonal cover code, where the CSI-RS may be transmitted in accordance with the set of communication parameters.

In some examples of the method, apparatuses, and non-transitory computer-readable medium described herein, the set of communication parameters includes a channel condition associated with the CSI-RS, a bandwidth associated with the CSI-RS, a location of one or more resources used to communicate the CSI-RS, a CDM type associated with the CSI-RS, or a combination thereof.

Some examples of the method, apparatuses, and non-transitory computer-readable medium described herein may further include operations, features, means, or instructions for receiving, from the UE, a message indicating the set of non-orthogonal cover codes, where transmitting the CSI-RS associated with the non-orthogonal cover code may be based on receiving the message.

Some examples of the method, apparatuses, and non-transitory computer-readable medium described herein may further include operations, features, means, or instructions for transmitting, to the UE, a configuration message indicating a second set of non-orthogonal cover codes including the set of non-orthogonal cover codes, where the message indicating the set of non-orthogonal cover codes includes a set of indexes, each index corresponding to a non-orthogonal code of the set of non-orthogonal cover codes.

Some examples of the method, apparatuses, and non-transitory computer-readable medium described herein may further include operations, features, means, or instructions for transmitting, based on receiving the message indicating the set of non-orthogonal cover codes, a configuration message indicating a set of neural network parameters of a neural network model for channel estimation corresponding to the non-orthogonal cover code.

Some examples of the method, apparatuses, and non-transitory computer-readable medium described herein may further include operations, features, means, or instructions for transmitting a configuration message indicating a set of neural network parameters of a neural network model for channel estimation corresponding to the non-orthogonal cover code, where the channel estimation procedure may be performed using the set of neural network parameters based on transmitting the configuration message.

Some examples of the method, apparatuses, and non-transitory computer-readable medium described herein may further include operations, features, means, or instructions for receiving, from the UE, an indication of a precoding matrix for communicating with the base station, the precoding matrix determined using the CSI-RS and a set of neural network parameters of a neural network model for channel estimation corresponding to the non-orthogonal cover code.

Some examples of the method, apparatuses, and non-transitory computer-readable medium described herein may further include operations, features, means, or instructions for transmitting, in response to receiving the indication of the precoding matrix, a second CSI-RS associated with the non-orthogonal cover code. Some examples of the method, apparatuses, and non-transitory computer-readable medium described herein may further include operations, features, means, or instructions for receiving, from the UE, a second feedback message including a CQI, an RI, or a combination thereof, determined based on a second channel estimation procedure of the second CSI-RS using a second set of neural network parameters of the neural network model corresponding to the non-orthogonal cover code.

Some examples of the method, apparatuses, and non-transitory computer-readable medium described herein may further include operations, features, means, or instructions for receiving, from the UE, a second feedback message including a CQI, the CQI determined using the CSI-RS and a set of neural network parameters of a neural network model for channel estimation corresponding to the non-orthogonal cover code.

A method for wireless communication at a base station is described. The method may include generating a CSI-RS using a first set of neural network parameters of a first neural network model for reference signals. The method may further include transmitting the CSI-RS to a UE. The method may further include receiving, from the UE, an indication of a precoding matrix for communicating with the base station, the precoding matrix determined using the CSI-RS and a second set of neural network parameters of a second neural network model for channel estimation.

An apparatus for wireless communication at a base station is described. The apparatus may include a processor; and memory coupled to the processor, the processor and memory configured to generate a CSI-RS using a first set of neural network parameters of a first neural network model for reference signals. The processor and memory may be further configured to transmit the CSI-RS to a UE. The processor and memory may be further configured to receive, from the UE, an indication of a precoding matrix for communicating with the base station, the precoding matrix determined using the CSI-RS and a second set of neural network parameters of a second neural network model for channel estimation.

Another apparatus for wireless communication at a base station is described. The apparatus may include means for generating a CSI-RS using a first set of neural network parameters of a first neural network model for reference signals. The apparatus may further include means for transmitting the CSI-RS to a UE. The apparatus may further include means for receiving, from the UE, an indication of a precoding matrix for communicating with the base station, the precoding matrix determined using the CSI-RS and a second set of neural network parameters of a second neural network model for channel estimation.

A non-transitory computer-readable medium storing code for wireless communication at a base station is described. The code may include instructions executable by a processor to generate a CSI-RS using a first set of neural network parameters of a first neural network model for reference signals. The code may further include instructions executable by the processor to transmit the CSI-RS to a UE. The code may further include instructions executable by the processor to receive, from the UE, an indication of a precoding matrix for communicating with the base station, the precoding matrix determined using the CSI-RS and a second set of neural network parameters of a second neural network model for channel estimation.

Some examples of the method, apparatuses, and non-transitory computer-readable medium described herein may further include operations, features, means, or instructions for generating, in response to receiving the indication of the precoding matrix, a second CSI-RS using a third set of neural network parameters of the first neural network model corresponding to the indicated precoding matrix. Some examples of the method, apparatuses, and non-transitory computer-readable medium described herein may further include operations, features, means, or instructions for transmitting the second CSI-RS to the UE. Some examples of the method, apparatuses, and non-transitory computer-readable medium described herein may further include operations, features, means, or instructions for receiving, from the UE, a feedback message including a CQI, an RI, or a combination thereof, determined using the second CSI-RS and a fourth set of neural network parameters of the second neural network model.

Some examples of the method, apparatuses, and non-transitory computer-readable medium described herein may further include operations, features, means, or instructions for receiving, from the UE, a feedback message including a CQI, the CQI determined using the CSI-RS and a third set of neural network parameters of the second neural network model.

### BRIEF DESCRIPTION OF THE DRAWINGS

FIGS. 1 and 2 illustrate examples of wireless communications systems that support neural network assisted communication techniques in accordance with one or more aspects of the present disclosure.

FIGS. 3A and 3B illustrate examples of neural network procedures that support neural network assisted communication techniques in accordance with one or more aspects of the present disclosure.

FIG. 4 illustrates an example of a machine learning process that supports techniques for indicating signal processing procedures for network deployed neural network models in accordance with one or more aspects of the present disclosure.

FIG. 5 illustrates an example of a cover code diagram that supports neural network assisted communication techniques in accordance with one or more aspects of the present disclosure.

FIGS. 6 and 7 illustrate examples of process flows that support neural network assisted communication techniques in accordance with one or more aspects of the present disclosure.

FIGS. 8 and 9 show block diagrams of devices that support neural network assisted communication techniques in accordance with one or more aspects of the present disclosure.

FIG. 10 shows a block diagram of a communications manager that supports neural network assisted communication techniques in accordance with one or more aspects of the present disclosure.

FIG. 11 shows a diagram of a system including a device that supports neural network assisted communication techniques in accordance with one or more aspects of the present disclosure.

FIGS. 12 and 13 show block diagrams of devices that support neural network assisted communication techniques in accordance with one or more aspects of the present disclosure.

FIG. 14 shows a block diagram of a communications manager that supports neural network assisted communication techniques in accordance with one or more aspects of the present disclosure.

FIG. 15 shows a diagram of a system including a device that supports neural network assisted communication techniques in accordance with one or more aspects of the present disclosure.

FIGS. 16 through 25 show flowcharts illustrating methods that support neural network assisted communication techniques in accordance with one or more aspects of the present disclosure.

### DETAILED DESCRIPTION

Some wireless communications systems may include communication devices, such as a UE and a network device, which may also be referred to as a base station (e.g., an eNodeB (eNB), a next-generation NodeB or a giga-NodeB, either of which may be referred to as a gNB, or some other base station), that may support multiple radio access technologies (RATs). Examples of RATs include 4G systems, such as LTE systems, and 5G systems, which may be referred to as NR systems, among other systems and RATs, including future systems and RATs not explicitly mentioned herein. In some examples, communication devices may utilize neural network models (e.g., neural network based machine learning models, among others) in which one or more components (e.g., a transmitter, receiver, encoder, decoder, etc.) may be configured using neural networks. For example, neural network configurations at a transmitter may provide one or more of encoding, modulation, reference signal generation, or precoding functions, among other functions, and neural network configurations at a receiver may provide one or more of synchronization, channel estimation, detection, demodulation, or decoding functions, among other functions.

In some wireless communications systems, a base station may transmit reference signals such as CSI-RSs to a UE that the UE may use to perform channel estimation procedures and provide channel state feedback (CSF) to the base station. In some examples, a base station may transmit the CSI-RSs using an orthogonal cover code within a CDM group that the UE may use to demultiplex the CSI-RSs. For example, the base station may transmit CSI-RSs via one or more resource elements of a resource block according to a CSI-RS pattern, where the CSI-RS pattern may be determined based on multiplexing antenna ports of the base station in accordance with associated orthogonal cover codes. The use of orthogonal cover codes, however, may not fully utilize the sparsity of a channel via which the CSI-RSs are transmitted in a spatial domain, time domain, and/or frequency domain. For example, a signal may be considered sparse in a particular domain if the signal has relatively few non-zero elements (e.g., non-zero coefficients) relative to its dimension in the domain. For example, the signal path of a CSI-RS using an orthogonal cover code may exist in relatively few directions between the UE and the base station, which may result in relatively few non-zero elements between the UE and the base station in the spatial domain. Accordingly, a channel via which the CSI-RS is communicated may be sparse in the spatial domain.

A cover code may be one or more matrices of values used to generate a reference signal for transmission. For example, a single cover code may be a vector of a matrix. A transmitting device (e.g., a UE or a base station) may use a given cover code as part of encoding or generating a CSI-RS to be transmitted to a receiving device. In some examples, the cover code may be specific to the transmitting device or the receiving device, while in other examples, the cover code may be specific to the type of reference signal that is generated.

Techniques, systems, and devices described herein support the use of non-orthogonal cover codes for reference signals such as CSI-RSs, which may increase efficiency in resource utilization of reference signals. That is, using non-orthogonal cover codes for a CSI-RS may enable the CSI-RS to occupy fewer overall resource elements (e.g., resource elements in the time domain or the frequency domain) than using orthogonal cover codes. For example, using a non-orthogonal cover code for a CSI-RS may enable a UE to estimate CSF for additional resource blocks and resource elements than the resource blocks and resource elements via which the CSI-RS is received. Thus, fewer resources may be used to transmit a CSI-RS in generating and reporting CSF for a channel. To generate such non-orthogonal cover codes, a communication device may use one or more neural network models. For example, a base station may implement a neural network model to generate non-orthogonal cover codes that increase network efficiency associated with CSI-RS transmissions, for example, by reducing a quantity of resource elements via which the CSI-RSs are transmitted.

A set of non-orthogonal cover codes may include one or more matrices of values that are non-orthogonal to every other matrix of values in the set. For example, a first cover code may be a first vector of a matrix and a second cover code may be a second vector of the matrix. The two cover codes are considered to be orthogonal when the inner product of the two cover codes is zero. Alternatively, when the inner product of two cover codes is non-zero, the two cover codes are non-orthogonal. A bit sequence, such as a binary bit sequence consisting of zeros and ones, may be considered an example of a special case of matrices. Thus, when the product of two binary sequences (or cover codes) results in an equal number of ones and zeros, the inner product is zero. Alternatively, when the product of two binary sequences (or cover codes) results in different numbers of ones and zeros, the inner product is non-zero, and the two cover codes are non-orthogonal.

A UE may perform channel estimation on the CSI-RSs generated using the non-orthogonal cover codes by using a neural network model for channel estimation (e.g., a set of neural network weights of the neural network model) that corresponds to the non-orthogonal cover code.

For example, the base station may transmit a CSI-RS to the UE that is associated with (e.g., multiplexed using) a non-orthogonal cover code of a set non-orthogonal cover codes. Using the CSI-RS, the UE may perform a channel estimation procedure that corresponds to the non-orthogonal cover code to determine one or more channel quality parameters (e.g., a channel quality, a signal-to-noise ratio (SNR), a signal-to-interference-plus-noise ratio (SINR), a reference signal receive power (RSRP), channel state information (CSI), or some other channel quality parameter) associated with the CSI-RS. In some examples of the channel estimation procedure, the UE may demultiplex the CSI-RS using the non-orthogonal cover code and may input the demultiplexed CSI-RS into a neural network model that uses a set of neural network parameters (e.g., weights, functions) corresponding to the non-orthogonal cover code. In some other examples of the channel estimation procedure, the UE may directly input the CSI-RS into the neural network model that uses the set of neural parameters corresponding to the non-orthogonal cover code (e.g., without demultiplexing the CSI-RS). Based on the channel estimation procedure, the UE may transmit a feedback message (e.g., a CSF message) that indicates the one or more channel quality parameters.

In some examples, to support the use of non-orthogonal cover codes in communicating CSI-RSs, the base station may indicate a quantity of transmission ports associated with transmission of a CSI-RS. For example, the base station may transmit an indication of the quantity of transmission ports used by the base station to transmit a CSI-RS (e.g., a subsequent CSI-RS). A length of the non-orthogonal cover code per resource block via which the CSI-RS is transmitted may be based on the quantity of transmission ports. For example, there may be an association between the quantity of transmission ports and the length of the non-orthogonal cover code such that the indication of the quantity of transmission ports may implicitly indicate the length of the non-orthogonal cover code (e.g., the length is half of the quantity of transmission ports, among other associations). The UE may use a neural network model that supports channel estimation for a CSI-RS communicated using the indicated quantity of transmission ports and one or more non-orthogonal cover codes having the associated length.

Techniques, systems, and devices are additionally described herein to utilize neural network models in parameter reporting. For example, a base station may generate a CSI-RS using a first set of neural network parameters of a first neural network model for reference signals and may transmit the CSI-RS to the UE. In some examples, the first set of neural network parameters may correspond to a non-orthogonal cover code used to multiplex the CSI-RS. The UE may determine a precoding matrix for communications between the UE and the base station using the CSI-RS and a second set of neural network parameters of a second neural network model for channel estimation. In some examples, the second set of neural network parameters may correspond to the non-orthogonal cover code. The UE may transmit a precoding matrix indicator (PMI) to the base station that indicates the determined precoding matrix and may communicate with the base station in accordance with the precoding matrix.

In some examples, utilizing non-orthogonal cover codes and neural network models may reduce resource overhead, increase spectral efficiency, and increase resource usage utilization. For example, by using non-orthogonal cover codes, CSI-RSs may be communicated via fewer time and frequency resources (e.g., fewer resource elements, fewer resource blocks) compared to communicating CSI-RSs using orthogonal cover codes, thereby reducing resource overhead and increasing resource efficiency associated with communicating the CSI-RSs. In some other examples, utilizing non-orthogonal cover codes and neural network models may reduce latency and power consumption and increase battery life, and processing capability, among other benefits. For example, communicating CSI-RSs over fewer resources based on using non-orthogonal cover codes and using neural network models to support channel estimation based on such CSI-RSs may reduce latency and processing associated with communicating and decoding the CSI-RSs over additional resources, thereby reducing power consumption, increasing battery life, and increasing processing capability.

Aspects of the disclosure are initially described in the context of wireless communications systems. Aspects of the disclosure are additionally described in the context of neural network procedures, a machine learning process, a cover code diagram, and process flows. Aspects of the disclosure are further illustrated by and described with reference to apparatus diagrams, system diagrams, and flowcharts that relate to neural network assisted communication techniques.

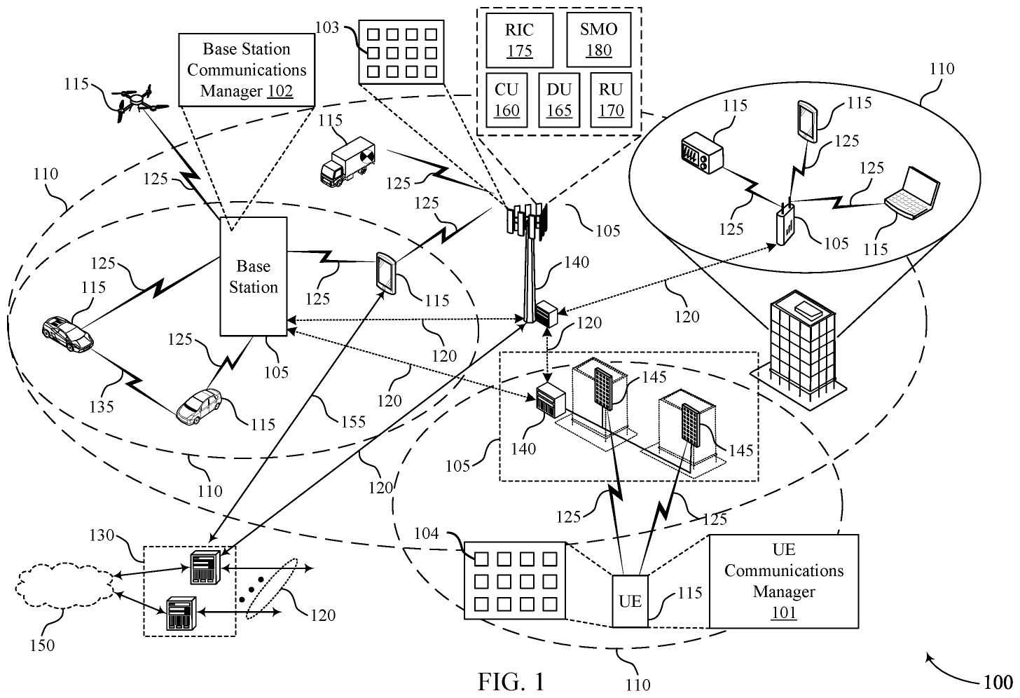

FIG. 1 illustrates an example of a wireless communications system 100 that supports neural network assisted communication techniques in accordance with one or more aspects of the present disclosure. The wireless communications system 100 may include one or more base stations 105, such as one or more network devices 140, which may also be referred to as network entities, one or more UEs 115, and a core network 130. In some examples, the wireless communications system 100 may be an LTE network, an LTE-A network, an LTE-A Pro network, an NR network, or a network operating in accordance with other systems and RATs, including future systems and RATs not explicitly mentioned herein. In some examples, the wireless communications system 100 may support enhanced broadband communications, ultra-reliable (e.g., mission critical) communications, low latency communications, communications with low-cost and low-complexity devices, or any combination thereof.

The base stations 105, network devices 140, or both may be dispersed throughout a geographic area to form the wireless communications system 100 and may be devices in different forms or having different capabilities. The base stations 105, network devices 140, or both and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, network devices 140, or network equipment (e.g., core network nodes, relay devices, integrated access and backhaul (IAB) nodes, or other network equipment), as shown in FIG. 1.

The base stations 105, network devices 140, or both may communicate with the core network 130, or with one another, or both. For example, the base stations 105, network devices 140, or both may interface with the core network 130 through one or more backhaul links 120 (e.g., via an S1, N2, N3, or other interface). The base stations 105, network devices 140, or both may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105, network devices 140, or both described herein may include or may be referred to by a person having ordinary skill in the art as a base transceiver station, a radio base station, an access point, a radio transceiver, a NodeB, an eNB, a next-generation NodeB or a giga-NodeB (either of which may be referred to as a gNB), a Home NodeB, a Home eNodeB, or other suitable terminology. A UE 115 may communicate with the core network 130 through a communication link 155.

As described herein, a node, which may be referred to as a node, a network node, a network device 140, a network entity, or a wireless node, may be a base station 105 (e.g., any base station described herein), a UE 115 (e.g., any UE described herein), a network controller, an apparatus, a device, a computing system, one or more components, and/or another suitable processing entity configured to perform any of the techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different relative to these examples.

Similarly, reference to a UE 115, base station 105, apparatus, device, computing system, or the like may include disclosure of the UE 115, base station 105, apparatus, device, computing system, or the like being a network node. For example, disclosure that a UE 115 is configured to receive information from a base station 105 also discloses that a first network node is configured to receive information from a second network node. Consistent with this disclosure, once a specific example is broadened in accordance with this disclosure (e.g., a UE 115 is configured to receive information from a base station 105 also discloses that a first network node is configured to receive information from a second network node), the broader example of the narrower example may be interpreted in the reverse, but in a broad open-ended way. In the example above where a UE 115 being configured to receive information from a base station 105 also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a first one or more components, a first processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, a network device 140 may be implemented in a disaggregated architecture (e.g., a disaggregated base station architecture, a disaggregated RAN architecture), which may be configured to utilize a protocol stack that is physically or logically distributed among two or more network devices 140, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network device 140 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network devices 140 in a disaggregated RAN architecture may be co-located, or one or more components of the network devices 140 may be located in distributed locations (e.g., separate physical locations). In some examples, one or more network devices 140 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1 c, F1 u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network devices 140 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network devices 140 (e.g., IAB nodes) may be partially controlled by each other. One or more IAB nodes may be referred to as a donor entity or an IAB donor. One or more DUs 165 or one or more RUs 170 may be partially controlled by one or more CUs 160 associated with a donor network device 140 (e.g., a donor base station 105). The one or more donor network devices 140 (e.g., IAB donors) may be in communication with one or more additional network devices 140 (e.g., IAB nodes) via supported access and backhaul links (e.g., backhaul communication links 120). IAB nodes may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node used for access via the DU 165 of the IAB node (e.g., referred to as virtual IAB-MT (vIAB-MT)). In some examples, the IAB nodes may include DUs 165 that support communication links with additional entities (e.g., IAB nodes, UEs 115) within the relay chain or configuration of the access network (e.g., downstream). In such cases, one or more components of the disaggregated RAN architecture (e.g., one or more IAB nodes or components of IAB nodes) may be configured to operate according to the techniques described herein.

For instance, an access network (AN) or RAN may include communications between access nodes (e.g., an IAB donor), IAB nodes, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node may refer to a RAN node that provides IAB functionality (e.g., access for UEs 115, wireless self-backhauling capabilities). A DU 165 may act as a distributed scheduling node towards child nodes associated with the IAB node, and the IAB-MT may act as a scheduled node towards parent nodes associated with the IAB node. That is, an IAB donor may be referred to as a parent node in communication with one or more child nodes (e.g., an IAB donor may relay transmissions for UEs through one or more other IAB nodes). Additionally, or alternatively, an IAB node may also be referred to as a parent node or a child node to other IAB nodes, depending on the relay chain or configuration of the AN. Therefore, the IAB-MT entity of IAB nodes may provide a Uu interface for a child IAB node to receive signaling from a parent IAB node, and the DU interface (e.g., DUs 165) may provide a Uu interface for a parent IAB node to signal to a child IAB node or UE 115.

For example, IAB node may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes. For example, the DU 165 of IAB donor may relay transmissions to UEs 115 through IAB nodes, and may directly signal transmissions to a UE 115. The CU 160 of IAB donor may signal communication link establishment via an F1 interface to IAB nodes, and the IAB nodes may schedule transmissions (e.g., transmissions to the UEs 115 relayed from the IAB donor) through the DUs 165. That is, data may be relayed to and from IAB nodes via signaling over an NR Uu interface to MT of the IAB node. Communications with IAB node may be scheduled by a DU 165 of IAB donor and communications with IAB node may be scheduled by DU 165 of IAB node.

In the case of the techniques described herein applied in the context of a disaggregated RAN architecture, one or more components of the disaggregated RAN architecture may be configured to support active interference cancellation for sidelink transmissions as described herein. For example, some operations described as being performed by a UE 115 or a network device 140 (e.g., a base station 105) may additionally, or alternatively, be performed by one or more components of the disaggregated RAN architecture (e.g., IAB nodes, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105, network devices 140, or both and the network equipment including macro eNBs or gNBs, small cell eNBs or gNBs, or relay base stations, among other examples, as shown in FIG. 1.

The UEs 115 and the base stations 105, network devices 140, or both may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

Signal waveforms transmitted over a carrier may be made up of multiple subcarriers (e.g., using multi-carrier modulation (MCM) techniques such as orthogonal frequency division multiplexing (OFDM) or DFT-S-OFDM). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ−N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105, network device 140, or both may be movable and therefore provide communication coverage for a moving geographic coverage area 110. In some examples, different geographic coverage areas 110 associated with different technologies may overlap, but the different geographic coverage areas 110 may be supported by the same base station 105, network device 140, or both. In other examples, the overlapping geographic coverage areas 110 associated with different technologies may be supported by different base stations 105, network devices 140, or both. The wireless communications system 100 may include, for example, a heterogeneous network in which different types of the network device 140 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105, network device 140, or both. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105, network device 140, or both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an network device 140, which may be an example of an access node controller (ANC). Each network device 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each network device 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105, network device 140, or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105, network device 140, or both may have an antenna array with a number of rows and columns of antenna ports 103 that the base station 105, network device 140, or both may use to support beamforming of communications with a UE 115. Likewise, a UE 115 may have one or more antenna arrays with a number of rows and columns of antenna ports 104 that may support various MIMO or beamforming operations. Additionally or alternatively, an antenna panel may support radio frequency beamforming for a signal transmitted via an antenna port 103 or an antenna port 104.

The base stations 105, network devices 140, or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports 103 or antenna ports 104 used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115, a network device 140) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105, a network device 140, or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105, a network device 140, or both multiple times in different directions. For example, the base station 105, a network device 140, or both may transmit a signal according to different beamforming weight sets associated with different directions of transmission. Transmissions in different beam directions may be used to identify (e.g., by a transmitting device, such as a base station 105, a network device 140, or both, or by a receiving device, such as a UE 115) a beam direction for later transmission or reception by the base station 105, a network device 140, or both.

Some signals, such as data signals associated with a particular receiving device, may be transmitted by a base station 105, a network device 140, or both in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105, a network device 140, or both in different directions and may report to the base station 105, a network device 140, or both an indication of the signal that the UE 115 received with a highest signal quality or an otherwise acceptable signal quality.

In some examples, transmissions by a device (e.g., by a base station 105, a network device 140, or a UE 115) may be performed using multiple beam directions, and the device may use a combination of digital precoding or radio frequency beamforming to generate a combined beam for transmission (e.g., from a base station 105 or a network device 140 to a UE 115). The UE 115 may report feedback that indicates precoding weights for one or more beam directions, and the feedback may correspond to a configured number of beams across a system bandwidth or one or more sub-bands. The base station 105, a network device 140, or both may transmit a reference signal (e.g., a cell-specific reference signal (CRS), a CSI-RS)), which may be precoded or unprecoded. The UE 115 may provide feedback for beam selection, which may be a PMI or codebook-based feedback (e.g., a multi-panel type codebook, a linear combination type codebook, a port selection type codebook). Although these techniques are described with reference to signals transmitted in one or more directions by a base station 105, a network device 140, or a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, a network device 140, or both, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest SNR, or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

A base station 105, a network device 140, or both may gather channel condition information from a UE 115 to efficiently configure and/or schedule the channel. This information may be transmitted by the UE 115 in the form of a channel state report (or CSI report). A channel state report may contain an RI requesting a number of layers to be used for downlink transmissions (e.g., based on antenna ports 104 of the UE 115), a PMI indicating a preference for which precoder matrix should be used (e.g., based on a number of layers), and a CQI representing a highest modulation and coding scheme (MCS) that may be used. In some cases, the RI may be associated with a number of antennas used by a device. CQI may be calculated by a UE 115 after receiving predetermined pilot symbols such as CRSs or CSI-RSs. RI and PMI may be excluded if the UE 115 does not support spatial multiplexing (or is not operating in a supported spatial mode). In some examples, the types of information included in the CSI report determines a reporting type. Channel state reports may be periodic or aperiodic. Further, channel state reports may have different types based on a codebook used to generate the report. For instance, a Type I CSI report may be based on a first codebook and a Type II CSI report may be based on a second codebook, where the first and second codebooks may be based on different antenna configurations. In some cases, the use of either Type I or Type II CSI reports may improve MIMO performance (as compared to other types of CSI reports). In some cases, a Type II CSI report may be carried at least on a physical uplink shared channel (PUSCH), and may provide CSI to a base station 105 with a relatively higher level of granularity (e.g., for MU-MIMO services).

A base station 105, a network device 140, or both may transmit CSI-RSs according to a CSI-RS pattern, where the CSI-RS locations (e.g., the resource element locations) within a resource block may be determined based on the CSI-RS pattern. CSI-RS patterns may be based on a quantity of antenna ports 103. For example, different CSI-RS patterns may be defined for CSI-RS transmissions using one, two, four, eight, twelve, sixteen, twenty-four, thirty two, or any other quantity of antenna ports 103. CSI-RS patterns may be determined by multiplexing the antenna ports 103 according to FDM and/or CDM techniques. In some examples, each antenna port 103 may be associated with a cover code that may be orthogonal or non-orthogonal with respect to cover codes associated with different antenna ports 103. CSI-RS patterns may additionally include one or more component CSI-RS resource element patterns, where a component CSI-RS resource element pattern may included adjacent resource elements in the frequency domain and z adjacent resource elements in the time domain withy and z being non-zero positive integers. In some cases, two component CSI-RS resource element patterns may be adjacent or non-adjacent in the frequency domain, while the resource elements within a given component CSI-RS resource element pattern may be adjacent in both the time domain and frequency domain.

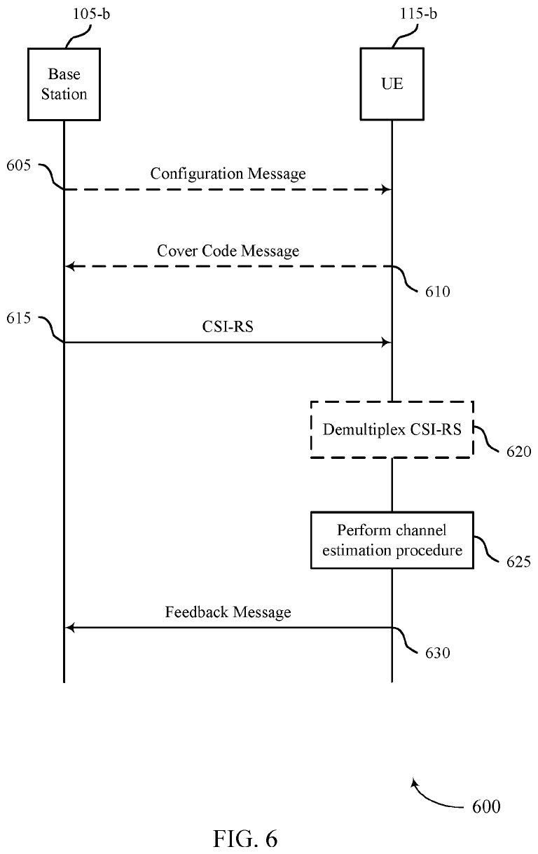

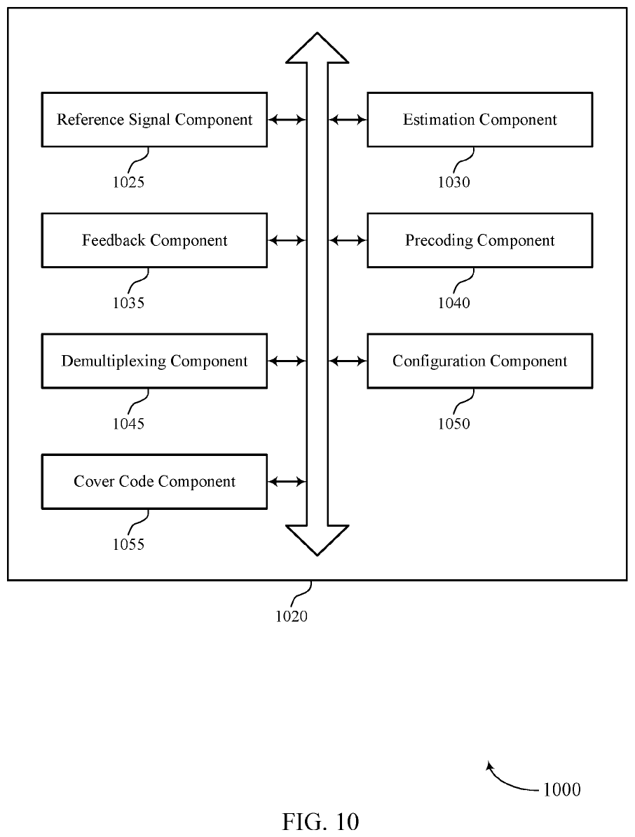

The wireless communications system 100 may be configured to utilize non-orthogonal cover codes and/or neural network models for wireless communications in the wireless communications system 100. For example, UEs 115 may include a UE communications manager 101 and base stations 105 may include a base station communications manager 102 that may each non-orthogonal cover code and neural network model implementations. The UE communications manager 101 may be an example of aspects of a communications manager as described in FIGS. 6 through 9. The base station communications manager 102 may be an example of aspects of a communications manager as described in FIGS. 10 through 13.

By way of example, a base station 105 (e.g., using a base station communications manager 102) may transmit a CSI-RS to a UE 115 that is associated with (e.g., multiplexed using) a non-orthogonal cover code of a set non-orthogonal cover codes. Using the CSI-RS, the UE 115 (e.g., using the UE communications manager 101) may perform a channel estimation procedure that corresponds to the non-orthogonal cover code to determine one or more channel quality parameters (e.g., a channel quality, an SNR, an SINR, an RSRP, CSI, or some other channel quality parameter) associated with the CSI-RS. In some examples of the channel estimation procedure, the UE 115 may demultiplex the CSI-RS using the non-orthogonal cover code and may input the demultiplexed CSI-RS into a neural network model that uses a set of neural network parameters (e.g., weights) corresponding to the non-orthogonal cover code. In some other examples of the channel estimation procedure, the UE 115 may directly input the CSI-RS into the neural network model that uses the set of neural parameters corresponding to the non-orthogonal cover code. Based on the channel estimation procedure, the UE 115 may transmit a feedback message (e.g., a CSF message) that indicates the one or more channel quality parameters.

In another example, a base station 105 may generate a CSI-RS using a first set of neural network parameters (e.g., corresponding to a non-orthogonal cover code associated with the CSI-RS) of a first neural network model for reference signals and may transmit the CSI-RS to a UE 115. The UE 115 may determine a precoding matrix using the CSI-RS and a second set of neural network parameters (e.g., corresponding to the non-orthogonal cover code) of a second neural network model for channel estimation. The UE 115 may transmit a PMI to the base station 105 that indicates the determined precoding matrix and may communicate with the base station 105 in accordance with the precoding matrix or a different precoding matrix selected and indicated by the base station 105.

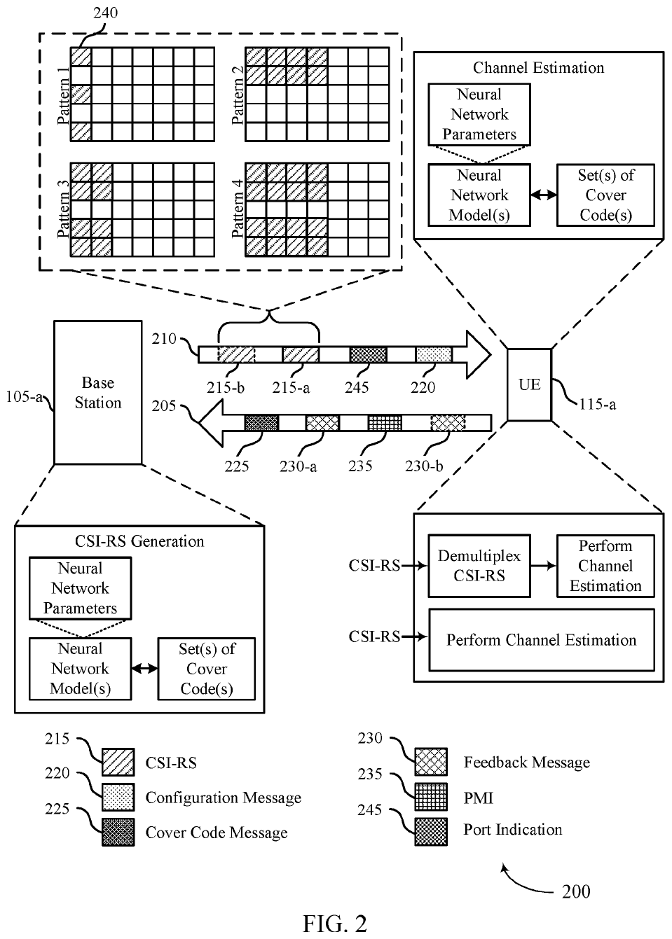

FIG. 2 illustrates an example of a wireless communications system 200 that supports neural network assisted communication techniques in accordance with one or more aspects of the present disclosure. The wireless communications system 200 may implement aspects of the wireless communications system 100 or may be implemented by aspects of the wireless communications system 100. For example, the wireless communications system 200 may include a base station 105-a and a UE 115-a, which may be examples of the corresponding devices described with reference to FIG. 1. In some examples, the wireless communications system 200 may support multiple RATs including 4G systems such as LTE systems, LTE-A systems, or LTE-A Pro systems, and 5G systems which may be referred to as NR systems. In some cases, the base station 105-a and the UE 115-a may support utilizing neural network models and non-orthogonal cover codes to increase data rates, resource usage, spectral efficiency, coordination between the base station 105-a and the UE 115-a, and processing capability and to reduce latency and power consumption, among other benefits.

The wireless communications system 200 may support communications between the base station 105-a and the UE 115-a. For example, the UE 115-a may transmit uplink messages to the base station 105-a via an uplink channel 205, and the base station 105-a may transmit downlink messages to the UE 115-a via a downlink channel 210. The uplink channel 205 may be an example of a physical uplink channel such as a physical uplink control channel (PUCCH), a PUSCH, a physical random access channel (PRACH), or some other physical uplink channel. The downlink channel 210 may be an example of a physical downlink channel such as a physical downlink control channel (PDCCH), a physical downlink shared channel (PDSCH), a PRACH, a physical broadcast channel (PBCH), or some other physical downlink channel.

The base station 105-a and the UE 115-a may implement neural network models to assist with communications between the base station 105-a and the UE 115-a. For example, the base station 105-a may use a first neural network model to generate non-orthogonal cover codes which may be applied to CSI-RS transmissions, and in some examples, the UE 115-a may use a second neural network model for performing channel estimation procedures corresponding to the non-orthogonal cover codes.

The base station 105-a may transmit CSI-RSs 215 that are associated with non-orthogonal cover codes. For example, the base station 105-a may generate a non-orthogonal cover code for a CSI-RS 215-a using a first set of neural network parameters (e.g., neural network weights) of the first neural network model and may transmit the CSI-RS 215-a in accordance with the non-orthogonal cover code. That is, the base station 105-a may apply the non-orthogonal cover code to the CSI-RS 215-a and transmit the CSI-RS 215-a to the UE 115-a. In some examples, applying the non-orthogonal cover code to the CSI-RS 215-a may result in transmitting the CSI-RS 215-a in different resource elements of a resource block compared to applying an orthogonal cover code to the CSI-RS 215-a. CSI-RS 215-a may be transmitted in one or more resources elements 240 according to a pattern. For example, CSI-RS 215-a may be transmitted via resource elements 240 according to Pattern 1, Pattern 2, Pattern 3, or Pattern 4, as shown, and each pattern may correspond to a set of resources (e.g., resource elements 240) via which CSI-RS 215-a may be transmitted. Other patterns may be considered without departing from the scope of the present disclosure.

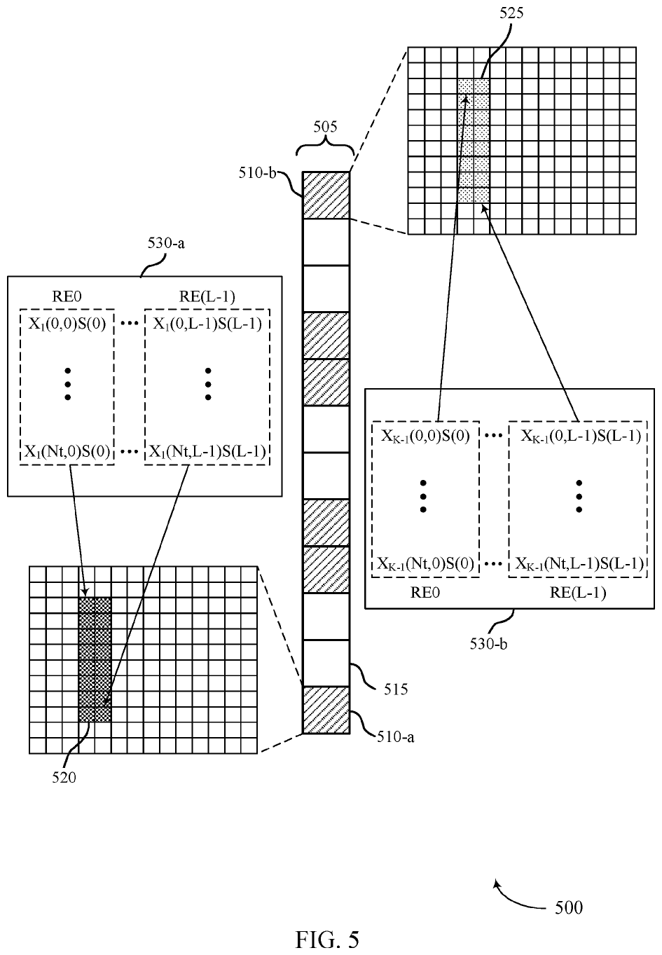

In some examples, the base station 105-a may transmit a port indication 245 to the UE 115-a that indicates a quantity of transmission ports (e.g., antenna ports 103) associated with transmission of the CSI-RS 215-a. For example, the indicated quantity of transmission ports may be the quantity of transmission ports used by the base station 105-a to transmit the CSI-RS 215-a. The base station 105-a may transmit the port indication 245 prior to transmitting the CSI-RS 215-a. In some examples, a length of the non-orthogonal cover code applied to the CSI-RS 215-a may be based on the indicated quantity of transmission ports. In some examples, a quantity of resource blocks via which the CSI-RS 215-a is transmitted, a quantity of resource elements 240 via which the CSI-RS 215-a is transmitted, a pattern of the resource elements 240, or a combination thereof, may be based on the indicated quantity of transmission ports, the second neural network model, or both. Additional details related to the indication of the quantity of transmission ports and its relation to CSI-RS transmission using non-orthogonal cover codes are described with reference to FIG. 5 below.

The UE 115-a may receive the CSI-RS 215-a and, using the CSI-RS 215-a, may perform a channel estimation procedure corresponding to the non-orthogonal cover code. In some examples, the UE 115-a may perform the channel estimation procedure without using the second neural network model. In some other examples, the UE 115-a may use the second neural network model to perform the channel estimation procedure. For example, the UE 115-a may demultiplex the CSI-RS 215-a according to the non-orthogonal cover code and may input the demultiplexed CSI-RS 215-a into the second neural network model to perform the channel estimation procedure. Alternatively, the UE 115-a may input the CSI-RS 215-a directly into the second neural network model (e.g., without previously demultiplexing the CSI-RS 215-a) to perform the channel estimation procedure. In either example, the UE 115-a may use a set of neural network parameters for the second neural network model that corresponds to the non-orthogonal cover code. The second neural network model may output feedback bits indicating one or more channel quality parameters (e.g., a channel quality, an SNR, an SINR, an RSRP, CSI, or some other channel quality parameter) associated with the CSI-RS 215-a.

The UE 115-a may determine the set of neural network parameters corresponding to the non-orthogonal cover code according to various techniques. In a first example, the base station 105-a may indicate the non-orthogonal cover code via a location of the resource elements 240 (e.g., a location within a resource block, TTI, or set of time-frequency resources) used to transmit the CSI-RS 215-a. For example, the resource elements 240 via which the base station 105-a transmits the CSI-RS 215-a may indicate the non-orthogonal cover code associated with (e.g., used to multiplex) the CSI-RS 215-a. Accordingly, the UE 115-a may determine the non-orthogonal cover code associated with the CSI-RS 215-a based on the resource location(s) and may select the set of neural network parameters of the second neural network model corresponding to the non-orthogonal cover code to perform the channel estimation procedure. In some examples, the UE 115-a may reference a table stored at the UE 115-a that maps CSI-RS 215-a resource locations to cover codes to determine the non-orthogonal cover code.

In a second example, the base station 105-a may transmit a configuration message 220 to the UE 115-a that configures (e.g., indicates) a particular non-orthogonal cover code of a set of non-orthogonal cover codes for one or more CSI-RSs 215 (e.g., including the CSI-RS 215-a). For example, the base station 105-a may use different non-orthogonal cover codes for different transmission scenarios such as for different propagation environments, different channel conditions, different bandwidths associated with a CSI-RS 215, different resource locations of a CSI-RS 215, different CDM types used to multiplex a CSI-RS 215, or a combination thereof. Accordingly, the base station 105-a may select and apply the non-orthogonal cover code associated with the CSI-RS 215-a based on the transmission scenario associated with the CSI-RS 215-a. That is, the base station 105-a may transmit the CSI-RS 215-a in accordance with a set of communication parameters (e.g., a propagation environment, one or more channel conditions, a location of one or more of the CSI-RS 215-a resources, a CDM type, a bandwidth) and may use a non-orthogonal cover code for the CSI-RS 215-a that corresponds to the set of communications parameters. The base station 105-a may transmit the configuration message 220 (e.g., via RRC signaling, downlink control information (DCI), or a MAC-control element (MAC-CE)) to indicate the set of communication parameters. The UE 115-a may receive the CSI-RS 215-a in accordance with indicated set of communication parameters and may select (e.g., identify, determine) the non-orthogonal cover code from the set of non-orthogonal cover codes based on receiving the CSI-RS 215-a in accordance with the indicated set of communication parameters. Based on selecting the non-orthogonal cover code, the UE 115-a may select the set of neural network parameters of the second neural network model corresponding to the non-orthogonal cover code to perform the channel estimation procedure.

In a third example, the base station 105-a may transmit a configuration message 220 to the UE 115-a that indicates a set of neural network parameters of the second neural network model to use for channel estimation. Here, the UE 115-a may use the indicated set of neural network parameters independent of the non-orthogonal cover code associated with the CSI-RS 215-a. That is, the UE 115-a may be unaware of the non-orthogonal cover code associated with the CSI-RS 215-a and may use the indicated set of neural network parameters for the channel estimation procedure regardless of the non-orthogonal cover associated with the CSI-RS 215-a. In some examples of the UE 115-a using the indicated set of neural network parameters, the UE 115-a may refrain from determining the non-orthogonal cover code associated with the CSI-RS 215-a.

In a fourth example, the UE 115-a may be configured (e.g., triggered, indicated) to indicate one or more preferred non-orthogonal cover codes. For example, the UE 115-a may transmit a cover code message 225 to the base station 105-a that may indicate a first set of one or more non-orthogonal cover codes. The base station 105-a may receive the cover code message 225 and may transmit the CSI-RS 215-a in accordance with one of the non-orthogonal cover codes of the first set of non-orthogonal cover codes. In some examples, the UE 115-a may select a set of neural network parameters of the second neural network model that corresponds to the first set of non-orthogonal cover codes and may perform the channel estimation procedure using the selected set of neural network parameters. That is, based on transmitting the cover code message 225, the UE 115-a may assume that the base station 105-a will use one of the non-orthogonal cover codes of the indicated set of non-orthogonal cover codes to transmit the CSI-RS 215-a and may select the set of neural network parameters that corresponds to the first set of non-orthogonal cover codes. In some examples, the UE 115-a may transmit the cover code message 225 via RRC signaling, random access signaling, or via some other uplink message via the uplink channel 205.

The cover code message 225 may include a set of indexes that indicates the first set of non-orthogonal cover codes. For example, the base station 105-a may configure the UE 115-a with a set of cover code options and the UE 115-a may report one or more indexes of these options as the first set of non-orthogonal cover codes. For instance, the base station 105-a may transmit a configuration message 220 to the UE 115-a that indicates a second set of non-orthogonal cover codes that includes at least the first set of non-orthogonal cover codes, and the UE 115-a may select its preferred non-orthogonal cover codes from the second set of non-orthogonal cover codes (e.g., the first set of non-orthogonal cover codes). To indicate the first set of non-orthogonal cover codes, the UE 115-a may transmit the cover code message 225 that includes indexes corresponding to the non-orthogonal cover codes of the first set of non-orthogonal cover codes.

In some examples, based on the cover code message 225, the base station 105-a may transmit the configuration message 220 to configure the UE 115-a with a set of neural network parameters of the second neural network model. For example, in response to receiving the cover code message 225 that indicates the first set of non-orthogonal cover codes (e.g., the preferred non-orthogonal cover codes), the base station 105-a may transmit the configuration message 220 that indicates a set of neural network parameters of the second neural network model that corresponds to one or more non-orthogonal cover codes of the first set of non-orthogonal cover codes. The UE 115-a may use the set of neural network parameters indicated by the configuration message 220 to perform the channel estimation procedure.

In some examples, based on the cover code message 225, the base station 105-a may transmit the configuration message 220 to configure the UE 115-a with a subset of non-orthogonal cover codes of the first set of non-orthogonal cover codes. For example, in response to receiving the cover code message 225, the base station 105-a may select one or more non-orthogonal cover codes of the first set of non-orthogonal cover codes to use to transmit CSI-RSs 215. The base station 105-a may transmit the configuration message 220 to indicate the selected one or more non-orthogonal cover codes of the first set of non-orthogonal cover codes. In response to receiving the configuration message 220, the UE 115-a may select a set of neural network parameters of the second neural network model that corresponds to the selected one or more non-orthogonal cover codes to perform the channel estimation procedure. For example, there may be a relationship between the selected one or more non-orthogonal cover codes and the set of neural network parameters, such as a mapping between the selected one or more non-orthogonal cover codes and the set of neural network parameters that is standardized or configured by the base station 105-a. Accordingly, based on the relationship, the UE 115-a may select the set of neural network parameters.

In any example of determining the set of neural network parameters of the second neural network model, or performing the channel estimation procedure, or both, the UE 115-a may calculate one or more channel quality parameters based on the channel estimation procedure and report the one or more channel quality parameters to the base station 105-a. For example, the UE 115-a may transmit a feedback message 230-a via the uplink channel 205 to the base station 105-a that indicates that one or more channel quality parameters.

Additionally, or alternatively, the UE 115-a may use the second neural network model to report various parameter indications. In a first example, the UE 115-a may select a set of neural network parameters of the second neural network model that may be used to determine a precoding matrix based on the CSI-RS 215-a. In some examples, the UE 115-a may use the techniques described herein (e.g., via CSI-RS 215-a resource location(s), via a configuration message 220, via a cover code message 225, or a combination thereof) to select a set of neural network parameters for precoding matrix determination that corresponds to the non-orthogonal cover code associated with the CSI-RS 215-a. The UE 115-a may input the CSI-RS 215-a (e.g., with or without demultiplexing the CSI-RS 215-a based on the non-orthogonal cover code) into the second neural network model to determine a precoding matrix for communications between the UE 115-a and the base station 105-a based on the CSI-RS 215-a. The UE 115-a may transmit a PMI 235 that indicates the determined precoding matrix to the base station 105-a.

In some cases, the base station 105-a may receive the PMI 235 and may use a set of neural network parameters of a third neural network model to recover (e.g., determine) the precoding matrix indicated by the PMI 235. In some examples, the base station 105-a may precode a CSI-RS 215-b according to the precoding matrix and may transmit CSI-RS 215-b to the UE 115-a (e.g., using a same non-orthogonal cover code as the CSI-RS 215-a, using a different non-orthogonal cover code than the CSI-RS 215-a). In some cases, CSI-RS 215-b may be generated based on the PMI 235 and transmitted in response to the PMI 235 received at the base station 105-a. CSI-RS 215-b may be transmitted in one or more resources elements 240 according to a pattern. For example, CSI-RS 215-b may be transmitted via resource elements 240 according to Pattern 1, Pattern 2, Pattern 3, or Pattern 4, as shown, and each pattern may correspond to a set of resources (e.g., resource elements 240) via which CSI-RS 215-b may be transmitted. Other patterns may be considered without departing from the scope of the present disclosure.

The UE 115-a may receive the CSI-RS 215-b and may perform a second channel estimation procedure of the CSI-RS 215-b. In some examples, the UE 115-a may select a second set of neural network parameters of the second neural network model that corresponds to the non-orthogonal cover code associated with the CSI-RS 215-b and may perform the second channel estimation procedure using the second set of neural network parameters to determine a CQI, an RI, or both. The UE 115-a may transmit a feedback message 230-b (e.g., a second feedback message) to the base station 105-a that indicates the CQI, RI, or both.

In a second example, the UE 115-a may select a set of neural network parameters of the second neural network model that may be used to determine a CQI based on the CSI-RS 215-a. In some examples, the UE 115-a may use the techniques described herein (e.g., via CSI-RS 215-a resource location(s), via a configuration message 220, via a cover code message 225, or a combination thereof) to select a set of neural network parameters for CQI determination that corresponds to the non-orthogonal cover code associated with the CSI-RS 215-a. The UE 115-a may input the CSI-RS 215-a (e.g., with or without demultiplexing the CSI-RS 215-a based on the non-orthogonal cover code) into the second neural network model to determine a CQI based on the CSI-RS 215-a. The UE 115-a may transmit the feedback message 230-b to the base station 105-a that includes the CQI and in some cases, a set of neural network parameters associated with the second neural network model.

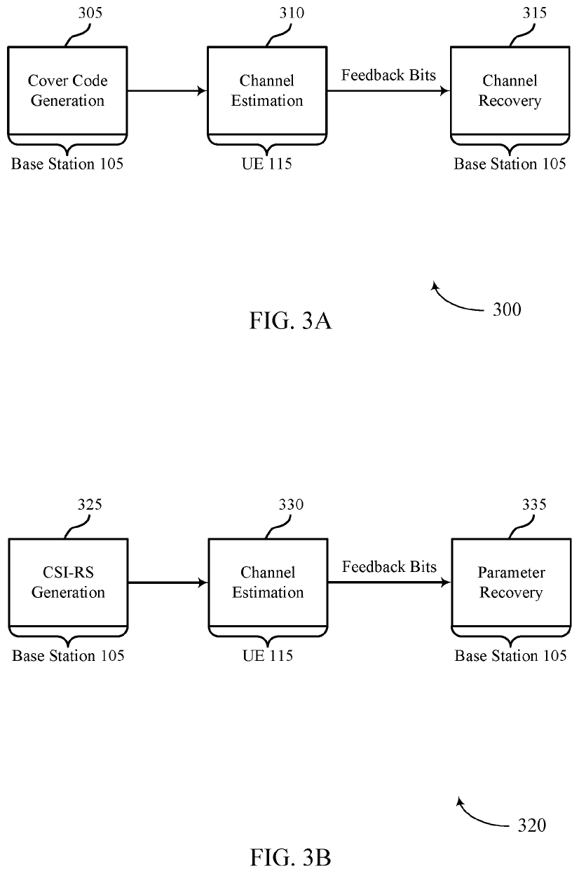

FIG. 3A illustrates an example of a neural network procedure 300 that supports neural network assisted communication techniques in accordance with one or more aspects of the present disclosure. The neural network procedure 300 may implement aspects of the wireless communications systems 100 and 200 or may be implemented by aspects of the wireless communications system 100 and 200 as described with reference to FIGS. 1 and 2, respectively. For example, the neural network procedure 300 may be implemented by a UE 115 and a base station 105 to support utilizing neural network models and non-orthogonal cover codes in wireless communications between the UE 115 and the base station 105.

In the following description of the neural network procedure 300, the operations performed by the base station 105 and the UE 115 may be performed in different orders or at different times. Some operations may also be omitted from the neural network procedure 300, and other operations may be added to the neural network procedure 300.

In some examples, the neural network procedure 300 may be an example of a training procedure during which one or more neural network models (e.g., or sets of neural network parameters for neural network models) at the base station 105 and the UE 115 are trained. Following the training procedure, the respective neural network models may be implemented at the base station 105 and the UE 115 to assist in performing various operations related to wireless communications, which in some examples, may be performed according to the neural network procedure 300.

For example, at 305, the base station 105 may train a first neural network model to generate non-orthogonal cover codes for CSI-RS transmissions. In some cases, training the first neural network model at 305 may be an example of a downlink pilot training procedure. The base station 105 may train multiple sets of neural network parameters (e.g., weights of the neural network model) that may each be used to generate non-orthogonal cover codes. In some examples, each set of neural network parameters may correspond to different potential channel conditions of a channel between the base station 105 and the UE 115, or to different parameters associated with a CSI-RS transmission, or both. For example, each set of neural network parameters may correspond to one or more channel conditions (e.g., a propagation environment, a channel quality, an SNR, an SINR, an RSRP, or some other channel condition) of the channel, a bandwidth associated with a CSI-RS, a location of one or more resources (e.g., resource elements) used to transmit the CSI-RS, a CDM type associated with the CSI-RS, or a combination thereof. Accordingly, the base station 105 may select which set of neural network parameters to use to generate a non-orthogonal cover code for a CSI-RS transmission based on a scenario (e.g., a set of channel conditions, a set of parameters) of the CSI-RS transmission.

In some examples, the base station 105 may use the first neural network model to generate a CSI-RS pattern for a CSI-RS transmission that corresponds to a non-orthogonal cover code. The base station 105 may transmit the CSI-RS according the generated CSI-RS pattern.

At 310, the UE 115 may train a second neural network model for channel estimation using CSI-RSs having non-orthogonal cover codes. In some cases, training the second neural network model at 310 may be an example of an uplink feedback training procedure. The UE 115 may train multiple sets of neural network parameters for the second neural network model that may each correspond to one or more non-orthogonal cover codes. Accordingly, if the base station 105 transmits a CSI-RS associated with a particular non-orthogonal cover code (e.g., multiplexed using the non-orthogonal cover code, transmitted in accordance with a CSI-RS pattern generated based on the non-orthogonal cover code), the UE 115 may use (e.g., select and use) a set of neural network parameters of the second neural network model that corresponds to the non-orthogonal cover code to perform a channel estimation procedure of the CSI-RS. In some examples, the UE 115 may additionally use the set of neural network parameters of the second neural network model that corresponds to the non-orthogonal cover code to demultiplex the CSI-RS.

The UE 115 may use the second neural network model to generate (e.g., and compress) feedback information (e.g., bits) corresponding to the CSI-RS. For example, the UE 115 may input the CSI-RS into the second neural network model (e.g., before or after demultiplexing the CSI-RS) which may output feedback bits (e.g., encoded CSF bits) indicating a result of the channel estimation procedure (e.g., one or more channel quality parameters) using the second neural network model. The UE 115 may transmit a feedback message that includes the feedback bits to the base station 105.

At 315, the base station 105 may train a third neural network model for channel recovery. For example, the base station 105 may use the third neural network model to decode the feedback bits and determine the one or more channel quality parameters. For instance, the base station 105 may input the feedback bits into the third neural network model which may output the one or channel quality parameters. The base station 105 may train multiple sets of neural network parameters (e.g., weights of the neural network model) that may each correspond to one or more non-orthogonal cover codes. Accordingly, if the base station 105 transmits a CSI-RS associated with a particular non-orthogonal cover code, the base station 105 may use (e.g., select and use) a set of neural network parameters of the third neural network model that corresponds to the non-orthogonal cover code to perform channel recovery of the CSI-RS. In some cases, training the third neural network model at 315 may be an example of a channel recovery training procedure.

FIG. 3B illustrates an example of a neural network procedure 320 that supports neural network assisted communication techniques in accordance with one or more aspects of the present disclosure. The neural network procedure 320 may implement aspects of the wireless communications systems 100 and 200 or may be implemented by aspects of the wireless communications system 100 and 200 as described with reference to FIGS. 1 and 2, respectively. For example, the neural network procedure 320 may be implemented by a UE 115 and a base station 105 to support neural network model assisted parameter reporting.

In the following description of the neural network procedure 320, the operations performed by the base station 105 and the UE 115 may be performed in different orders or at different times. Some operations may also be omitted from the neural network procedure 320, and other operations may be added to the neural network procedure 320.

In some examples, the neural network procedure 320 may be an example of a training procedure during which one or more neural network models (e.g., or sets of neural network parameters for neural network models) at the base station 105 and the UE 115 are trained. Following the training procedure, the respective neural network models may be implemented at the base station 105 and the UE 115 to assist in performing various operations related to wireless communications, which in some examples, may be performed according to the neural network procedure 320.

For example, at 325, the base station 105 may train a first neural network model to generate CSI-RSs. In some examples, the base station 105 may use the first neural network model to generate CSI-RS patterns for CSI-RS transmissions. In some cases, training the first neural network model at 325 may be an example of a downlink pilot training procedure. The base station 105 may train multiple sets of neural network parameters (e.g., weights of the neural network model) that may each be used to generate CSI-RSs or CSI-RS patterns. In some examples, each set of neural network parameters may correspond to different potential channel conditions of a channel between the base station 105 and the UE 115, or to different parameters associated with a CSI-RS transmission, or both. For example, each set of neural network parameters may correspond to one or more channel conditions (e.g., a propagation environment, a channel quality, an SNR, an SINR, an RSRP, or some other channel condition) of the channel, a bandwidth associated with a CSI-RS, a location of one or more resources (e.g., resource elements) used to transmit the CSI-RS, a CDM type associated with the CSI-RS, or a combination thereof. Accordingly, the base station 105 may select which set of neural network parameters to use to generate the CSI-RS or the CSI-RS pattern based on a scenario (e.g., a set of channel conditions, a set of parameters) of the CSI-RS transmission. The base station 105 may transmit, to the UE 115 the generated CSI-RS or the CSI-RS in accordance with the generated CSI-RS pattern.

At 330, the UE 115 may train a second neural network model for parameter reporting. For example, the UE 115 may train the second neural network model to determine a precoding matrix, a CQI, an RI, or a combination thereof, based on a CSI-RS received from the base station 105. For instance, the UE 115 may use the second neural network model to perform a channel estimation procedure of the CSI-RS and to determine the precoding matrix, the CQI, the RI, or the combination thereof, based on the channel estimation.

The UE 115 may train multiple sets of neural network parameters for the second neural network model that may each correspond to one or more CSI-RSs, one or more CSI-RS patterns, a parameter to be determined by the second neural network (e.g., a PMI, a CQI, an RI), or a combination thereof. For example, one or more sets of neural network parameters of the second neural network model may be trained to determine PMIs, one or more sets of neural network parameters of the second neural network model may be trained to determine CQIs, one or more sets of neural network parameters of the second neural network model may be trained to determine RIs, or a combination thereof. Here, each set of neural network of the second neural network may correspond to one or more CSI-RSs or one or more CSI-RS patterns. Accordingly, based on the CSI-RS transmitted by the base station 105, the UE 115 may use (e.g., select and use) a set of neural network parameters of the second neural network model that corresponds to the CSI-RS to determine a PMI, a CQI, or an RI associated with the CSI-RS. In some examples, the UE 115 may additionally use the set of neural network parameters of the second neural network model that corresponds to the CSI-RS to demultiplex the CSI-RS. In some examples, each set of neural network parameters of the second neural network model may additionally, or alternatively, correspond to a non-orthogonal cover code associated with CSI-RS. In some cases, training the second neural network model at 330 may be an example of an uplink feedback training procedure.

The UE 115 may use the second neural network model to generate (e.g., and compress) feedback information (e.g., bits) corresponding to the CSI-RS. For example, the UE 115 may input the CSI-RS into the second neural network model (e.g., before or after demultiplexing the CSI-RS) which may output feedback bits (e.g., encoded CSF bits) that indicate a PMI, a CQI, an RI, or a combination thereof. The UE 115 may transmit a feedback message that includes the feedback bits to the base station 105.

At 335, the base station 105 may train a third neural network model for parameter recovery. For example, the base station 105 may use the third neural network model to decode the feedback bits and determine the PMI, the CQI, the RI, or the combination thereof. For instance, the base station 105 may input the feedback bits into the third neural network model which may output one or more of the precoding matrix, the channel quality, or the rank indicated by the PMI, the CQI, or the RI, respectively. The base station 105 may train multiple sets of neural network parameters (e.g., weights of the neural network model) that may each correspond to one or more CSI-RSs or CSI-RS patterns. Accordingly, based on the CSI-RS transmitted by the base station 105 (e.g., at 325), the base station 105 may use (e.g., select and use) a set of neural network parameters of the third neural network model that corresponds to the CSI-RS or the CSI-RS pattern to perform parameter recovery of the CSI-RS. In some cases, training the third neural network model at 315 may be an example of a channel recovery training procedure.

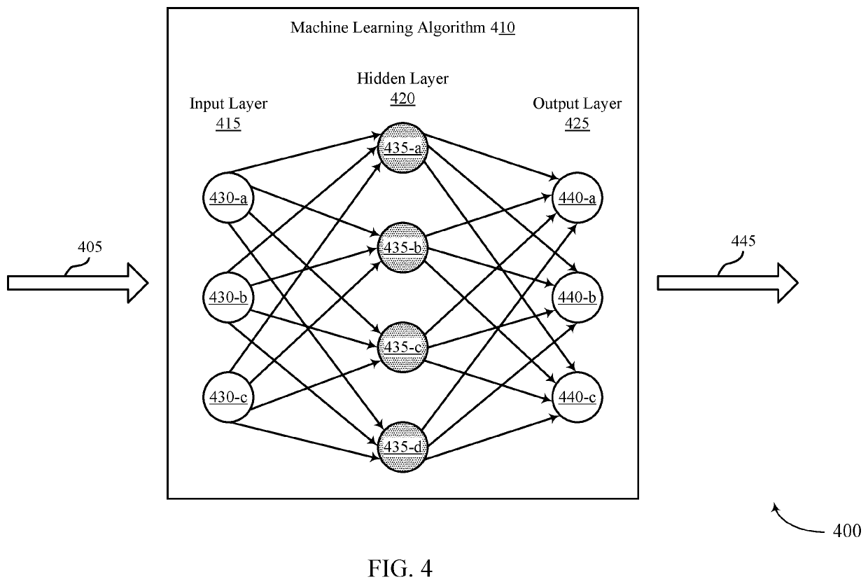

FIG. 4 illustrates an example of a machine learning process 400 that supports neural network assisted communication techniques in accordance with one or more aspects of the present disclosure. The machine learning process 400 may be implemented at a wireless device, such as a UE or a base station as described with reference to FIGS. 1-3. The machine learning process 400 may include a machine learning algorithm 410. In some examples, the wireless device may receive a neural network model from a base station and implement one or more machine learning algorithms 410 as part of the neural network model to optimize communication processes.

As illustrated, the machine learning algorithm 410 may be an example of a neural net, such as a feed forward (FF) or deep feed forward (DFF) neural network, a recurrent neural network (RNN), a long/short term memory (LSTM) neural network, or any other type of neural network. However, any other machine learning algorithms may be supported by the UE. For example, the machine learning algorithm 410 may implement a nearest neighbor algorithm, a linear regression algorithm, a Naïve Bayes algorithm, a random forest algorithm, or any other machine learning algorithm. Further, the machine learning process 400 may involve supervised learning, unsupervised learning, semi-supervised learning, reinforcement learning, or any combination thereof. The machine learning may be performed prior to deployment of a UE, while the UE is deployed, during low usage periods of the UE while the UE is deployed, or any combination thereof.

The machine learning algorithm 410 may include an input layer 415, one or more hidden layers 420, and an output layer 425. In a fully connected neural network with one hidden layer 420, each hidden layer node 435 may receive a value from each input layer node 430 as input, where each input is weighted. These neural network weights may be based on a cost function that is revised during training of the machine learning algorithm 410. Similarly, each output layer node 440 may receive a value from each hidden layer node 435 as input, where the inputs are weighted. If post-deployment training (e.g., online training) is supported at a UE, the UE may allocate memory to store errors and/or gradients for reverse matrix multiplication. These errors and/or gradients may support updating the machine learning algorithm 410 based on output feedback. Training the machine learning algorithm 410 may support computation of the weights (e.g., connecting the input layer nodes 430 to the hidden layer nodes 435 and the hidden layer nodes 435 to the output layer nodes 440) to map an input pattern to a desired output outcome. This training may result in a UE-specific machine learning algorithm 410 based on the historic application data and data transfer for a specific UE.

The UE may send input values 405 to the machine learning algorithm 410 for processing. In some example, the UE may perform preprocessing according to a sequence of operations received from the base station on the input values 405 such that the input values 405 may be in a format that is compatible with the machine learning algorithm 410. The input values 405 may be converted into a set of k input layer nodes 430 at the input layer 415. In some cases, different measurements may be input at different input layer nodes 430 of the input layer 415. Some input layer nodes 430 may be assigned default values (e.g., values of 0) if the number of input layer nodes 430 exceeds the number of inputs corresponding to the input values 405. As illustrated, the input layer 415 may include three input layer nodes 430-a, 430-b, and 430-c. However, it is to be understood that the input layer 415 may include any number of input layer nodes 430 (e.g., 20 input nodes).

The machine learning algorithm 410 may convert the input layer 415 to a hidden layer 420 based on a number of input-to-hidden weights between the k input layer nodes 430 and the n hidden layer nodes 435. The machine learning algorithm 410 may include any number of hidden layers 420 as intermediate steps between the input layer 415 and the output layer 425. Additionally, each hidden layer 420 may include any number of nodes. For example, as illustrated, the hidden layer 420 may include four hidden layer nodes 435-a, 435-b, 435-c, and 435-d. However, it is to be understood that the hidden layer 420 may include any number of hidden layer nodes 435 (e.g., 10 input nodes). In a fully connected neural network, each node in a layer may be based on each node in the previous layer. For example, the value of hidden layer node 435-a may be based on the values of input layer nodes 430-a, 430-b, and 430-c (e.g., with different weights applied to each node value).

The machine learning algorithm 410 may determine values for the output layer nodes 440 of the output layer 425 following one or more hidden layers 420. For example, the machine learning algorithm 410 may convert the hidden layer 420 to the output layer 425 based on a number of hidden-to-output weights between the n hidden layer nodes 435 and the m output layer nodes 440. In some cases, n=m. Each output layer node 440 may correspond to a different output value 445 of the machine learning algorithm 410. As illustrated, the machine learning algorithm 410 may include three output layer nodes 440-a, 440-b, and 440-c, supporting three different threshold values. However, it is to be understood that the output layer 425 may include any number of output layer nodes 440.

In some examples, a base station may utilize a neural network model based on the machine learning algorithm 410, which may be used for generating non-orthogonal cover codes for CSI-RS transmission to a UE. For example, a CU or a DU of a base station may implement a neural network model based on the machine learning algorithm 410 to generate non-orthogonal cover codes for CSI-RS transmission. An RU of a base station may transmit CSI-RSs to a UE using non-orthogonal cover codes generated using the neural network model that is based on the machine learning algorithm 410. The UE may perform channel estimation on a CSI-RS using the non-orthogonal cover codes and the neural network model that is based on the machine learning algorithm 410.

FIG. 5 illustrates an example of a cover code diagram 500 that supports neural network assisted communication techniques in accordance with one or more aspects of the present disclosure. The cover code diagram 500 may implement aspects of the wireless communications systems 100 and 200 or may be implemented by aspects of the wireless communications system 100 and 200 as described with reference to FIGS. 1 and 2, respectively. For example, the cover code diagram 500 may be implemented by a UE 115 and a base station 105 (e.g., network device 140, components of a network device 140, or the like) to support utilizing neural network models and non-orthogonal cover codes in CSI-RS transmissions from the base station 105 to the UE 115.

The cover code diagram 500 illustrates a set of resource blocks 505. The set of resource blocks 505 may include resource blocks 510 corresponding to resource blocks via which the base station 105 may transmit a CSI-RS and include resource blocks 515 corresponding to resource blocks associated with the CSI-RS but via which the CSI-RS is not transmitted. For example, by using non-orthogonal cover codes and neural network models to communicate CSI-RSs, the base station 105 may transmit the CSI-RS via a subset of set of resource blocks 505 (e.g., rather than each of the resource blocks of the set of resource blocks 505 if the base station 105 were to use an orthogonal cover code to transmit the CSI-RS). For instance, based on using a non-orthogonal cover code and neural network model to communicate the CSI-RS, the UE 115 may estimate a channel associated with the set of resource blocks 505 based on measurements of the CSI-RS transmitted via the resource blocks 510. Accordingly, the base station 105 may transmit the CSI-RS via a quantity of resource blocks 510 (e.g., K resource blocks 510, where K is some positive integer) that is less than a quantity of resource blocks 505 associated with the channel, while still supporting estimation of the channel, thereby reducing resource overhead of the CSI-RS (e.g., in the frequency domain).

The base station 105 may transmit the CSI-RS via a respective set of resource elements in each resource block 510. For example, the base station 105 may transmit the CSI-RS via a set of resource elements 520 of a resource block 510-a and so on up through a set of resource elements 525 of a resource block 510-b. A quantity of resource elements of each set of resource elements via which the CSI-RS is transmitted may be based on a quantity of transmission ports associated with transmission of the CSI-RS. For example, the base station 105 may transmit the CSI-RS using Nt of transmission ports, where Nt is some positive integer (e.g., 2, 4, 8, 16, 32, among other quantities). In some cases, if the base station 105 were to use an orthogonal cover code to transmit the CSI-RS, a length of the orthogonal cover mode may equal the quantity of transmission ports used to transmit the CSI-RS (e.g., equal Nt). That is, the matrix of values corresponding to the orthogonal cover code may be an Nt×Nt matrix. This may enable the UE 115 to estimate the channel for each of the Nt transmission ports.

When using a non-orthogonal cover code, however, the length of the non-orthogonal cover code may be less than the quantity of transmission ports. For example, in one resource block 510, the non-orthogonal cover code may have a length L, where L is some positive integer having a value less than Nt. Accordingly, the matrix of values corresponding to the non-orthogonal cover code may be an Nt×L matrix. In some examples, the quantity of resource elements via which the CSI-RS is transmitted in each resource block 510 may be equal to the length L of the non-orthogonal cover code. For example, in the example of FIG. 5, Nt may equal 32 transmission ports and L may equal a non-orthogonal cover code length of 16. Accordingly, the set of resource elements 520 and the set of resource elements 525 may each include 16 resource elements via which the CSI-RS is transmitted. It is noted that the resource element pattern of the respective sets of resource elements is an example pattern and that other resource element patterns may be supported.

There may be an association between the quantity Nt of transmission ports and the length L of the non-orthogonal cover code per resource block 510. For instance, if the Nt transmission ports are used, the length of the non-orthogonal cover code may be L. Accordingly, the base station 105 may transmit a port indication (e.g., port indication 245) to the UE 115 to indicate the quantity Nt of transmission ports, which may implicitly indicate the length of the non-orthogonal cover code to be L and explicitly indicate the quantity of ports to be recovered by the UE 115 (e.g., Nt ports). In some examples, the port indication may additionally (e.g., explicitly) indicate the length L. In some examples, the UE 115 may determine a neural network model to use to perform channel estimation based the length L of the non-orthogonal cover code and the quantity Nt of transmission ports. For example, a neural network model used by the UE 115 may support channel estimation for various combinations of non-orthogonal cover code lengths and transmission port quantities, such as the following set of combinations: {Nt1, L}, {Nt2, L} or {Nt, L1}, {Nt, L2} or {Nt1, L1}, {Nt2, L2}. The UE 115 may determine the length L, for example, by observing (e.g., receiving, measuring) L CSI-RS signals per resource block 510. Accordingly, based on the determined length L and the indicated value Nt, the UE 115 may select a neural network model that supports channel estimation for the determined length L and indicated value Nt combination and perform channel estimation using the selected neural network model.

In some examples, there may be an association between the quantity resource blocks 505 (e.g., a quantity of N_RB resource blocks 505, where N_RB is some positive integer) and the quantity K of resource blocks 510. For example, the UE 115 may be configured with the value of K resource blocks 510 via which the base station 105 is to transmit the CSI-RS (e.g., the CSI-RS bandwidth). The set of resource blocks 505 may correspond to a reporting channel bandwidth of a feedback message (e.g., a feedback message 230) associated with the CSI-RS (e.g., a bandwidth of a channel recovered by the UE 115). That is, the feedback message may include CSF associated with the set of resource blocks 505 despite receiving the CSI-RS via the subset of resource blocks 510, for example, based on communicating the CSI-RS using a non-orthogonal cover code. The UE 115 may determine the reporting channel bandwidth of the feedback message (e.g., the quantity N_RB of resource blocks 505 for which the UE 115 is to perform channel estimation) based on the association between the quantity of K resource blocks 510 and the quantity of N_RB resource blocks 505. For example, the association may be that K=αN_RB, where a is a value between 0 and 1. Accordingly, the UE 115 may calculate the value of N_RB based on the values of K and α. In the example of FIG. 5, the UE 115 may be configured with K=6 and α=0.5, such that N_RB=12. Accordingly, the UE 115 may receive the CSI-RS over six resource blocks 510, and the reporting channel bandwidth may be twelve resource blocks 505 (e.g., the channel recovered by the UE 115 may have a bandwidth of 12 resource blocks).

In some examples, the base station 105 may transmit and the UE 115 may receive the CSI-RS using a set of non-orthogonal cover codes. For example, the non-orthogonal cover codes used to communicate the CSI-RS may be resource block specific. For instance, the base station 105 may apply a respective non-orthogonal cover code X to each set of resource elements used to transmit the CSI-RS via the K resource blocks 510. In the example of FIG. 5, the cover code diagram 500 illustrates an application 530-a of a non-orthogonal cover code X₁ to the set of resource elements 520 and an application 530-b of a non-orthogonal cover code X_{K-1} to the set of resource elements 525, where X₁ and X_{K-1} may be specific to the resource block 510-a and the resource block 510-b, respectively.

The base station 105 may apply the set of non-orthogonal cover codes X to the CSI-RS by multiplying the non-orthogonal cover codes X with pilot symbol values S of the CSI-RS. For example, in the application 530-a, the non-orthogonal cover X₁ may be applied to the set of resource elements 520 that includes resource elements RE0 to RE(L−1), each of which may be associated with a pilot symbol values S(0) through S(L−1), respectively. To apply the non-orthogonal cover code X₁ to RE0, the base station 105 may respectively multiply the matrix value of X₁(0,0) up through X₁(Nt, 0) by S(0). The base station 105 may similarly apply the non-orthogonal cover code X₁ to the remaining resource elements up through RE(L−1) (e.g., respectively multiply the matrix value of X₁(0,L−1) up through X₁(Nt, L−1) by S(L−1) for RE(L−1)). To transmit the CSI-RS via the set of resource elements 520 using the quantity Nt of transmission ports, the values of X₁(0,0)S(0) through X₁(0, L−1)S(L−1) may be transmitted via RE0 through RE(L−1), respectively, using a first of the Nt transmission ports, and so on up through the values of X₁(Nt,0)S(0) through X₁(Nt, L−1)S(L−1) being transmitted via RE0 through RE(L−1), respectively, using a last of the Nt transmission ports. The base station 105 may similarly apply the non-orthogonal cover code X_{K-1} to the set of resource elements 525 and transmit the set of resource elements using the Nt transmission ports.

By using non-orthogonal cover codes to communicate CSI-RSs, resource overhead associated with communicating CSI-RSs may be reduced. For example, if using an orthogonal cover code to communicate a CSI-RS, a total quantity of resource elements used to transmit the CSI-RS via a set of resource blocks may equal the quantity Nt of transmission ports times the quantity N_RB of resource blocks of the set. If using one or more non-orthogonal cover codes, the total quantity of resource elements may be the length L of the non-orthogonal cover code times the quantity K of resource blocks 510. Because L<Nt and K<N_RB, the total quantity of resource elements may be reduced, thereby reducing resource overhead of communicating the CSI-RS.

FIG. 6 illustrates an example of a process flow 600 that supports neural network assisted communication techniques in accordance with one or more aspects of the present disclosure. In some examples, the process flow 600 may implement aspects of a wireless communications system 100 and 200 as described with reference to FIGS. 1 and 2. For example, the process flow 600 may be implemented by a base station 105-b and a UE 115-b to support utilizing neural network models and non-orthogonal cover codes in wireless communications between the UE 115-b and the base station 105-b. The process flow 600 may further be implemented by the base station 105-b and the UE 115-b to support techniques for increased data rates, spectral efficiency, reliability, resource usage, battery life, processing capability, and coordination between devices and reduced latency and power consumption, among other benefits.

The base station 105-b and the UE 115-b may be examples of a base station 105 or a UE 115, as described with reference to FIGS. 1 and 2. In the following description of the process flow 600, the operations between the base station 105-b and the UE 115-b may be communicated in a different order than the example order shown, or the operations performed by the base station 105-b and the UE 115-b may be performed in different orders or at different times. Some operations may also be omitted from the process flow 600, and other operations may be added to the process flow 600.

At 605, the base station 105-b may optionally transmit a configuration message to the UE 115-b. In some examples, the configuration message may indicate one or more sets of communication parameters that are each associated with a non-orthogonal cover code. In some other examples, the configuration message may indicate a first set of non-orthogonal cover codes of which the UE 115-b may indicate one or more preferred non-orthogonal cover codes. In still some other examples, the configuration message may configure the UE 115-b with a set of neural network parameters of a neural network model to use to perform channel estimation procedures.

At 610, the UE 115-b may optionally transmit a cover code message to the base station 105-b. In some examples, the cover code message may indicate one or more preferred non-orthogonal cover codes of the UE 115-b to the base station 105-b. In some other examples, the cover code message may indicate one or more non-orthogonal cover codes of the first set of non-orthogonal cover codes by including one or more indexes corresponding to the one or more non-orthogonal cover codes.

At 615, the base station 105-b may transmit a CSI-RS to the UE 115-b. The CSI-RS may be associated with a non-orthogonal cover code. For example, the base station 105-b may use the associated non-orthogonal cover code to multiplex the CSI-RS. In some examples, the base station 105-b may select the associated non-orthogonal cover code from the one or more non-orthogonal cover codes indicated by the cover code message. In some other examples, the base station 105-b may select a non-orthogonal cover code that corresponds to the indicated set of neural network parameters for the associated non-orthogonal cover code. In some cases, the base station 105-b may indicate the associated non-orthogonal cover code to the UE 115-b by transmitting the CSI-RS using one or more resources that correspond to the non-orthogonal cover code. In some examples, the base station 105-b may indicate the associated non-orthogonal cover to the UE 115-b by transmitting the CSI-RS in accordance with the indicated set of communication parameters.

At 620, the UE 115-b may optionally demultiplex the CSI-RS. For example, the UE 115-b may determine the associated non-orthogonal cover code and may demultiplex the CSI-RS using the associated non-orthogonal cover code.

At 625, the UE 115-b may perform a channel estimation procedure that corresponds to the non-orthogonal cover code. In some examples, the UE 115-b may perform the channel estimation procedure by inputting the CSI-RS (e.g., demultiplexed CSI-RS) into the neural network model. The neural network model may output one or more feedback bits that indicate one or more channel quality parameters that are associated with the CSI-RS.

At 630, the UE 115-b may transmit a feedback message to the base station 105-b that indicates the one or more channel quality parameters.

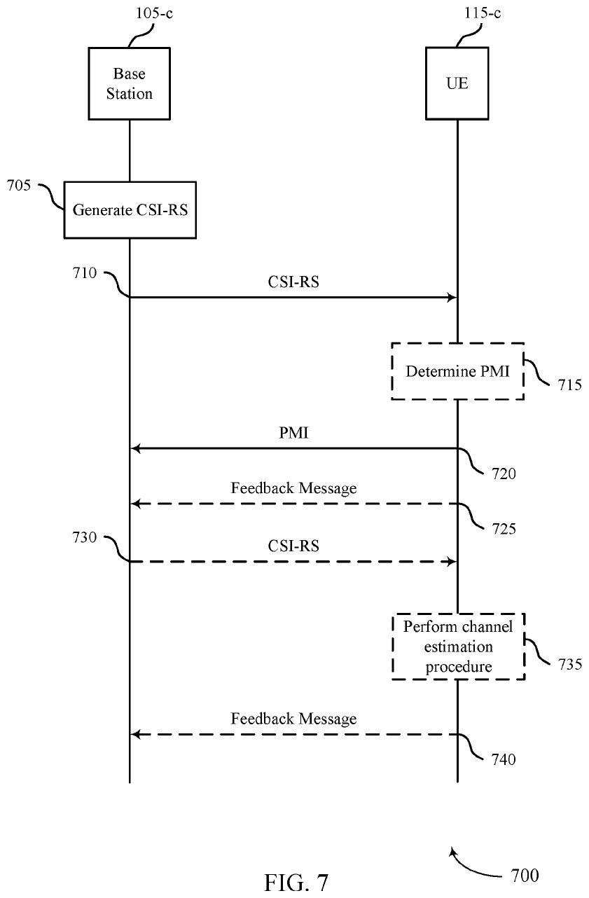

FIG. 7 illustrates an example of a process flow 700 that supports neural network assisted communication techniques in accordance with one or more aspects of the present disclosure. In some examples, the process flow 700 may implement aspects of a wireless communications system 100 and 200 as described with reference to FIGS. 1 and 2. For example, the process flow 700 may be implemented by a base station 105-c and a UE 115-c to support neural network model assisted parameter reporting. The process flow 700 may further be implemented by the base station 105-c and the UE 115-c to support techniques for increased data rates, spectral efficiency, reliability, resource usage, battery life, processing capability, and coordination between devices and reduced latency and power consumption, among other benefits.

The base station 105-c and the UE 115-c may be examples of a base station 105 or a UE 115, as described with reference to FIGS. 1 and 2. In the following description of the process flow 700, the operations between the base station 105-c and the UE 115-c may be communicated in a different order than the example order shown, or the operations performed by the base station 105-c and the UE 115-c may be performed in different orders or at different times. Some operations may also be omitted from the process flow 700, and other operations may be added to the process flow 700.

At 705, the base station 105-c may generate a first CSI-RS using a first set of neural network parameters of a first neural network model for reference signals.

At 710, the base station 105-c may transmit the first CSI-RS to the UE 115-c. In some examples, the first CSI-RS may be associated with a non-orthogonal cover code.

At 715, the UE 115-c may optionally determine a precoding matrix for communications between the UE 115-c and the base station 105-c. For example, the UE 115-c may use a second neural network model for channel estimation to determine the precoding matrix based on the first CSI-RS. For instance, the UE 115-c may select a first set of neural network parameters of the second neural network model (e.g., corresponding to the first CSI-RS, corresponding to the associated non-orthogonal cover code) and may input the first CSI-RS into the second neural network model configured with the first set of neural network parameters which may output the precoding matrix.

At 720, the UE 115-c may transmit a PMI to the base station 105-c that indicates the determined precoding matrix.

At 725, the UE 115-c may optionally transmit a feedback message to the base station 105-c that includes a CQI. For example, the UE 115-c may use the second neural model to determine a CQI based on the first CSI-RS. For instance, the UE 115-c may select a second set of neural network parameters of the second neural network model (e.g., corresponding to the first CSI-RS, corresponding to the associated non-orthogonal cover code) and may input the first CSI-RS into the second neural network model configured with the second set of neural network parameters which may output the CQI. The UE 115-c may transmit the feedback message to the base station 105-c to indicate the CQI.

At 730, the base station 105-c may optionally transmit a second CSI-RS to the base station 105-c. For example, in response to receiving the PMI, the base station 105-c may generate the second CSI-RS using a second set of neural network parameters of the first neural network model that corresponds to the PMI. The second CSI-RS may be a precoded CSI-RS that is precoded according to the precoding matrix indicated by the PMI. In some examples, the second CSI-RS may be associated with a second non-orthogonal cover code.

At 735, the UE 115-c may optionally perform a channel estimation procedure of the second CSI-RS. In some examples, the UE 115-c may perform the channel estimation procedure using a third set of neural network parameters of the second neural network model and may derive a CQI, an RI, or both from the channel estimation procedure. For example, the UE 115-c may input the second CSI-RS into the second neural network model configured with the third set of neural network parameters, and the second neural network model may output the CQI, the RI, or both. In a second example, the UE 115-c may input the second CSI-RS into the second neural network model configured with the third set of neural network parameters, and the second neural network model may output one or more channel quality parameters which the UE 115-c may use to derive the CQI, the RI, or both.

At 740, the UE 115-c may optionally transmit a second feedback message to the base station 105-b based on performing the channel estimation procedure. The second feedback message may include the CQI, RI, or both.

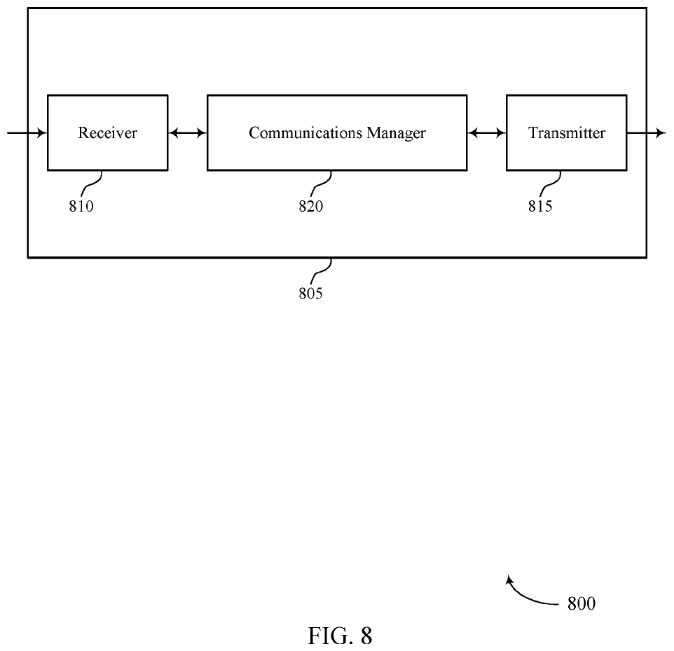

FIG. 8 shows a block diagram 800 of a device 805 that supports neural network assisted communication techniques in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to neural network assisted communication techniques). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to neural network assisted communication techniques). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of neural network assisted communication techniques as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a UE in accordance with examples as disclosed herein. For example, the communications manager 820 may be configured as or otherwise support a means for receiving, from a base station, a CSI-RS associated with a non-orthogonal cover code of a set of non-orthogonal cover codes for reference signals. The communications manager 820 may be configured as or otherwise support a means for performing a channel estimation procedure of the CSI-RS, the channel estimation procedure corresponding to the non-orthogonal cover code. The communications manager 820 may be configured as or otherwise support a means for transmitting, to the base station, a feedback message that indicates a channel quality parameter based on the channel estimation procedure of the CSI-RS associated with the non-orthogonal cover code.

Additionally or alternatively, the communications manager 820 may support wireless communication at a UE in accordance with examples as disclosed herein. For example, the communications manager 820 may be configured as or otherwise support a means for receiving, from a base station, a CSI-RS generated using a first set of neural network parameters of a first neural network model for reference signals. The communications manager 820 may be configured as or otherwise support a means for transmitting, to the base station, an indication of a precoding matrix for communicating with the base station, the precoding matrix determined using the CSI-RS and a second set of neural network parameters of a second neural network model for channel estimation.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for reduced processing, reduced power consumption, more efficient utilization of communication resources by supporting non-orthogonal cover code and neural network implementations for wireless communications.

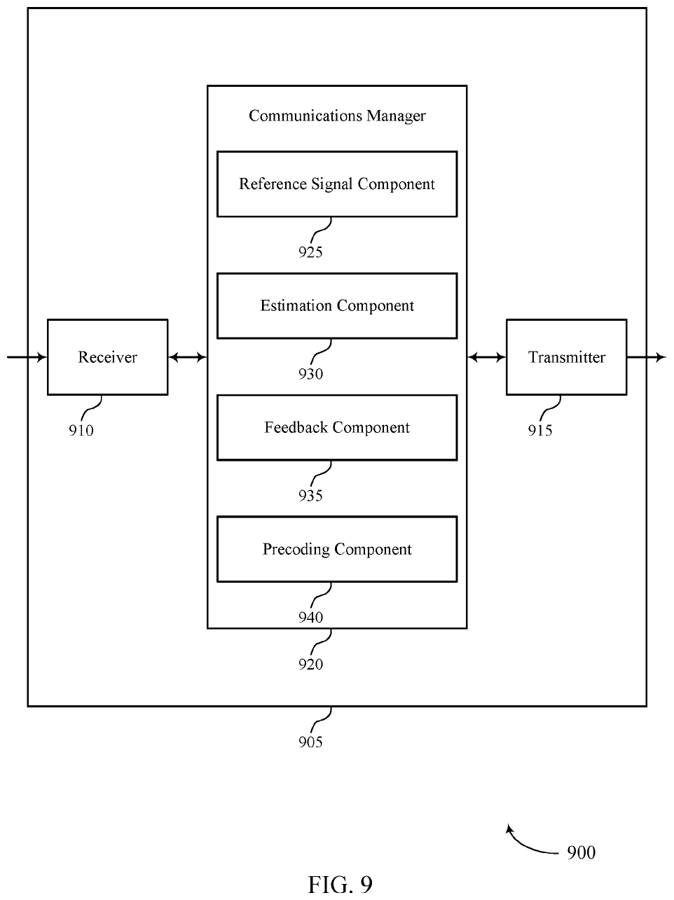

FIG. 9 shows a block diagram 900 of a device 905 that supports neural network assisted communication techniques in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to neural network assisted communication techniques). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to neural network assisted communication techniques). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of neural network assisted communication techniques as described herein. For example, the communications manager 920 may include a reference signal component 925, an estimation component 930, a feedback component 935, a precoding component 940, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a UE in accordance with examples as disclosed herein. The reference signal component 925 may be configured as or otherwise support a means for receiving, from a base station, a CSI-RS associated with a non-orthogonal cover code of a set of non-orthogonal cover codes for reference signals. The estimation component 930 may be configured as or otherwise support a means for performing a channel estimation procedure of the CSI-RS, the channel estimation procedure corresponding to the non-orthogonal cover code. The feedback component 935 may be configured as or otherwise support a means for transmitting, to the base station, a feedback message that indicates a channel quality parameter based on the channel estimation procedure of the CSI-RS associated with the non-orthogonal cover code.

Additionally or alternatively, the communications manager 920 may support wireless communication at a UE in accordance with examples as disclosed herein. The reference signal component 925 may be configured as or otherwise support a means for receiving, from a base station, a CSI-RS generated using a first set of neural network parameters of a first neural network model for reference signals. The precoding component 940 may be configured as or otherwise support a means for transmitting, to the base station, an indication of a precoding matrix for communicating with the base station, the precoding matrix determined using the CSI-RS and a second set of neural network parameters of a second neural network model for channel estimation.

FIG. 10 shows a block diagram 1000 of a communications manager 1020 that supports neural network assisted communication techniques in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of neural network assisted communication techniques as described herein. For example, the communications manager 1020 may include a reference signal component 1025, an estimation component 1030, a feedback component 1035, a precoding component 1040, a demultiplexing component 1045, a configuration component 1050, a cover code component 1055, or any combination thereof. Each of these components may communicate, directly or indirectly, with one another (e.g., via one or more buses).

The communications manager 1020 may support wireless communication at a UE in accordance with examples as disclosed herein. The reference signal component 1025 may be configured as or otherwise support a means for receiving, from a base station, a CSI-RS associated with a non-orthogonal cover code of a set of non-orthogonal cover codes for reference signals. The estimation component 1030 may be configured as or otherwise support a means for performing a channel estimation procedure of the CSI-RS, the channel estimation procedure corresponding to the non-orthogonal cover code. The feedback component 1035 may be configured as or otherwise support a means for transmitting, to the base station, a feedback message that indicates a channel quality parameter based on the channel estimation procedure of the CSI-RS associated with the non-orthogonal cover code.

In some examples, the demultiplexing component 1045 may be configured as or otherwise support a means for demultiplexing the CSI-RS based on the non-orthogonal cover code, where performing the channel estimation procedure is based on inputting the demultiplexed CSI-RS into a neural network model for channel estimation, the neural network model using a set of neural network parameters corresponding to the non-orthogonal cover code.

In some examples, to support performing the channel estimation procedure, the estimation component 1030 may be configured as or otherwise support a means for inputting the CSI-RS into a neural network model for channel estimation, the neural network model using a set of neural network parameters corresponding to the non-orthogonal cover code.

In some examples, the non-orthogonal cover code is based on a location of one or more resources used to communicate the CSI-RS.

In some examples, the configuration component 1050 may be configured as or otherwise support a means for receiving a configuration message that indicates a set of communication parameters associated with the non-orthogonal cover code, where the CSI-RS is received in accordance with the set of communication parameters. In some examples, the cover code component 1055 may be configured as or otherwise support a means for selecting the non-orthogonal cover code from the set of non-orthogonal cover codes based on receiving the CSI-RS in accordance with the set of communication parameters.

In some examples, the set of communication parameters includes a channel condition associated with the CSI-RS, a bandwidth associated with the CSI-RS, a location of one or more resources used to communicate the CSI-RS, a CDM type associated with the CSI-RS, or a combination thereof.

In some examples, the cover code component 1055 may be configured as or otherwise support a means for transmitting, to the base station, a message indicating the set of non-orthogonal cover codes, where receiving the CSI-RS associated with the non-orthogonal cover code is based on transmitting the message.

In some examples, the configuration component 1050 may be configured as or otherwise support a means for receiving, from the base station, a configuration message indicating a second set of non-orthogonal cover codes including the set of non-orthogonal cover codes, where the message indicating the set of non-orthogonal cover codes includes a set of indexes, each index corresponding to a non-orthogonal code of the set of non-orthogonal cover codes.

In some examples, the estimation component 1030 may be configured as or otherwise support a means for selecting, based on transmitting the message indicating the set of non-orthogonal cover codes, a set of neural network parameters of a neural network model for channel estimation corresponding to the non-orthogonal cover code, where the channel estimation procedure is performed using the set of neural network parameters.

In some examples, the configuration component 1050 may be configured as or otherwise support a means for receiving, based on transmitting the message indicating the set of non-orthogonal cover codes, a configuration message indicating a set of neural network parameters of a neural network model for channel estimation corresponding to the non-orthogonal cover code, where the channel estimation procedure is performed using the set of neural network parameters.

In some examples, the configuration component 1050 may be configured as or otherwise support a means for receiving a configuration message indicating a set of neural network parameters of a neural network model for channel estimation corresponding to the non-orthogonal cover code, where the channel estimation procedure is performed using the set of neural network parameters based on receiving the configuration message.

In some examples, the precoding component 1040 may be configured as or otherwise support a means for transmitting, to the base station, an indication of a precoding matrix for communicating with the base station, the precoding matrix determined using the CSI-RS and a set of neural network parameters of a neural network model for channel estimation corresponding to the non-orthogonal cover code.

In some examples, the reference signal component 1025 may be configured as or otherwise support a means for receiving, in response to transmitting the indication of the precoding matrix, a second CSI-RS associated with the non-orthogonal cover code. In some examples, the estimation component 1030 may be configured as or otherwise support a means for performing a second channel estimation procedure of the second CSI-RS using a second set of neural network parameters of the neural network model corresponding to the non-orthogonal cover code. In some examples, the feedback component 1035 may be configured as or otherwise support a means for transmitting, to the base station, a second feedback message including a CQI, an RI, or a combination thereof, based on the second channel estimation procedure.

In some examples, the feedback component 1035 may be configured as or otherwise support a means for transmitting, to the base station, a second feedback message including a CQI, the CQI determined using the CSI-RS and a set of neural network parameters of a neural network model for channel estimation corresponding to the non-orthogonal cover code.

Additionally or alternatively, the communications manager 1020 may support wireless communication at a UE in accordance with examples as disclosed herein. In some examples, the reference signal component 1025 may be configured as or otherwise support a means for receiving, from a base station, a CSI-RS generated using a first set of neural network parameters of a first neural network model for reference signals. The precoding component 1040 may be configured as or otherwise support a means for transmitting, to the base station, an indication of a precoding matrix for communicating with the base station, the precoding matrix determined using the CSI-RS and a second set of neural network parameters of a second neural network model for channel estimation.

In some examples, the reference signal component 1025 may be configured as or otherwise support a means for receiving, in response to transmitting the indication of the precoding matrix, a second CSI-RS generated using a third set of neural network parameters of the first neural network model corresponding to the indicated precoding matrix. In some examples, the estimation component 1030 may be configured as or otherwise support a means for performing a channel estimation procedure of the second CSI-RS using a fourth set of neural network parameters of the second neural network model. In some examples, the feedback component 1035 may be configured as or otherwise support a means for transmitting a feedback message including a CQI, an RI, or a combination thereof, based on the channel estimation procedure.

In some examples, the feedback component 1035 may be configured as or otherwise support a means for transmitting, to the base station, a feedback message including a CQI, the CQI determined using the CSI-RS and a third set of neural network parameters of the second neural network model.

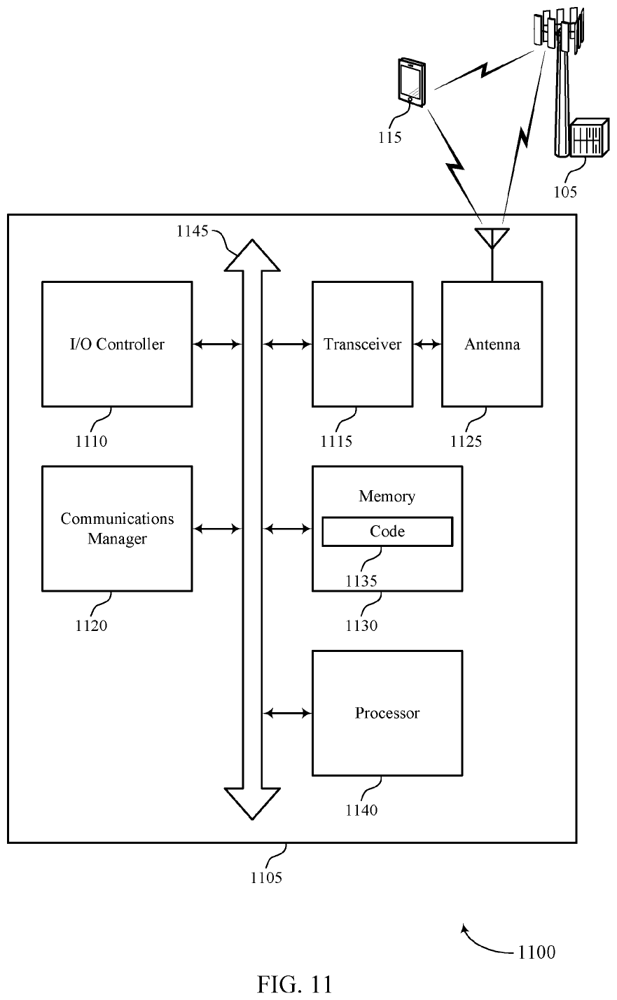

FIG. 11 shows a diagram of a system 1100 including a device 1105 that supports neural network assisted communication techniques in accordance with one or more aspects of the present disclosure. The device 1105 may be an example of or include the components of a device 805, a device 905, or a UE 115 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting neural network assisted communication techniques). For example, the device 1105 or a component of the device 1105 may include a processor 1140 and memory 1130 coupled to the processor 1140, the processor 1140 and memory 1130 configured to perform various functions described herein.

The communications manager 1120 may support wireless communication at a UE in accordance with examples as disclosed herein. For example, the communications manager 1120 may be configured as or otherwise support a means for receiving, from a base station, a CSI-RS associated with a non-orthogonal cover code of a set of non-orthogonal cover codes for reference signals. The communications manager 1120 may be configured as or otherwise support a means for performing a channel estimation procedure of the CSI-RS, the channel estimation procedure corresponding to the non-orthogonal cover code. The communications manager 1120 may be configured as or otherwise support a means for transmitting, to the base station, a feedback message that indicates a channel quality parameter based on the channel estimation procedure of the CSI-RS associated with the non-orthogonal cover code.

Additionally or alternatively, the communications manager 1120 may support wireless communication at a UE in accordance with examples as disclosed herein. For example, the communications manager 1120 may be configured as or otherwise support a means for receiving, from a base station, a CSI-RS generated using a first set of neural network parameters of a first neural network model for reference signals. The communications manager 1120 may be configured as or otherwise support a means for transmitting, to the base station, an indication of a precoding matrix for communicating with the base station, the precoding matrix determined using the CSI-RS and a second set of neural network parameters of a second neural network model for channel estimation.

By including or configuring the communications manager 1120 in accordance with examples as described herein, the device 1105 may support techniques for increased data rates, spectral efficiency, reliability, resource usage, battery life, processing capability, and coordination between devices and reduced latency and power consumption, among other benefits.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of neural network assisted communication techniques as described herein, or the processor 1140 and the memory 1130 may be otherwise configured to perform or support such operations.

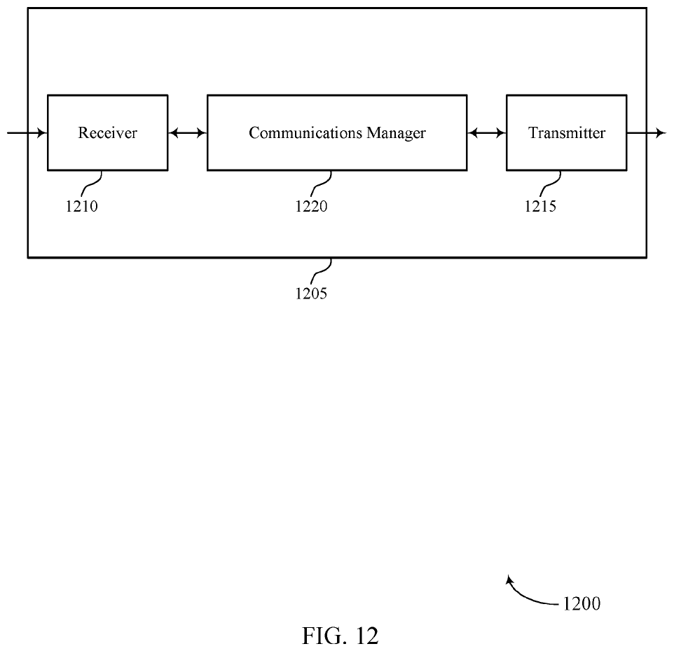

FIG. 12 shows a block diagram 1200 of a device 1205 that supports neural network assisted communication techniques in accordance with one or more aspects of the present disclosure. The device 1205 may be an example of aspects of a base station 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to neural network assisted communication techniques). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to neural network assisted communication techniques). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations thereof or various components thereof may be examples of means for performing various aspects of neural network assisted communication techniques as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1220 may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communication at a base station in accordance with examples as disclosed herein. For example, the communications manager 1220 may be configured as or otherwise support a means for transmitting, to a UE, a CSI-RS associated with a non-orthogonal cover code of a set of non-orthogonal cover codes for reference signals. The communications manager 1220 may be configured as or otherwise support a means for receiving, from the UE, a feedback message indicating a channel quality parameter that is determined based on a channel estimation procedure of the CSI-RS, the channel estimation procedure corresponding to the non-orthogonal cover code.

Additionally or alternatively, the communications manager 1220 may support wireless communication at a base station in accordance with examples as disclosed herein. For example, the communications manager 1220 may be configured as or otherwise support a means for generating a CSI-RS using a first set of neural network parameters of a first neural network model for reference signals. The communications manager 1220 may be configured as or otherwise support a means for transmitting the CSI-RS to a UE. The communications manager 1220 may be configured as or otherwise support a means for receiving, from the UE, an indication of a precoding matrix for communicating with the base station, the precoding matrix determined using the CSI-RS and a second set of neural network parameters of a second neural network model for channel estimation.

By including or configuring the communications manager 1220 in accordance with examples as described herein, the device 1205 (e.g., a processor controlling or otherwise coupled to the receiver 1210, the transmitter 1215, the communications manager 1220, or a combination thereof) may support techniques for reduced processing, reduced power consumption, more efficient utilization of communication resources by supporting non-orthogonal cover code and neural network implementations for wireless communications.

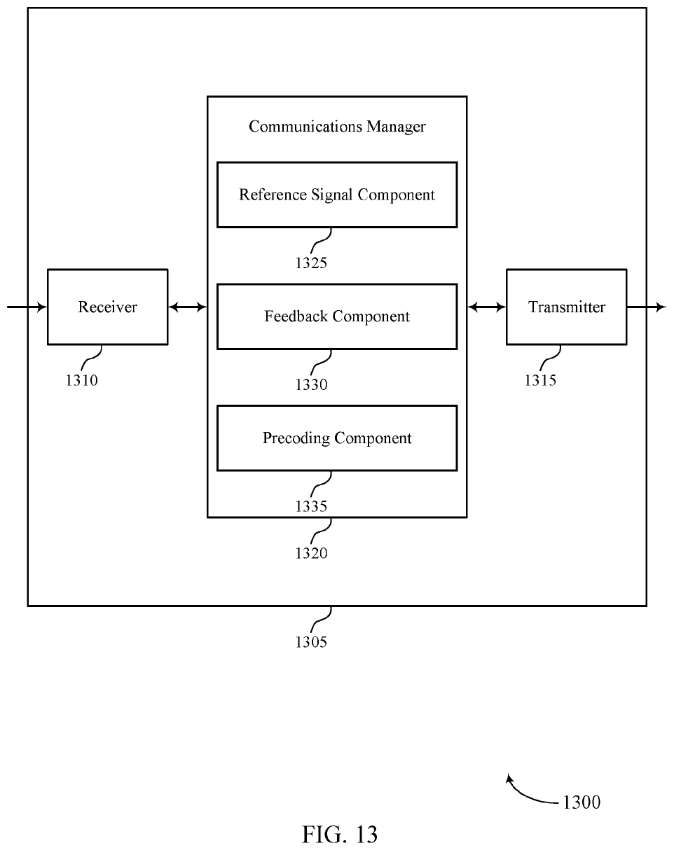

FIG. 13 shows a block diagram 1300 of a device 1305 that supports neural network assisted communication techniques in accordance with one or more aspects of the present disclosure. The device 1305 may be an example of aspects of a device 1205 or a base station 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to neural network assisted communication techniques). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to neural network assisted communication techniques). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of neural network assisted communication techniques as described herein. For example, the communications manager 1320 may include a reference signal component 1325, a feedback component 1330, a precoding component 1335, or any combination thereof. The communications manager 1320 may be an example of aspects of a communications manager 1220 as described herein. In some examples, the communications manager 1320, or various components thereof, may be configured to perform various operations (e.g., receiving, monitoring, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to receive information, transmit information, or perform various other operations as described herein.

The communications manager 1320 may support wireless communication at a base station in accordance with examples as disclosed herein. The reference signal component 1325 may be configured as or otherwise support a means for transmitting, to a UE, a CSI-RS associated with a non-orthogonal cover code of a set of non-orthogonal cover codes for reference signals. The feedback component 1330 may be configured as or otherwise support a means for receiving, from the UE, a feedback message indicating a channel quality parameter that is determined based on a channel estimation procedure of the CSI-RS, the channel estimation procedure corresponding to the non-orthogonal cover code.

Additionally or alternatively, the communications manager 1320 may support wireless communication at a base station in accordance with examples as disclosed herein. The reference signal component 1325 may be configured as or otherwise support a means for generating a CSI-RS using a first set of neural network parameters of a first neural network model for reference signals. The reference signal component 1325 may be configured as or otherwise support a means for transmitting the CSI-RS to a UE. The precoding component 1335 may be configured as or otherwise support a means for receiving, from the UE, an indication of a precoding matrix for communicating with the base station, the precoding matrix determined using the CSI-RS and a second set of neural network parameters of a second neural network model for channel estimation.

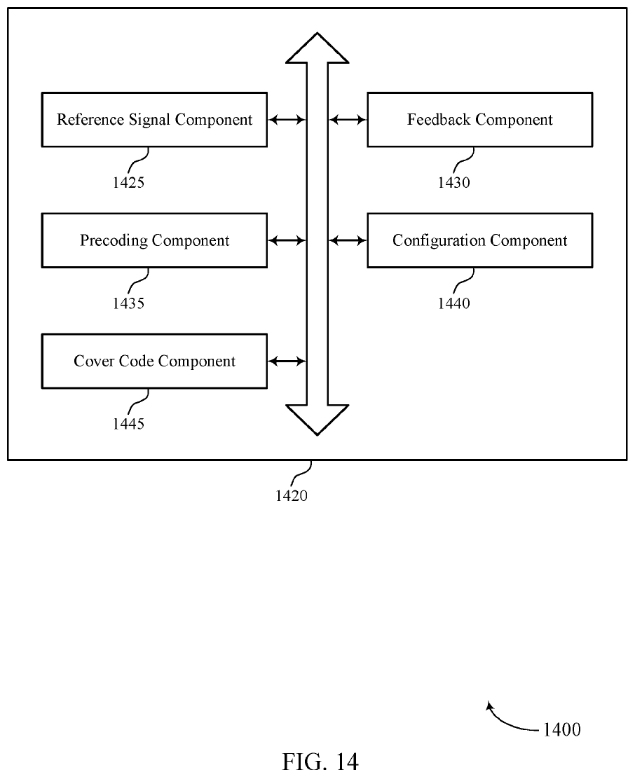

FIG. 14 shows a block diagram 1400 of a communications manager 1420 that supports neural network assisted communication techniques in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of neural network assisted communication techniques as described herein. For example, the communications manager 1420 may include a reference signal component 1425, a feedback component 1430, a precoding component 1435, a configuration component 1440, a cover code component 1445, or any combination thereof. Each of these components may communicate, directly or indirectly, with one another (e.g., via one or more buses).

The communications manager 1420 may support wireless communication at a base station in accordance with examples as disclosed herein. The reference signal component 1425 may be configured as or otherwise support a means for transmitting, to a UE, a CSI-RS associated with a non-orthogonal cover code of a set of non-orthogonal cover codes for reference signals. The feedback component 1430 may be configured as or otherwise support a means for receiving, from the UE, a feedback message indicating a channel quality parameter that is determined based on a channel estimation procedure of the CSI-RS, the channel estimation procedure corresponding to the non-orthogonal cover code.

In some examples, the non-orthogonal cover code is based on a location of one or more resources used to transmit the CSI-RS.

In some examples, the configuration component 1440 may be configured as or otherwise support a means for transmitting a configuration message that indicates a set of communication parameters associated with the non-orthogonal cover code, where the CSI-RS is transmitted in accordance with the set of communication parameters.

In some examples, the set of communication parameters includes a channel condition associated with the CSI-RS, a bandwidth associated with the CSI-RS, a location of one or more resources used to communicate the CSI-RS, a CDM type associated with the CSI-RS, or a combination thereof.

In some examples, the cover code component 1445 may be configured as or otherwise support a means for receiving, from the UE, a message indicating the set of non-orthogonal cover codes, where transmitting the CSI-RS associated with the non-orthogonal cover code is based on receiving the message.

In some examples, the configuration component 1440 may be configured as or otherwise support a means for transmitting, to the UE, a configuration message indicating a second set of non-orthogonal cover codes including the set of non-orthogonal cover codes, where the message indicating the set of non-orthogonal cover codes includes a set of indexes, each index corresponding to a non-orthogonal code of the set of non-orthogonal cover codes.

In some examples, the configuration component 1440 may be configured as or otherwise support a means for transmitting, based on receiving the message indicating the set of non-orthogonal cover codes, a configuration message indicating a set of neural network parameters of a neural network model for channel estimation corresponding to the non-orthogonal cover code.

In some examples, the configuration component 1440 may be configured as or otherwise support a means for transmitting a configuration message indicating a set of neural network parameters of a neural network model for channel estimation corresponding to the non-orthogonal cover code, where the channel estimation procedure is performed using the set of neural network parameters based on transmitting the configuration message.

In some examples, the precoding component 1435 may be configured as or otherwise support a means for receiving, from the UE, an indication of a precoding matrix for communicating with the base station, the precoding matrix determined using the CSI-RS and a set of neural network parameters of a neural network model for channel estimation corresponding to the non-orthogonal cover code.

In some examples, the reference signal component 1425 may be configured as or otherwise support a means for transmitting, in response to receiving the indication of the precoding matrix, a second CSI-RS associated with the non-orthogonal cover code. In some examples, the feedback component 1430 may be configured as or otherwise support a means for receiving, from the UE, a second feedback message including a CQI, an RI, or a combination thereof, determined based on a second channel estimation procedure of the second CSI-RS using a second set of neural network parameters of the neural network model corresponding to the non-orthogonal cover code.

In some examples, the feedback component 1430 may be configured as or otherwise support a means for receiving, from the UE, a second feedback message including a CQI, the CQI determined using the CSI-RS and a set of neural network parameters of a neural network model for channel estimation corresponding to the non-orthogonal cover code.

Additionally or alternatively, the communications manager 1420 may support wireless communication at a base station in accordance with examples as disclosed herein. In some examples, the reference signal component 1425 may be configured as or otherwise support a means for generating a CSI-RS using a first set of neural network parameters of a first neural network model for reference signals. In some examples, the reference signal component 1425 may be configured as or otherwise support a means for transmitting the CSI-RS to a UE. The precoding component 1435 may be configured as or otherwise support a means for receiving, from the UE, an indication of a precoding matrix for communicating with the base station, the precoding matrix determined using the CSI-RS and a second set of neural network parameters of a second neural network model for channel estimation.

In some examples, the reference signal component 1425 may be configured as or otherwise support a means for generating, in response to receiving the indication of the precoding matrix, a second CSI-RS using a third set of neural network parameters of the first neural network model corresponding to the indicated precoding matrix. In some examples, the reference signal component 1425 may be configured as or otherwise support a means for transmitting the second CSI-RS to the UE. In some examples, the feedback component 1430 may be configured as or otherwise support a means for receiving, from the UE, a feedback message including a CQI, an RI, or a combination thereof, determined using the second CSI-RS and a fourth set of neural network parameters of the second neural network model.

In some examples, the feedback component 1430 may be configured as or otherwise support a means for receiving, from the UE, a feedback message including a CQI, the CQI determined using the CSI-RS and a third set of neural network parameters of the second neural network model.

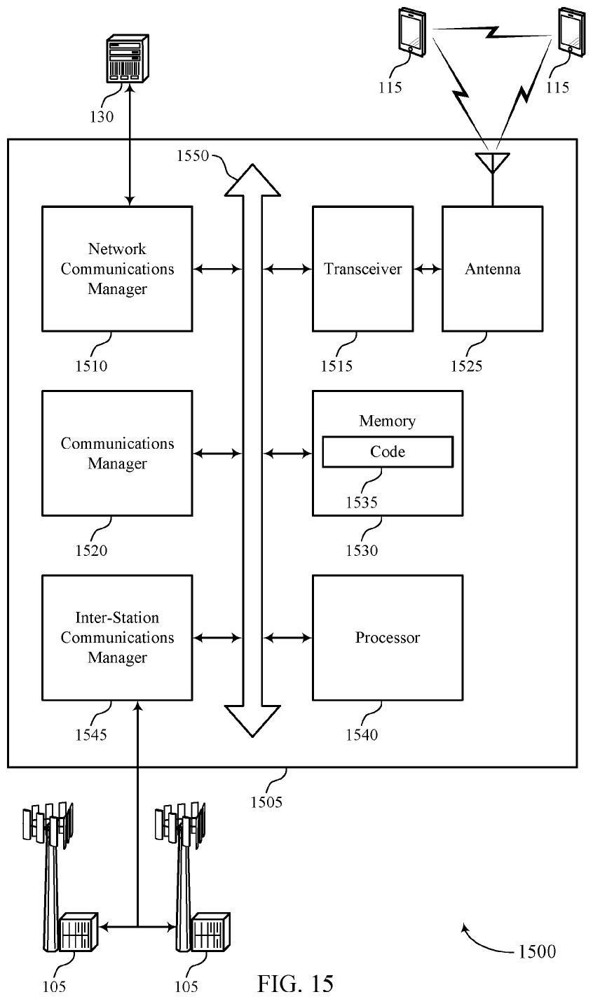

FIG. 15 shows a diagram of a system 1500 including a device 1505 that supports neural network assisted communication techniques in accordance with one or more aspects of the present disclosure. The device 1505 may be an example of or include the components of a device 1205, a device 1305, or a base station 105 as described herein. The device 1505 may communicate wirelessly with one or more base stations 105, UEs 115, or any combination thereof. The device 1505 may include components for bi-directional voice and data communications including components for transmitting and receiving communications, such as a communications manager 1520, a network communications manager 1510, a transceiver 1515, an antenna 1525, a memory 1530, code 1535, a processor 1540, and an inter-station communications manager 1545. These components may be in electronic communication or otherwise coupled (e.g., operatively, communicatively, functionally, electronically, electrically) via one or more buses (e.g., a bus 1550).

The network communications manager 1510 may manage communications with a core network 130 (e.g., via one or more wired backhaul links). For example, the network communications manager 1510 may manage the transfer of data communications for client devices, such as one or more UEs 115.

In some cases, the device 1505 may include a single antenna 1525. However, in some other cases the device 1505 may have more than one antenna 1525, which may be capable of concurrently transmitting or receiving multiple wireless transmissions. The transceiver 1515 may communicate bi-directionally, via the one or more antennas 1525, wired, or wireless links as described herein. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The memory 1530 may include RAM and ROM. The memory 1530 may store computer-readable, computer-executable code 1535 including instructions that, when executed by the processor 1540, cause the device 1505 to perform various functions described herein. The code 1535 may be stored in a non-transitory computer-readable medium such as system memory or another type of memory. In some cases, the code 1535 may not be directly executable by the processor 1540 but may cause a computer (e.g., when compiled and executed) to perform functions described herein. In some cases, the memory 1530 may contain, among other things, a BIOS which may control basic hardware or software operation such as the interaction with peripheral components or devices.

The processor 1540 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1540 may be configured to operate a memory array using a memory controller. In some other cases, a memory controller may be integrated into the processor 1540. The processor 1540 may be configured to execute computer-readable instructions stored in a memory (e.g., the memory 1530) to cause the device 1505 to perform various functions (e.g., functions or tasks supporting neural network assisted communication techniques). For example, the device 1505 or a component of the device 1505 may include a processor 1540 and memory 1530 coupled to the processor 1540, the processor 1540 and memory 1530 configured to perform various functions described herein.

The inter-station communications manager 1545 may manage communications with other base stations 105, and may include a controller or scheduler for controlling communications with UEs 115 in cooperation with other base stations 105. For example, the inter-station communications manager 1545 may coordinate scheduling for transmissions to UEs 115 for various interference mitigation techniques such as beamforming or joint transmission. In some examples, the inter-station communications manager 1545 may provide an X2 interface within an LTE/LTE-A wireless communications network technology to provide communication between base stations 105.

The communications manager 1520 may support wireless communication at a base station in accordance with examples as disclosed herein. For example, the communications manager 1520 may be configured as or otherwise support a means for transmitting, to a UE, a CSI-RS associated with a non-orthogonal cover code of a set of non-orthogonal cover codes for reference signals. The communications manager 1520 may be configured as or otherwise support a means for receiving, from the UE, a feedback message indicating a channel quality parameter that is determined based on a channel estimation procedure of the CSI-RS, the channel estimation procedure corresponding to the non-orthogonal cover code.

Additionally or alternatively, the communications manager 1520 may support wireless communication at a base station in accordance with examples as disclosed herein. For example, the communications manager 1520 may be configured as or otherwise support a means for generating a CSI-RS using a first set of neural network parameters of a first neural network model for reference signals. The communications manager 1520 may be configured as or otherwise support a means for transmitting the CSI-RS to a UE. The communications manager 1520 may be configured as or otherwise support a means for receiving, from the UE, an indication of a precoding matrix for communicating with the base station, the precoding matrix determined using the CSI-RS and a second set of neural network parameters of a second neural network model for channel estimation.

By including or configuring the communications manager 1520 in accordance with examples as described herein, the device 1505 may support techniques for increased data rates, spectral efficiency, reliability, resource usage, battery life, processing capability, and coordination between devices and reduced latency and power consumption, among other benefits.

In some examples, the communications manager 1520 may be configured to perform various operations (e.g., receiving, monitoring, transmitting) using or otherwise in cooperation with the transceiver 1515, the one or more antennas 1525, or any combination thereof. Although the communications manager 1520 is illustrated as a separate component, in some examples, one or more functions described with reference to the communications manager 1520 may be supported by or performed by the processor 1540, the memory 1530, the code 1535, or any combination thereof. For example, the code 1535 may include instructions executable by the processor 1540 to cause the device 1505 to perform various aspects of neural network assisted communication techniques as described herein, or the processor 1540 and the memory 1530 may be otherwise configured to perform or support such operations.

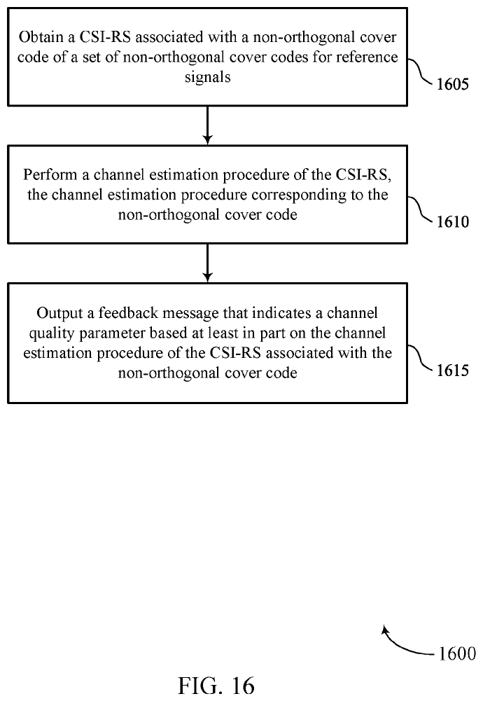

FIG. 16 shows a flowchart illustrating a method 1600 that supports neural network assisted communication techniques in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1605, the method may include obtaining (e.g., receiving from a base station) a CSI-RS associated with a non-orthogonal cover code of a set of non-orthogonal cover codes for reference signals. The operations of 1605 may be performed in accordance with examples as disclosed herein. In some examples, aspects of the operations of 1605 may be performed by a reference signal component 1025 as described with reference to FIG. 10.

At 1610, the method may include performing a channel estimation procedure of the CSI-RS, the channel estimation procedure corresponding to the non-orthogonal cover code. The operations of 1610 may be performed in accordance with examples as disclosed herein. In some examples, aspects of the operations of 1610 may be performed by an estimation component 1030 as described with reference to FIG. 10.

At 1615, the method may include outputting (e.g., transmitting to the base station) a feedback message that indicates a channel quality parameter based on the channel estimation procedure of the CSI-RS associated with the non-orthogonal cover code. The operations of 1615 may be performed in accordance with examples as disclosed herein. In some examples, aspects of the operations of 1615 may be performed by a feedback component 1035 as described with reference to FIG. 10.

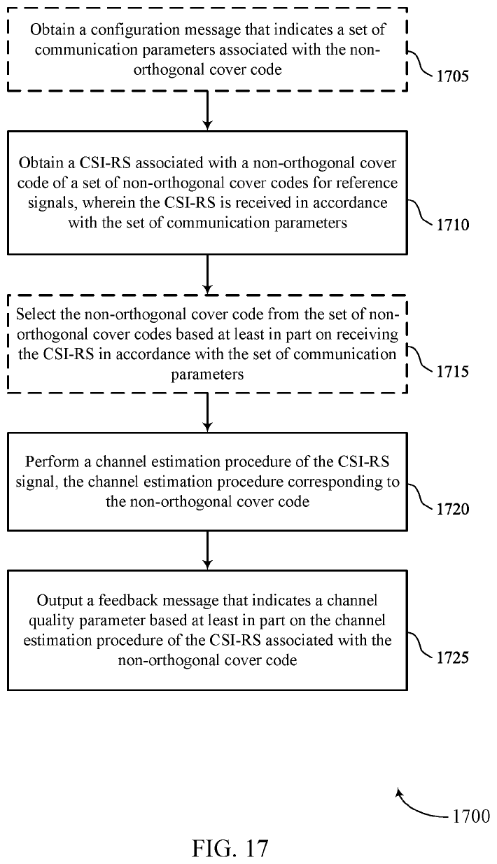

FIG. 17 shows a flowchart illustrating a method 1700 that supports neural network assisted communication techniques in accordance with one or more aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1705, the method may include obtaining (e.g., receiving) a configuration message that indicates a set of communication parameters associated with the non-orthogonal cover code. The operations of 1705 may be performed in accordance with examples as disclosed herein. In some examples, aspects of the operations of 1705 may be performed by a configuration component 1050 as described with reference to FIG. 10.

At 1710, the method may include obtaining (e.g., receiving from a base station) a CSI-RS associated with a non-orthogonal cover code of a set of non-orthogonal cover codes for reference signals, where the CSI-RS is received in accordance with the set of communication parameters. The operations of 1710 may be performed in accordance with examples as disclosed herein. In some examples, aspects of the operations of 1710 may be performed by a reference signal component 1025 as described with reference to FIG. 10.

At 1715, the method may include selecting the non-orthogonal cover code from the set of non-orthogonal cover codes based receiving the CSI-RS in accordance with the set of communication parameters. The operations of 1715 may be performed in accordance with examples as disclosed herein. In some examples, aspects of the operations of 1715 may be performed by a cover code component 1055 as described with reference to FIG. 10.

At 1720, the method may include performing a channel estimation procedure of the CSI-RS, the channel estimation procedure corresponding to the non-orthogonal cover code. The operations of 1720 may be performed in accordance with examples as disclosed herein. In some examples, aspects of the operations of 1720 may be performed by an estimation component 1030 as described with reference to FIG. 10.

At 1725, the method may include outputting (e.g., transmitting to the base station) a feedback message that indicates a channel quality parameter based on the channel estimation procedure of the CSI-RS associated with the non-orthogonal cover code. The operations of 1725 may be performed in accordance with examples as disclosed herein. In some examples, aspects of the operations of 1725 may be performed by a feedback component 1035 as described with reference to FIG. 10.

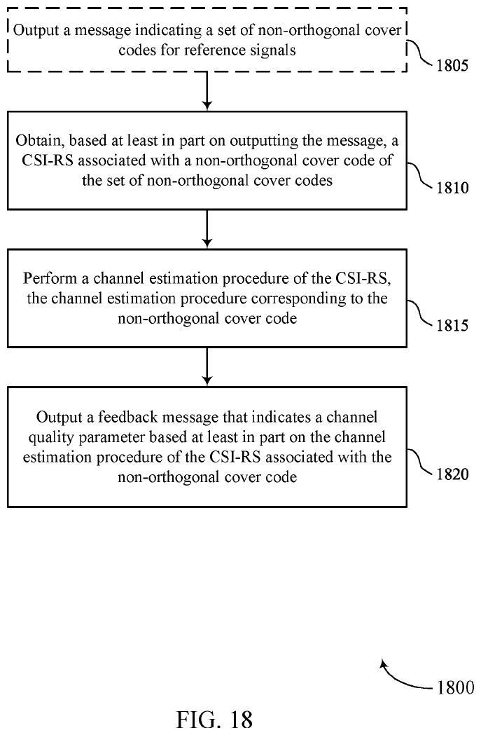

FIG. 18 shows a flowchart illustrating a method 1800 that supports neural network assisted communication techniques in accordance with one or more aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1805, the method may include outputting (e.g., transmitting to a base station) a message indicating a set of non-orthogonal cover codes for reference signals. The operations of 1805 may be performed in accordance with examples as disclosed herein. In some examples, aspects of the operations of 1805 may be performed by a cover code component 1055 as described with reference to FIG. 10.

At 1810, the method may include obtaining, (e.g., receiving from the base station) based on outputting (e.g., transmitting) the message, a CSI-RS associated with a non-orthogonal cover code of the set of non-orthogonal cover codes. The operations of 1810 may be performed in accordance with examples as disclosed herein. In some examples, aspects of the operations of 1810 may be performed by a reference signal component 1025 as described with reference to FIG. 10.

At 1815, the method may include performing a channel estimation procedure of the CSI-RS, the channel estimation procedure corresponding to the non-orthogonal cover code. The operations of 1815 may be performed in accordance with examples as disclosed herein. In some examples, aspects of the operations of 1815 may be performed by an estimation component 1030 as described with reference to FIG. 10.

At 1820, the method may include outputting (e.g., transmitting to the base station) a feedback message that indicates a channel quality parameter based on the channel estimation procedure of the CSI-RS associated with the non-orthogonal cover code. The operations of 1820 may be performed in accordance with examples as disclosed herein. In some examples, aspects of the operations of 1820 may be performed by a feedback component 1035 as described with reference to FIG. 10.

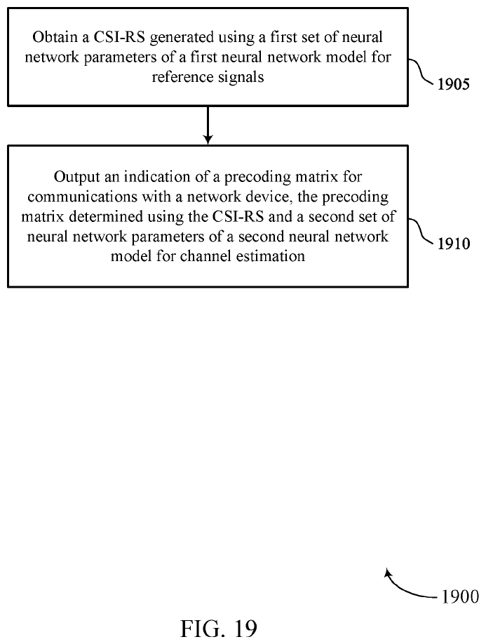

FIG. 19 shows a flowchart illustrating a method 1900 that supports neural network assisted communication techniques in accordance with one or more aspects of the present disclosure. The operations of the method 1900 may be implemented by a UE or its components as described herein. For example, the operations of the method 1900 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1905, the method may include obtaining (e.g., receiving from a base station or network device) a CSI-RS generated using a first set of neural network parameters of a first neural network model for reference signals. The operations of 1905 may be performed in accordance with examples as disclosed herein. In some examples, aspects of the operations of 1905 may be performed by a reference signal component 1025 as described with reference to FIG. 10.

At 1910, the method may include outputting (e.g., transmitting to the base station) an indication of a precoding matrix for communications with the network device (e.g., the base station), the precoding matrix determined using the CSI-RS and a second set of neural network parameters of a second neural network model for channel estimation. The operations of 1910 may be performed in accordance with examples as disclosed herein. In some examples, aspects of the operations of 1910 may be performed by a precoding component 1040 as described with reference to FIG. 10.

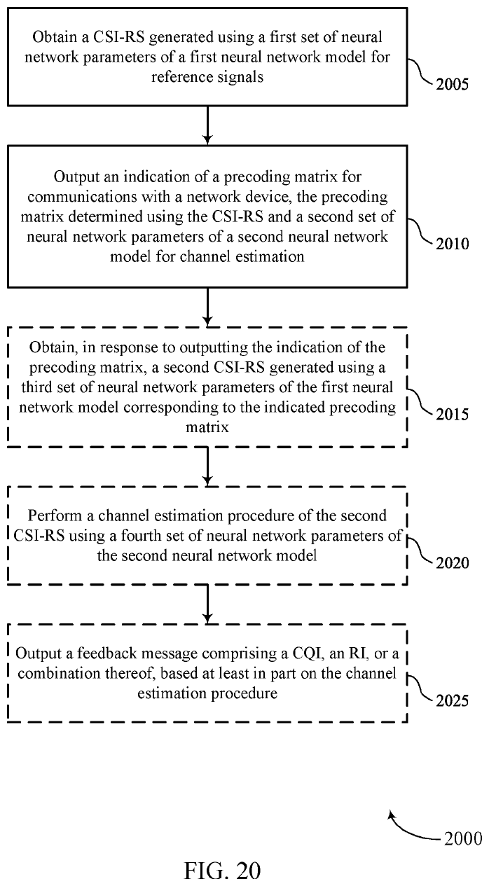

FIG. 20 shows a flowchart illustrating a method 2000 that supports neural network assisted communication techniques in accordance with one or more aspects of the present disclosure. The operations of the method 2000 may be implemented by a UE or its components as described herein. For example, the operations of the method 2000 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 2005, the method may include obtaining (e.g., receiving, from a base station or network device) a CSI-RS generated using a first set of neural network parameters of a first neural network model for reference signals. The operations of 2005 may be performed in accordance with examples as disclosed herein. In some examples, aspects of the operations of 2005 may be performed by a reference signal component 1025 as described with reference to FIG. 10.

At 2010, the method may include outputting (e.g., transmitting, to the base station or network device) an indication of a precoding matrix for communications with the network device (e.g., base station), the precoding matrix determined using the CSI-RS and a second set of neural network parameters of a second neural network model for channel estimation. The operations of 2010 may be performed in accordance with examples as disclosed herein. In some examples, aspects of the operations of 2010 may be performed by a precoding component 1040 as described with reference to FIG. 10.

At 2015, the method may include obtaining (e.g., receiving), in response to outputting (e.g., transmitting) the indication of the precoding matrix, a second CSI-RS generated using a third set of neural network parameters of the first neural network model corresponding to the indicated precoding matrix. The operations of 2015 may be performed in accordance with examples as disclosed herein. In some examples, aspects of the operations of 2015 may be performed by a reference signal component 1025 as described with reference to FIG. 10.

At 2020, the method may include performing a channel estimation procedure of the second CSI-RS using a fourth set of neural network parameters of the second neural network model. The operations of 2020 may be performed in accordance with examples as disclosed herein. In some examples, aspects of the operations of 2020 may be performed by an estimation component 1030 as described with reference to FIG. 10.

At 2025, the method may include outputting (e.g., transmitting) a feedback message including a CQI, an RI, or a combination thereof, based on the channel estimation procedure. The operations of 2025 may be performed in accordance with examples as disclosed herein. In some examples, aspects of the operations of 2025 may be performed by a feedback component 1035 as described with reference to FIG. 10.

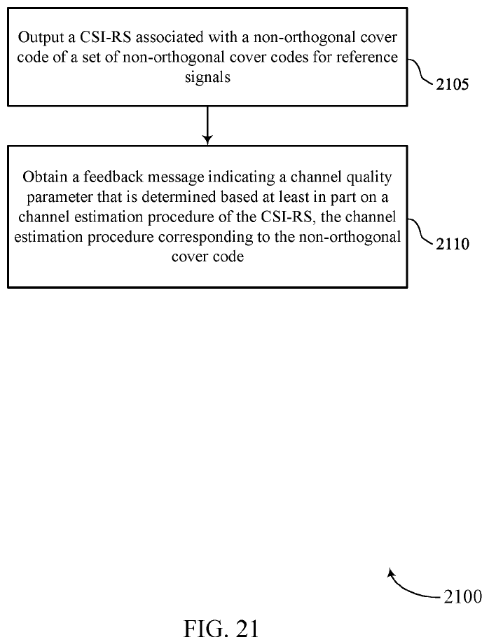

FIG. 21 shows a flowchart illustrating a method 2100 that supports neural network assisted communication techniques in accordance with one or more aspects of the present disclosure. The operations of the method 2100 may be implemented by a base station or its components as described herein. For example, the operations of the method 2100 may be performed by a base station 105 as described with reference to FIGS. 1 through 7 and 12 through 15. In some examples, a base station may execute a set of instructions to control the functional elements of the base station to perform the described functions. Additionally or alternatively, the base station may perform aspects of the described functions using special-purpose hardware.

At 2105, the method may include outputting (e.g., transmitting to a UE) a CSI-RS associated with a non-orthogonal cover code of a set of non-orthogonal cover codes for reference signals. The operations of 2105 may be performed in accordance with examples as disclosed herein. In some examples, aspects of the operations of 2105 may be performed by a reference signal component 1425 as described with reference to FIG. 14.

At 2110, the method may include obtaining (e.g., receiving from the UE) a feedback message indicating a channel quality parameter that is determined based on a channel estimation procedure of the CSI-RS, the channel estimation procedure corresponding to the non-orthogonal cover code. The operations of 2110 may be performed in accordance with examples as disclosed herein. In some examples, aspects of the operations of 2110 may be performed by a feedback component 1430 as described with reference to FIG. 14.

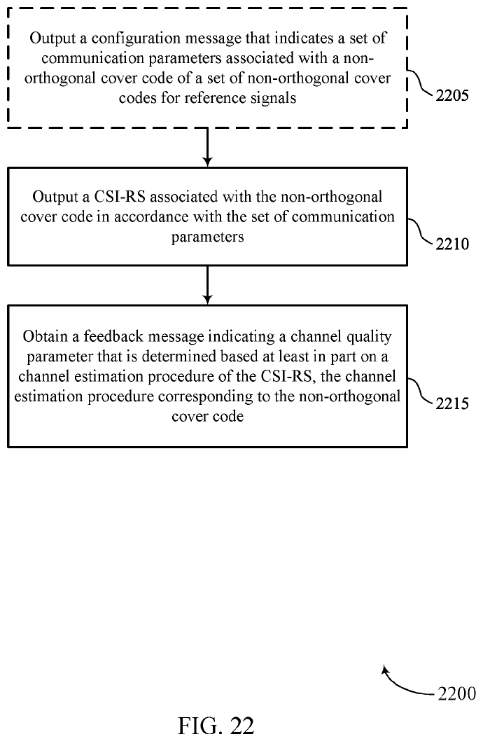

FIG. 22 shows a flowchart illustrating a method 2200 that supports neural network assisted communication techniques in accordance with one or more aspects of the present disclosure. The operations of the method 2200 may be implemented by a base station or its components as described herein. For example, the operations of the method 2200 may be performed by a base station 105 as described with reference to FIGS. 1 through 7 and 12 through 15. In some examples, a base station may execute a set of instructions to control the functional elements of the base station to perform the described functions. Additionally or alternatively, the base station may perform aspects of the described functions using special-purpose hardware.

At 2205, the method may include outputting (e.g., transmitting) a configuration message that indicates a set of communication parameters associated with a non-orthogonal cover code of a set of non-orthogonal cover codes for reference signals. The operations of 2205 may be performed in accordance with examples as disclosed herein. In some examples, aspects of the operations of 2205 may be performed by a configuration component 1440 as described with reference to FIG. 14.

At 2210, the method may include outputting (e.g., transmitting to a UE) a CSI-RS associated with the non-orthogonal cover code in accordance with the set of communication parameters. The operations of 2210 may be performed in accordance with examples as disclosed herein. In some examples, aspects of the operations of 2210 may be performed by a reference signal component 1425 as described with reference to FIG. 14.

At 2215, the method may include obtaining (e.g., receiving from the UE) a feedback message indicating a channel quality parameter that is determined based on a channel estimation procedure of the CSI-RS, the channel estimation procedure corresponding to the non-orthogonal cover code. The operations of 2215 may be performed in accordance with examples as disclosed herein. In some examples, aspects of the operations of 2215 may be performed by a feedback component 1430 as described with reference to FIG. 14.

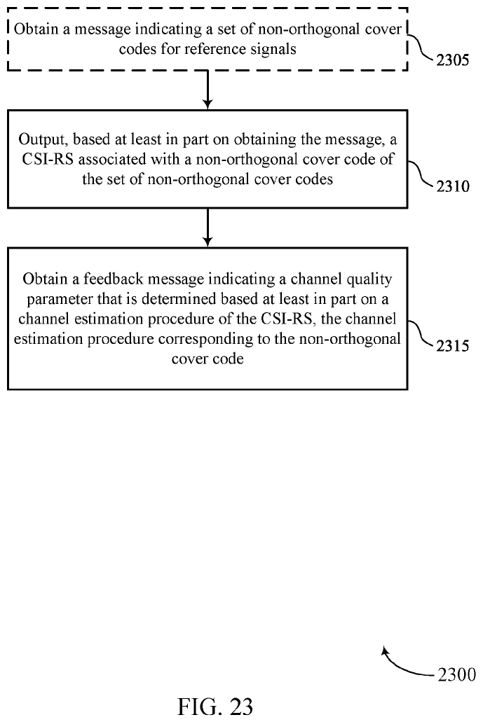

FIG. 23 shows a flowchart illustrating a method 2300 that supports neural network assisted communication techniques in accordance with one or more aspects of the present disclosure. The operations of the method 2300 may be implemented by a base station or its components as described herein. For example, the operations of the method 2300 may be performed by a base station 105 as described with reference to FIGS. 1 through 7 and 12 through 15. In some examples, a base station may execute a set of instructions to control the functional elements of the base station to perform the described functions. Additionally or alternatively, the base station may perform aspects of the described functions using special-purpose hardware.

At 2305, the method may include obtaining (e.g., receiving from a UE) a message indicating a set of non-orthogonal cover codes for reference signals. The operations of 2305 may be performed in accordance with examples as disclosed herein. In some examples, aspects of the operations of 2305 may be performed by a cover code component 1445 as described with reference to FIG. 14.

At 2310, the method may include outputting, (e.g., transmitting to the UE) based on obtaining (e.g., receiving) the message, a CSI-RS associated with a non-orthogonal cover code of the set of non-orthogonal cover codes. The operations of 2310 may be performed in accordance with examples as disclosed herein. In some examples, aspects of the operations of 2310 may be performed by a reference signal component 1425 as described with reference to FIG. 14.

At 2315, the method may include obtaining (e.g., receiving from the UE) a feedback message indicating a channel quality parameter that is determined based on a channel estimation procedure of the CSI-RS, the channel estimation procedure corresponding to the non-orthogonal cover code. The operations of 2315 may be performed in accordance with examples as disclosed herein. In some examples, aspects of the operations of 2315 may be performed by a feedback component 1430 as described with reference to FIG. 14.

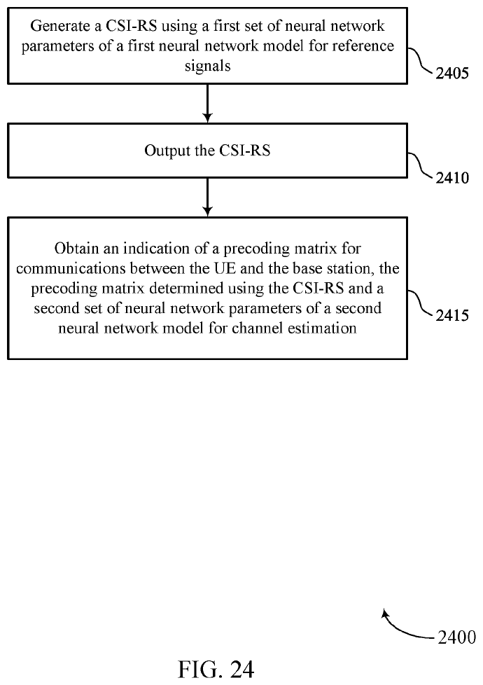

FIG. 24 shows a flowchart illustrating a method 2400 that supports neural network assisted communication techniques in accordance with one or more aspects of the present disclosure. The operations of the method 2400 may be implemented by a base station or its components as described herein. For example, the operations of the method 2400 may be performed by a base station 105 as described with reference to FIGS. 1 through 7 and 12 through 15. In some examples, a base station may execute a set of instructions to control the functional elements of the base station to perform the described functions. Additionally or alternatively, the base station may perform aspects of the described functions using special-purpose hardware.

At 2405, the method may include generating a CSI-RS using a first set of neural network parameters of a first neural network model for reference signals. The operations of 2405 may be performed in accordance with examples as disclosed herein. In some examples, aspects of the operations of 2405 may be performed by a reference signal component 1425 as described with reference to FIG. 14.

At 2410, the method may include outputting (e.g., transmitting) the CSI-RS (e.g., to a UE). The operations of 2410 may be performed in accordance with examples as disclosed herein. In some examples, aspects of the operations of 2410 may be performed by a reference signal component 1425 as described with reference to FIG. 14.

At 2415, the method may include obtaining (e.g., receiving from the UE) an indication of a precoding matrix for communicating with the base station, the precoding matrix determined using the CSI-RS and a second set of neural network parameters of a second neural network model for channel estimation. The operations of 2415 may be performed in accordance with examples as disclosed herein. In some examples, aspects of the operations of 2415 may be performed by a precoding component 1435 as described with reference to FIG. 14.

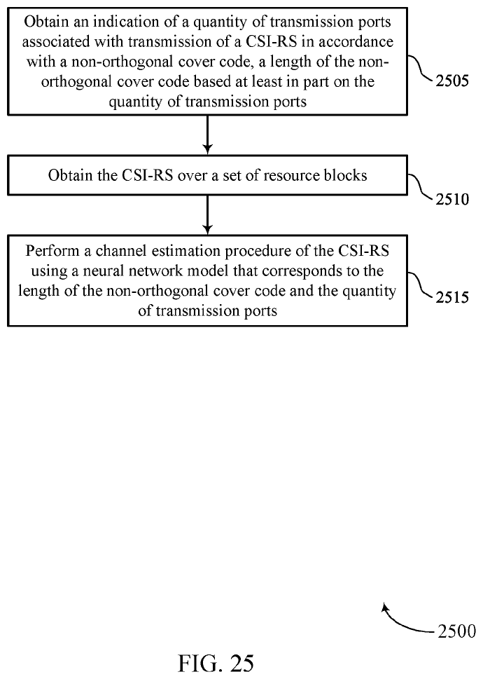

FIG. 25 shows a flowchart illustrating a method 2500 that supports neural network assisted communication techniques in accordance with one or more aspects of the present disclosure. The operations of the method 2500 may be implemented by a UE or its components as described herein. For example, the operations of the method 2500 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 2505, the method may include obtaining an indication of a quantity of transmission ports associated with transmission of a CSI-RS in accordance with a non-orthogonal cover code, a length of the non-orthogonal cover code based on the quantity of transmission ports. The operations of 2505 may be performed in accordance with examples as disclosed herein. In some examples, aspects of the operations of 2505 may be performed by a configuration component 1050 as described with reference to FIG. 10.

At 2510, the method may include obtaining the CSI-RS via a set of resource blocks. The operations of 2510 may be performed in accordance with examples as disclosed herein. In some examples, aspects of the operations of 2510 may be performed by a reference signal component 1025 as described with reference to FIG. 10.

At 2515, the method may include performing a channel estimation procedure of the channel state information-reference signal using a neural network model that corresponds to the length of the non-orthogonal cover code and the quantity of transmission ports. The operations of 2515 may be performed in accordance with examples as disclosed herein. In some examples, aspects of the operations of 2515 may be performed by an estimation component 1030 as described with reference to FIG. 10.

The following provides an overview of aspects of the present disclosure:
Aspect 1: A method for wireless communications at a UE, comprising: obtaining a CSI-RS associated with a non-orthogonal cover code of a set of non-orthogonal cover codes for reference signals; performing a channel estimation procedure of the CSI-RS, the channel estimation procedure corresponding to the non-orthogonal cover code; and outputting a feedback message that indicates a channel quality parameter based at least in part on the channel estimation procedure of the CSI-RS associated with the non-orthogonal cover code.
Aspect 2: The method of aspect 56, further comprising: demultiplexing the CSI-RS based at least in part on the non-orthogonal cover code, wherein the channel estimation procedure is performed based at least in part on inputting the demultiplexed CSI-RS into a neural network model for channel estimation, the neural network model using a set of neural network parameters corresponding to the non-orthogonal cover code.
Aspect 3: The method of aspect 56, further comprising: inputting the CSI-RS into a neural network model for channel estimation, the neural network model using a set of neural network parameters corresponding to the non-orthogonal cover code.
Aspect 4: The method of any of aspects 56 through 58, wherein the non-orthogonal cover code is based at least in part on a location of one or more resources used to communicate the CSI-RS.
Aspect 5: The method of any of aspects 56 through 59, further comprising: obtaining a configuration message that indicates a set of communication parameters associated with the non-orthogonal cover code, wherein the CSI-RS is obtained in accordance with the set of communication parameters; and selecting the non-orthogonal cover code from the set of non-orthogonal cover codes based at least in part on obtaining the CSI-RS in accordance with the set of communication parameters.
Aspect 6: The method of aspect 60, wherein the set of communication parameters comprises a channel condition associated with the CSI-RS, a bandwidth associated with the CSI-RS, a location of one or more resources used to communicate the CSI-RS, a CDM type associated with the CSI-RS, or a combination thereof.
Aspect 7: The method of any of aspects 56 through 61, further comprising: outputting a message indicating the set of non-orthogonal cover codes, wherein the CSI-RS associated with the non-orthogonal cover code is obtained based at least in part on the output of the message.
Aspect 8: The method of aspect 62, further comprising: obtaining a configuration message indicating a second set of non-orthogonal cover codes comprising the set of non-orthogonal cover codes, wherein the message indicating the set of non-orthogonal cover codes comprises a set of indexes, each index corresponding to a non-orthogonal code of the set of non-orthogonal cover codes.
Aspect 9: The method of any of aspects 62 through 63, further comprising: selecting, based at least in part on the output of the message indicating the set of non-orthogonal cover codes, a set of neural network parameters of a neural network model for channel estimation corresponding to the non-orthogonal cover code, wherein the channel estimation procedure is performed using the set of neural network parameters.
Aspect 10: The method of any of aspects 62 through 64, further comprising: obtaining, based at least in part on the output of the message indicating the set of non-orthogonal cover codes, a configuration message indicating a set of neural network parameters of a neural network model for channel estimation corresponding to the non-orthogonal cover code, wherein the channel estimation procedure is performed using the set of neural network parameters.
Aspect 11: The method of any of aspects 56 through 65, further comprising: obtaining a configuration message indicating a set of neural network parameters of a neural network model for channel estimation corresponding to the non-orthogonal cover code, wherein the channel estimation procedure is performed using the set of neural network parameters based at least in part on the configuration message.
Aspect 12: The method of any of aspects 56 through 66, further comprising: outputting an indication of a precoding matrix for communicating with a network device, the precoding matrix determined using the CSI-RS and a set of neural network parameters of a neural network model for channel estimation corresponding to the non-orthogonal cover code.
Aspect 13: The method of aspect 67, further comprising: obtaining, in response to the output of the indication of the precoding matrix, a second CSI-RS associated with the non-orthogonal cover code; performing a second channel estimation procedure of the second CSI-RS using a second set of neural network parameters of the neural network model corresponding to the non-orthogonal cover code; and outputting a second feedback message comprising a CQI, a RI, or a combination thereof, based at least in part on the second channel estimation procedure.
Aspect 14: The method of any of aspects 56 through 68, further comprising: outputting a second feedback message comprising a CQI, the CQI determined using the CSI-RS and a set of neural network parameters of a neural network model for channel estimation corresponding to the non-orthogonal cover code.
Aspect 15: The method of any of aspects 56 through 69, further comprising: obtaining an indication of a quantity of transmission ports associated with transmission of the CSI-RS, wherein a length of the non-orthogonal cover code is based at least in part on the quantity of transmission ports.
Aspect 16: The method of aspect 70, wherein obtaining the CSI-RS comprises: obtaining the CSI-RS via a set of resource blocks, wherein a quantity of the set of resource blocks is based at least in part on a reporting channel bandwidth associated with the feedback message.
Aspect 17: The method of any of aspects 70 through 71, wherein obtaining the CSI-RS comprises: obtaining the CSI-RS via a set of resource elements, wherein a quantity of the set of resource elements is based at least in part on the length of the non-orthogonal cover code.
Aspect 18: A method for wireless communications at a UE, comprising: obtaining a CSI-RS generated using a first set of neural network parameters of a first neural network model for reference signals; and outputting an indication of a precoding matrix for communicating with a network device, the precoding matrix determined using the CSI-RS and a second set of neural network parameters of a second neural network model for channel estimation.
Aspect 19: The method of aspect 73, further comprising: obtaining, in response to the output of the indication of the precoding matrix, a second CSI-RS generated using a third set of neural network parameters of the first neural network model corresponding to the indicated precoding matrix; performing a channel estimation procedure of the second CSI-RS using a fourth set of neural network parameters of the second neural network model; and outputting a feedback message comprising a CQI, a RI, or a combination thereof, based at least in part on the channel estimation procedure.
Aspect 20: The method of aspect 73, further comprising: outputting a feedback message comprising a CQI, the CQI determined using the CSI-RS and a third set of neural network parameters of the second neural network model.
Aspect 21: A method for wireless communications at a network device, comprising: outputting a CSI-RS associated with a non-orthogonal cover code of a set of non-orthogonal cover codes for reference signals; and obtaining a feedback message indicating a channel quality parameter that is determined based at least in part on a channel estimation procedure of the CSI-RS, the channel estimation procedure corresponding to the non-orthogonal cover code.
Aspect 22: The method of aspect 76, wherein the non-orthogonal cover code is based at least in part on a location of one or more resources used to output the CSI-RS.
Aspect 23: The method of any of aspects 76 through 77, further comprising: outputting a configuration message that indicates a set of communication parameters associated with the non-orthogonal cover code, wherein the CSI-RS is output in accordance with the set of communication parameters.
Aspect 24: The method of aspect 78, wherein the set of communication parameters comprises a channel condition associated with the CSI-RS, a bandwidth associated with the CSI-RS, a location of one or more resources used to communicate the CSI-RS, a CDM type associated with the CSI-RS, or a combination thereof.
Aspect 25: The method of any of aspects 76 through 79, further comprising: obtaining a message indicating the set of non-orthogonal cover codes, wherein the processor is configured to output the CSI-RS associated with the non-orthogonal cover code based at least in part on the message.
Aspect 26: The method of aspect 80, further comprising: outputting a configuration message indicating a second set of non-orthogonal cover codes comprising the set of non-orthogonal cover codes, wherein the message indicating the set of non-orthogonal cover codes comprises a set of indexes, each index corresponding to a non-orthogonal code of the set of non-orthogonal cover codes.
Aspect 27: The method of any of aspects 80 through 81, further comprising: outputting, based at least in part on the message indicating the set of non-orthogonal cover codes, a configuration message indicating a set of neural network parameters of a neural network model for channel estimation corresponding to the non-orthogonal cover code.
Aspect 28: The method of any of aspects 76 through 82, further comprising: outputting a configuration message indicating a set of neural network parameters of a neural network model for channel estimation corresponding to the non-orthogonal cover code, wherein the channel estimation procedure is performed using the set of neural network parameters based at least in part on the output of the configuration message.
Aspect 29: The method of any of aspects 76 through 83, further comprising: obtaining an indication of a precoding matrix for communicating with a UE, the precoding matrix determined using the CSI-RS and a set of neural network parameters of a neural network model for channel estimation corresponding to the non-orthogonal cover code.
Aspect 30: The method of aspect 84, further comprising: outputting, in response to the indication of the precoding matrix, a second CSI-RS associated with the non-orthogonal cover code; and obtaining a second feedback message comprising a CQI, a RI, or a combination thereof, determined based at least in part on a second channel estimation procedure of the second CSI-RS using a second set of neural network parameters of the neural network model corresponding to the non-orthogonal cover code.
Aspect 31: The method of any of aspects 76 through 85, further comprising: obtaining a second feedback message comprising a CQI, the CQI determined using the CSI-RS and a set of neural network parameters of a neural network model for channel estimation corresponding to the non-orthogonal cover code.
Aspect 32: The method of any of aspects 76 through 86, further comprising: outputting an indication of a quantity of transmission ports associated with the output of the CSI-RS, wherein a length of the non-orthogonal cover code is based at least in part on the quantity of transmission ports.
Aspect 33: The method of aspect 87, wherein outputting the CSI-RS comprises: outputting the CSI-RS via a set of resource elements, wherein a quantity of the set of resource elements is based at least in part on the length of the non-orthogonal cover code.
Aspect 34: A method for wireless communications at a network device, comprising: generating a CSI-RS using a first set of neural network parameters of a first neural network model for reference signals; outputting the CSI-RS; and obtaining an indication of a precoding matrix for communicating with a UE, the precoding matrix determined using the CSI-RS and a second set of neural network parameters of a second neural network model for channel estimation.
Aspect 35: The method of aspect 89, further comprising: generating, in response to the indication of the precoding matrix, a second CSI-RS using a third set of neural network parameters of the first neural network model corresponding to the indicated precoding matrix; outputting the second CSI-RS; and obtaining a feedback message comprising a CQI, a RI, or a combination thereof, determined using the second CSI-RS and a fourth set of neural network parameters of the second neural network model.
Aspect 36: A method for wireless communications at a UE, comprising: obtaining an indication of a quantity of transmission ports associated with transmission of a CSI-RS in accordance with a non-orthogonal cover code, a length of the non-orthogonal cover code based at least in part on the quantity of transmission ports; obtaining the CSI-RS via a set of resource blocks; and performing a channel estimation procedure of the CSI-RS using a neural network model that corresponds to the length of the non-orthogonal cover code and the quantity of transmission ports.
Aspect 37: The method of aspect 91, wherein obtaining the CSI-RS comprises: obtain the CSI-RS in accordance with a set of non-orthogonal cover codes comprising the non-orthogonal cover code, wherein each non-orthogonal cover code is specific to a resource block of the set of resource blocks.
Aspect 38: The method of any of aspects 91 through 92, wherein obtaining the CSI-RS comprises: obtain, via each resource block of the set of resource blocks, the CSI-RS via a set of resource elements of the resource block, wherein a quantity of resource elements of the set of resource elements is based at least in part on the length of the non-orthogonal cover code.
Aspect 39: The method of aspect 93, wherein the quantity of resource elements per resource block of the set of resource blocks is less than the quantity of transmission ports.
Aspect 40: The method of any of aspects 91 through 94, wherein the length of the non-orthogonal cover code per resource block of the set of resource blocks is less than the quantity of transmission ports.
Aspect 41: An apparatus for wireless communications at a UE, comprising a processor; and memory coupled with the processor, the processor configured to perform a method of any of aspects 56 through 72.
Aspect 42: An apparatus for wireless communications at a UE, comprising at least one means for performing a method of any of aspects 56 through 72.
Aspect 43: A non-transitory computer-readable medium storing code for wireless communications at a UE, the code comprising instructions executable by a processor to perform a method of any of aspects 56 through 72.
Aspect 44: An apparatus for wireless communications at a UE, comprising a processor; and memory coupled with the processor, the processor configured to perform a method of any of aspects 73 through 75.
Aspect 45: An apparatus for wireless communications at a UE, comprising at least one means for performing a method of any of aspects 73 through 75.
Aspect 46: A non-transitory computer-readable medium storing code for wireless communications at a UE, the code comprising instructions executable by a processor to perform a method of any of aspects 73 through 75.
Aspect 47: An apparatus for wireless communications at a network device, comprising a processor; and memory coupled with the processor, the processor configured to perform a method of any of aspects 76 through 88.
Aspect 48: An apparatus for wireless communications at a network device, comprising at least one means for performing a method of any of aspects 76 through 88.
Aspect 49: A non-transitory computer-readable medium storing code for wireless communications at a network device, the code comprising instructions executable by a processor to perform a method of any of aspects 76 through 88.
Aspect 50: An apparatus for wireless communications at a network device, comprising a processor; and memory coupled with the processor, the processor configured to perform a method of any of aspects 89 through 90.
Aspect 51: An apparatus for wireless communications at a network device, comprising at least one means for performing a method of any of aspects 89 through 90.
Aspect 52: A non-transitory computer-readable medium storing code for wireless communications at a network device, the code comprising instructions executable by a processor to perform a method of any of aspects 89 through 90.
Aspect 53: An apparatus for wireless communications at a UE, comprising a processor; and memory coupled with the processor, the processor configured to perform a method of any of aspects 91 through 95.
Aspect 54: An apparatus for wireless communications at a UE, comprising at least one means for performing a method of any of aspects 91 through 95.
Aspect 55: A non-transitory computer-readable medium storing code for wireless communications at a UE, the code comprising instructions executable by a processor to perform a method of any of aspects 91 through 95.
Aspect 56: A method for wireless communication at a UE, comprising: receiving, from a base station, a CSI-RS associated with a non-orthogonal cover code of a set of non-orthogonal cover codes for reference signals; performing a channel estimation procedure of the CSI-RS, the channel estimation procedure corresponding to the non-orthogonal cover code; and transmitting, to the base station, a feedback message that indicates a channel quality parameter based at least in part on the channel estimation procedure of the CSI-RS associated with the non-orthogonal cover code.
Aspect 57: The method of aspect 56, further comprising: demultiplexing the CSI-RS based at least in part on the non-orthogonal cover code, wherein performing the channel estimation procedure is based at least in part on inputting the demultiplexed CSI-RS into a neural network model for channel estimation, the neural network model using a set of neural network parameters corresponding to the non-orthogonal cover code.
Aspect 58: The method of aspect 56, the performing the channel estimation procedure comprising: inputting the CSI-RS into a neural network model for channel estimation, the neural network model using a set of neural network parameters corresponding to the non-orthogonal cover code.
Aspect 59: The method of any of aspects 56 through 58, wherein the non-orthogonal cover code is based at least in part on a location of one or more resources used to communicate the CSI-RS.
Aspect 60: The method of any of aspects 56 through 59, further comprising: receiving a configuration message that indicates a set of communication parameters associated with the non-orthogonal cover code, wherein the CSI-RS is received in accordance with the set of communication parameters; and selecting the non-orthogonal cover code from the set of non-orthogonal cover codes based at least in part receiving the CSI-RS in accordance with the set of communication parameters.
Aspect 61: The method of aspect 60, wherein the set of communication parameters comprises a channel condition associated with the CSI-RS, a bandwidth associated with the CSI-RS, a location of one or more resources used to communicate the CSI-RS, a CDM type associated with the CSI-RS, or a combination thereof.
Aspect 62: The method of any of aspects 56 through 61, further comprising: transmitting, to the base station, a message indicating the set of non-orthogonal cover codes, wherein receiving the CSI-RS associated with the non-orthogonal cover code is based at least in part on transmitting the message.
Aspect 63: The method of aspect 62, further comprising: receiving, from the base station, a configuration message indicating a second set of non-orthogonal cover codes comprising the set of non-orthogonal cover codes, wherein the message indicating the set of non-orthogonal cover codes comprises a set of indexes, each index corresponding to a non-orthogonal code of the set of non-orthogonal cover codes.
Aspect 64: The method of any of aspects 62 through 63, further comprising: selecting, based at least in part on transmitting the message indicating the set of non-orthogonal cover codes, a set of neural network parameters of a neural network model for channel estimation corresponding to the non-orthogonal cover code, wherein the channel estimation procedure is performed using the set of neural network parameters.
Aspect 65: The method of any of aspects 62 through 64, further comprising: receiving, based at least in part on transmitting the message indicating the set of non-orthogonal cover codes, a configuration message indicating a set of neural network parameters of a neural network model for channel estimation corresponding to the non-orthogonal cover code, wherein the channel estimation procedure is performed using the set of neural network parameters.
Aspect 66: The method of any of aspects 56 through 65, further comprising: receiving a configuration message indicating a set of neural network parameters of a neural network model for channel estimation corresponding to the non-orthogonal cover code, wherein the channel estimation procedure is performed using the set of neural network parameters based at least in part on receiving the configuration message.
Aspect 67: The method of any of aspects 56 through 66, further comprising: transmitting, to the base station, an indication of a precoding matrix for communicating with the base station, the precoding matrix determined using the CSI-RS and a set of neural network parameters of a neural network model for channel estimation corresponding to the non-orthogonal cover code.
Aspect 68: The method of aspect 67, further comprising: receiving, in response to transmitting the indication of the precoding matrix, a second CSI-RS associated with the non-orthogonal cover code; performing a second channel estimation procedure of the second CSI-RS using a second set of neural network parameters of the neural network model corresponding to the non-orthogonal cover code; and transmitting, to the base station, a second feedback message comprising a CQI, an RI, or a combination thereof, based at least in part on the second channel estimation procedure.
Aspect 69: The method of any of aspects 56 through 66, further comprising: transmitting, to the base station, a second feedback message comprising a CQI, the CQI determined using the CSI-RS and a set of neural network parameters of a neural network model for channel estimation corresponding to the non-orthogonal cover code.
Aspect 70: A method for wireless communication at a UE, comprising: receiving, from a base station, a CSI-RS generated using a first set of neural network parameters of a first neural network model for reference signals; and transmitting, to the base station, an indication of a precoding matrix for communicating with the base station, the precoding matrix determined using the CSI-RS and a second set of neural network parameters of a second neural network model for channel estimation.
Aspect 71: The method of aspect 70, further comprising: receiving, in response to transmitting the indication of the precoding matrix, a second CSI-RS generated using a third set of neural network parameters of the first neural network model corresponding to the indicated precoding matrix; performing a channel estimation procedure of the second CSI-RS using a fourth set of neural network parameters of the second neural network model; and transmitting a feedback message comprising a CQI, an RI, or a combination thereof, based at least in part on the channel estimation procedure.
Aspect 72: The method of aspect 70, further comprising: transmitting, to the base station, a feedback message comprising a CQI, the CQI determined using the CSI-RS and a third set of neural network parameters of the second neural network model.
Aspect 73: A method for wireless communication at a base station, comprising: transmitting, to a UE, a CSI-RS associated with a non-orthogonal cover code of a set of non-orthogonal cover codes for reference signals; and receiving, from the UE, a feedback message indicating a channel quality parameter that is determined based at least in part on a channel estimation procedure of the CSI-RS, the channel estimation procedure corresponding to the non-orthogonal cover code.
Aspect 74: The method of aspect 73, wherein the non-orthogonal cover code is based at least in part on a location of one or more resources used to transmit the CSI-RS.
Aspect 75: The method of any of aspects 73 through 74, further comprising: transmitting a configuration message that indicates a set of communication parameters associated with the non-orthogonal cover code, wherein the CSI-RS is transmitted in accordance with the set of communication parameters.
Aspect 76: The method of aspect 75, wherein the set of communication parameters comprises a channel condition associated with the CSI-RS, a bandwidth associated with the CSI-RS, a location of one or more resources used to communicate the CSI-RS, a CDM type associated with the CSI-RS, or a combination thereof.
Aspect 77: The method of any of aspects 73 through 76, further comprising: receiving, from the UE, a message indicating the set of non-orthogonal cover codes, wherein transmitting the CSI-RS associated with the non-orthogonal cover code is based at least in part on receiving the message.
Aspect 78: The method of aspect 77, further comprising: transmitting, to the UE, a configuration message indicating a second set of non-orthogonal cover codes comprising the set of non-orthogonal cover codes, wherein the message indicating the set of non-orthogonal cover codes comprises a set of indexes, each index corresponding to a non-orthogonal code of the set of non-orthogonal cover codes.
Aspect 79: The method of any of aspects 77 through 78, further comprising: transmitting, based at least in part on receiving the message indicating the set of non-orthogonal cover codes, a configuration message indicating a set of neural network parameters of a neural network model for channel estimation corresponding to the non-orthogonal cover code.
Aspect 80: The method of any of aspects 73 through 79, further comprising: transmitting a configuration message indicating a set of neural network parameters of a neural network model for channel estimation corresponding to the non-orthogonal cover code, wherein the channel estimation procedure is performed using the set of neural network parameters based at least in part on transmitting the configuration message.
Aspect 81: The method of any of aspects 73 through 80, further comprising: receiving, from the UE, an indication of a precoding matrix for communicating with the base station, the precoding matrix determined using the CSI-RS and a set of neural network parameters of a neural network model for channel estimation corresponding to the non-orthogonal cover code.
Aspect 82: The method of aspect 81, further comprising: transmitting, in response to receiving the indication of the precoding matrix, a second CSI-RS associated with the non-orthogonal cover code; and receiving, from the UE, a second feedback message comprising a CQI, an RI, or a combination thereof, determined based at least in part on a second channel estimation procedure of the second CSI-RS using a second set of neural network parameters of the neural network model corresponding to the non-orthogonal cover code.
Aspect 83: The method of any of aspects 73 through 80, further comprising: receiving, from the UE, a second feedback message comprising a CQI, the CQI determined using the CSI-RS and a set of neural network parameters of a neural network model for channel estimation corresponding to the non-orthogonal cover code.
Aspect 84: A method for wireless communication at a base station, comprising: generating a CSI-RS using a first set of neural network parameters of a first neural network model for reference signals; transmitting the CSI-RS to a UE; and receiving, from the UE, an indication of a precoding matrix for communicating with the base station, the precoding matrix determined using the CSI-RS and a second set of neural network parameters of a second neural network model for channel estimation.
Aspect 85: The method of aspect 84, further comprising: generating, in response to receiving the indication of the precoding matrix, a second CSI-RS using a third set of neural network parameters of the first neural network model corresponding to the indicated precoding matrix; transmitting the second CSI-RS to the UE; and receiving, from the UE, a feedback message comprising a CQI, an RI, or a combination thereof, determined using the second CSI-RS and a fourth set of neural network parameters of the second neural network model.
Aspect 86: The method of aspect 84, further comprising: receiving, from the UE, a feedback message comprising a CQI, the CQI determined using the CSI-RS and a third set of neural network parameters of the second neural network model.
Aspect 87: An apparatus for wireless communication at a UE, comprising a processor; and memory coupled with the processor, the processor and memory configured to perform a method of any of aspects 56 through 69.
Aspect 88: An apparatus for wireless communication at a UE, comprising at least one means for performing a method of any of aspects 56 through 69.
Aspect 89: A non-transitory computer-readable medium storing code for wireless communication at a UE, the code comprising instructions executable by a processor to perform a method of any of aspects 56 through 69.
Aspect 90: An apparatus for wireless communication at a UE, comprising a processor; and memory coupled with the processor, the processor and memory configured to perform a method of any of aspects 70 through 72.
Aspect 91: An apparatus for wireless communication at a UE, comprising at least one means for performing a method of any of aspects 70 through 72.
Aspect 92: A non-transitory computer-readable medium storing code for wireless communication at a UE, the code comprising instructions executable by a processor to perform a method of any of aspects 70 through 72.
Aspect 93: An apparatus for wireless communication at a base station, comprising a processor; and memory coupled with the processor, the processor and memory configured to perform a method of any of aspects 73 through 83.
Aspect 94: An apparatus for wireless communication at a base station, comprising at least one means for performing a method of any of aspects 73 through 83.
Aspect 95: A non-transitory computer-readable medium storing code for wireless communication at a base station, the code comprising instructions executable by a processor to perform a method of any of aspects 73 through 83.
Aspect 96: An apparatus for wireless communication at a base station, comprising a processor; and memory coupled with the processor, the processor and memory configured to perform a method of any of aspects 84 through 86.
Aspect 97: An apparatus for wireless communication at a base station, comprising at least one means for performing a method of any of aspects 84 through 86.
Aspect 98: A non-transitory computer-readable medium storing code for wireless communication at a base station, the code comprising instructions executable by a processor to perform a method of any of aspects 84 through 86.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor; and
memory coupled with the processor, the processor configured to:
obtain a channel state information-reference signal associated with a non-orthogonal cover code of a set of non-orthogonal cover codes for reference signals;
perform a channel estimation procedure of the channel state information-reference signal, the channel estimation procedure corresponding to the non-orthogonal cover code; and
output a feedback message that indicates a channel quality parameter based at least in part on the channel estimation procedure of the channel state information-reference signal associated with the non-orthogonal cover code.

2. The apparatus of claim 1, wherein the processor is further configured to:
demultiplex the channel state information-reference signal based at least in part on the non-orthogonal cover code, wherein the channel estimation procedure is performed based at least in part on inputting the demultiplexed channel state information-reference signal into a neural network model for channel estimation, the neural network model using a set of neural network parameters corresponding to the non-orthogonal cover code.

3. The apparatus of claim 1, wherein the processor is further configured to:
input the channel state information-reference signal into a neural network model for channel estimation, the neural network model using a set of neural network parameters corresponding to the non-orthogonal cover code.

4. The apparatus of claim 1, wherein the non-orthogonal cover code is based at least in part on a location of one or more resources used to communicate the channel state information-reference signal.

5. The apparatus of claim 1, wherein the processor is further configured to:
obtain a configuration message that indicates a set of communication parameters associated with the non-orthogonal cover code, wherein the channel state information-reference signal is obtained in accordance with the set of communication parameters; and
select the non-orthogonal cover code from the set of non-orthogonal cover codes based at least in part on obtainment of the channel state information-reference signal in accordance with the set of communication parameters.

6. The apparatus of claim 5, wherein the set of communication parameters comprises a channel condition associated with the channel state information-reference signal, a bandwidth associated with the channel state information-reference signal, a location of one or more resources used to communicate the channel state information-reference signal, a code division multiplexing type associated with the channel state information-reference signal, or a combination thereof.

7. The apparatus of claim 1, wherein the processor is further configured to:
output a message indicating the set of non-orthogonal cover codes, wherein the channel state information-reference signal associated with the non-orthogonal cover code is obtained based at least in part on the output of the message.

8. The apparatus of claim 7, wherein the processor is further configured to:
obtain a configuration message indicating a second set of non-orthogonal cover codes comprising the set of non-orthogonal cover codes, wherein the message indicating the set of non-orthogonal cover codes comprises a set of indexes, each index corresponding to a non-orthogonal code of the set of non-orthogonal cover codes.

9. The apparatus of claim 7, wherein the processor is further configured to:
select, based at least in part on the output of the message indicating the set of non-orthogonal cover codes, a set of neural network parameters of a neural network model for channel estimation corresponding to the non-orthogonal cover code, wherein the channel estimation procedure is performed using the set of neural network parameters.

10. The apparatus of claim 7, wherein the processor is further configured to:
obtain, based at least in part on the output of the message indicating the set of non-orthogonal cover codes, a configuration message indicating a set of neural network parameters of a neural network model for channel estimation corresponding to the non-orthogonal cover code, wherein the channel estimation procedure is performed using the set of neural network parameters.

11. The apparatus of claim 1, wherein the processor is further configured to:
obtain a configuration message indicating a set of neural network parameters of a neural network model for channel estimation corresponding to the non-orthogonal cover code, wherein the channel estimation procedure is performed using the set of neural network parameters based at least in part on the configuration message.

12. The apparatus of claim 1, wherein the processor is further configured to:
output an indication of a precoding matrix for communicating with a network device, the precoding matrix determined using the channel state information-reference signal and a set of neural network parameters of a neural network model for channel estimation corresponding to the non-orthogonal cover code.

13. The apparatus of claim 12, wherein the processor is further configured to:
obtain, in response to the output of the indication of the precoding matrix, a second channel state information-reference signal associated with the non-orthogonal cover code;
perform a second channel estimation procedure of the second channel state information-reference signal using a second set of neural network parameters of the neural network model corresponding to the non-orthogonal cover code; and
output a second feedback message comprising a channel quality indicator, a rank indicator, or a combination thereof, based at least in part on the second channel estimation procedure.

14. The apparatus of claim 1, further comprising:
an antenna panel, wherein the processor and antenna panel are further configured to:
output a second feedback message comprising a channel quality indicator, the channel quality indicator determined using the channel state information-reference signal and a set of neural network parameters of a neural network model for channel estimation corresponding to the non-orthogonal cover code.

15. The apparatus of claim 1, wherein the processor is further configured to:
obtain an indication of a quantity of transmission ports associated with transmission of the channel state information-reference signal, wherein a length of the non-orthogonal cover code is based at least in part on the quantity of transmission ports.

16. The apparatus of claim 15, wherein, to obtain the channel state information-reference signal, the processor is configured to:
obtain the channel state information-reference signal via a set of resource blocks, wherein a quantity of the set of resource blocks is based at least in part on a reporting channel bandwidth associated with the feedback message.

17. The apparatus of claim 15, wherein, to obtain the channel state information-reference signal, the processor is configured to:
obtain the channel state information-reference signal via a set of resource elements, wherein a quantity of the set of resource elements is based at least in part on the length of the non-orthogonal cover code.

18. An apparatus for wireless communication at a user equipment (UE), comprising:
a processor; and
memory coupled with the processor, the processor configured to:
obtain a channel state information-reference signal generated using a first set of neural network parameters of a first neural network model for reference signals; and
output an indication of a precoding matrix for communications with a network device, the precoding matrix determined using the channel state information-reference signal and a second set of neural network parameters of a second neural network model for channel estimation.

19. The apparatus of claim 18, wherein the processor is further configured to:
obtain, in response to the output of the indication of the precoding matrix, a second channel state information-reference signal generated using a third set of neural network parameters of the first neural network model corresponding to the indicated precoding matrix;
perform a channel estimation procedure of the second channel state information-reference signal using a fourth set of neural network parameters of the second neural network model; and
output a feedback message comprising a channel quality indicator, a rank indicator, or a combination thereof, based at least in part on the channel estimation procedure.

20. The apparatus of claim 18, wherein the processor is further configured to:
output a feedback message comprising a channel quality indicator, the channel quality indicator determined using the channel state information-reference signal and a third set of neural network parameters of the second neural network model.

21. An apparatus for wireless communication at a network device, comprising:
a processor; and
memory coupled with the processor, the processor configured to:
output a channel state information-reference signal associated with a non-orthogonal cover code of a set of non-orthogonal cover codes for reference signals; and
obtain a feedback message indicating a channel quality parameter that is determined based at least in part on a channel estimation procedure of the channel state information-reference signal, the channel estimation procedure corresponding to the non-orthogonal cover code.

22. The apparatus of claim 21, wherein the non-orthogonal cover code is based at least in part on a location of one or more resources used to output the channel state information-reference signal.

23. The apparatus of claim 21, wherein the processor is further configured to:
output a configuration message that indicates a set of communication parameters associated with the non-orthogonal cover code, wherein the channel state information-reference signal is output in accordance with the set of communication parameters.

24. The apparatus of claim 23, wherein the set of communication parameters comprises a channel condition associated with the channel state information-reference signal, a bandwidth associated with the channel state information-reference signal, a location of one or more resources used to communicate the channel state information-reference signal, a code division multiplexing type associated with the channel state information-reference signal, or a combination thereof.

25. The apparatus of claim 21, wherein the processor is further configured to:
obtain a message indicating the set of non-orthogonal cover codes, wherein the processor is configured to output the channel state information-reference signal associated with the non-orthogonal cover code based at least in part on the message.

26. The apparatus of claim 25, wherein the processor is further configured to:
output a configuration message indicating a second set of non-orthogonal cover codes comprising the set of non-orthogonal cover codes, wherein the message indicating the set of non-orthogonal cover codes comprises a set of indexes, each index corresponding to a non-orthogonal code of the set of non-orthogonal cover codes.

27. The apparatus of claim 25, wherein the processor is further configured to:
output, based at least in part on the message indicating the set of non-orthogonal cover codes, a configuration message indicating a set of neural network parameters of a neural network model for channel estimation corresponding to the non-orthogonal cover code.

28. The apparatus of claim 21, wherein the processor is further configured to:
output a configuration message indicating a set of neural network parameters of a neural network model for channel estimation corresponding to the non-orthogonal cover code, wherein the channel estimation procedure is performed using the set of neural network parameters based at least in part on the output of the configuration message.

29. The apparatus of claim 21, wherein the processor is further configured to:
obtain an indication of a precoding matrix for communicating with a user equipment (UE), the precoding matrix determined using the channel state information-reference signal and a set of neural network parameters of a neural network model for channel estimation corresponding to the non-orthogonal cover code.

30. The apparatus of claim 29, wherein the processor is further configured to:
output, in response to the indication of the precoding matrix, a second channel state information-reference signal associated with the non-orthogonal cover code; and
obtain a second feedback message comprising a channel quality indicator, a rank indicator, or a combination thereof, determined based at least in part on a second channel estimation procedure of the second channel state information-reference signal using a second set of neural network parameters of the neural network model corresponding to the non-orthogonal cover code.

31. The apparatus of claim 21, wherein the processor is further configured to:
obtain a second feedback message comprising a channel quality indicator, the channel quality indicator determined using the channel state information-reference signal and a set of neural network parameters of a neural network model for channel estimation corresponding to the non-orthogonal cover code.

32. The apparatus of claim 21, wherein the processor is further configured to:
output an indication of a quantity of transmission ports associated with the output of the channel state information-reference signal, wherein a length of the non-orthogonal cover code is based at least in part on the quantity of transmission ports.

33. The apparatus of claim 32, wherein, to output the channel state information-reference signal, the processor is configured to:
output the channel state information-reference signal via a set of resource elements, wherein a quantity of the set of resource elements is based at least in part on the length of the non-orthogonal cover code.

34. An apparatus for wireless communication at a network device, comprising:
a processor; and
memory coupled with the processor, the processor configured to:
generate a channel state information-reference signal using a first set of neural network parameters of a first neural network model for reference signals;
output the channel state information-reference signal; and
obtain an indication of a precoding matrix for communicating with a user equipment (UE), the precoding matrix determined using the channel state information-reference signal and a second set of neural network parameters of a second neural network model for channel estimation.

35. The apparatus of claim 34, wherein the processor is further configured to:
generate, in response to the indication of the precoding matrix, a second channel state information-reference signal using a third set of neural network parameters of the first neural network model corresponding to the indicated precoding matrix;
output the second channel state information-reference signal; and
obtain a feedback message comprising a channel quality indicator, a rank indicator, or a combination thereof, determined using the second channel state information-reference signal and a fourth set of neural network parameters of the second neural network model.

36. An apparatus for wireless communication at a user equipment (UE), comprising:
a processor; and
memory coupled with the processor, the processor configured to:
obtain an indication of a quantity of transmission ports associated with transmission of a channel state information-reference signal in accordance with a non-orthogonal cover code, a length of the non-orthogonal cover code based at least in part on the quantity of transmission ports;
obtain the channel state information-reference signal via a set of resource blocks; and
perform a channel estimation procedure of the channel state information-reference signal using a neural network model that corresponds to the length of the non-orthogonal cover code and the quantity of transmission ports.

37. The apparatus of claim 36, wherein, to obtain the channel state information-reference signal, the processor is configured to:
obtain the channel state information-reference signal in accordance with a set of non-orthogonal cover codes comprising the non-orthogonal cover code, wherein each non-orthogonal cover code is specific to a resource block of the set of resource blocks.

38. The apparatus of claim 36, wherein, to obtain the channel state information-reference signal, the processor is configured to:
obtain, via each resource block of the set of resource blocks, the channel state information-reference signal via a set of resource elements of the resource block, wherein a quantity of resource elements of the set of resource elements is based at least in part on the length of the non-orthogonal cover code.

39. The apparatus of claim 38, wherein the quantity of resource elements per resource block of the set of resource blocks is less than the quantity of transmission ports.

40. The apparatus of claim 36, wherein the length of the non-orthogonal cover code per resource block of the set of resource blocks is less than the quantity of transmission ports.
